(19) United States
(12) Patent Application Publication
(10) Pub. No.: US 2015/0317666 A1
(43) Pub. Date: Nov. 5, 2015

(54) COLLABORATIVE REWARD SYSTEM

(71) Applicant: Phouthalang Pygnasak, Maple Grove, MN (US)

(72) Inventor: Phouthalang Pygnasak, Maple Grove, MN (US)

(21) Appl. No.: 14/702,752

(22) Filed: May 3, 2015

Related U.S. Application Data
(60) Provisional application No. 62/044,142, filed on Aug. 29, 2014.
(60) Provisional application No. 61/988,261, filed on May 4, 2014.

(51) Int. Cl. G06Q 30/02

(52) U.S. Cl. CPC G06Q 30/0226; G06Q 30/0241

(57) ABSTRACT

An advertisement that includes a discount percentage value is received from an advertiser and converted to an ad point value. An indication of a redemption of the advertisement by a shopper is received. A first quantity of earned ad points is provided to the shopper and a second quantity of earned ad points is provided to the advertiser based on the indication of the redemption of the advertisement and on the ad point value of the advertisement. The shopper and the advertiser are associated with first and second reward distribution grids, respectively based on the first and second quantities of earned ad points, respectively. The shopper and advertiser are rewarded with first and second quantities of reward currency, respectively, based on the first and second reward distribution grids, respectively, and on the first and second quantities of earned ad points, respectively.

### CROSS-REFERENCE TO RELATED APPLICATIONS

This application claims the benefit of U.S. Provisional Application No. 62/044,142, filed Aug. 29, 2014 and titled “System and Methods for Point Advertisements Utilizing Reward Distribution Grids And Currency Exchange Market Apparatus,” and also claims the benefit of U.S. Provisional Application No. 61/988,261, filed May 4, 2014 and titled “System and Methods for Point Advertisements Utilizing Reward Distribution Grids And Currency Exchange Market Apparatus,” and the entire contents of each of the aforementioned provisional applications is incorporated in its entirety herein.

### TECHNICAL FIELD

This document generally describes methods, systems and devices for providing a collaborative transaction and reward system that rewards users based on one or more offer, ad or reward transactions by one or more of the users.

### BACKGROUND

Dating back to the 1700's, manufacturers, merchants and advertisers have used a variety of advertisement techniques to expose and/or persuade consumers into purchasing their products. Many different advertisement techniques have been created and evolved to include display advertisements (e.g., traditional or digital displays), reward and loyalty programs, discount advertisements (e.g., coupons, sales), affiliate marketing, and network marketing. Advertisers and merchant sellers have increased globally, and compete for consumers by attempting to offer the greatest incentive or the lowest price. With the increased competition, it has become more difficult for manufacturers, merchants and advertisers to reach-out, attract, retain or get new consumers who are willing to pay retail price, or to attract loyal brand shoppers even after incentives are provided.

Print media publications offer display advertisements in sources that are decreasing in importance. For example, it has been well documented that printed newspapers and magazines are now less used by consumers with the progress of technology and the ready availability of electronic substitutes. Reward and loyalty programs have been used to provide a deferred rebate program for individuals. Affiliate and network marketing programs have relied on consumers' desires for financial freedom to promote and sell their products using a hierarchical peer-to-peer commission/compensation plan. In some examples, participants in such programs may be left with a distaste for the brand if their financial goals are not met.

With the emergence of global e-commerce and the Internet, some types of discount advertisements have become less effective. For example, consumers can now use the Internet to search to identify competing sellers, and can often find the lowest price for an item without the need for a coupon. Consumers are also becoming more aware of pricing strategies that some manufacturers, brands and merchants use to maintain their profit-margins, such as incremental increases of the manufacturer's suggested retail price (MSRP) over time to compensate for a greater discount offer, immediate discounting of products from the original MSRP, and continuous discount offers week-after-week, where consumers can become aware of what the MSRP price should be without the discount applied.

Historically, television commercials, radio commercials, and ads in printed publications were the dominant sources to deliver advertisements to consumers. For the consumer, finding, snipping, and physically presenting coupons, or transporting and physically presenting loyalty or reward cards can often lead to a poor user experience. More recently, as delivery and presentation of advertisements on electronic devices has gained momentum, some consumers find such ads intrusive or irrelevant, which in some cases can cause consumers to ignore the ad or brand entirely.

### SUMMARY

In a first general aspect, a computer-implemented method of providing a collaborative reward system includes receiving, at a central computer system, an advertisement, where the advertisement is provided by an advertiser and includes a discount percentage value for the advertisement. The method also includes converting, by the central computer system, the discount percentage value to an ad point value, and receiving, at the central computer system, an indication of a redemption of the advertisement, the indication of the redemption provided by a shopper. The method further includes providing, by the central computer system, the shopper a first quantity of earned ad points based on the indication of the redemption of the advertisement and on the ad point value of the advertisement, and associating the shopper with a first reward distribution grid based on the first quantity of earned ad points. The method further includes providing, by the central computer system, the advertiser a second quantity of earned ad points based on the indication of the redemption of the advertisement and on the ad point value of the advertisement, and associating the advertiser with a second reward distribution grid based on the second quantity of earned ad points. The method further includes rewarding, by the central computer system, the shopper with a first quantity of reward currency based on the first reward distribution grid and the first quantity of earned ad points, and rewarding, by the central computer system, the advertiser with a second quantity of reward currency based on the second reward distribution grid and the second quantity of earned ad points.

Implementations may include one or more of the following. The converting the discount percentage value to the ad point value can be based on a product class associated with the advertisement, and can additionally be based on a rank value of the advertiser. The method can further include providing the distributor a third quantity of earned ad points based on the redemption of the advertisement and on the ad point value of the advertisement; associating the distributor with a third reward distribution grid based on the third quantity of earned ad points; and rewarding, the distributor with a third quantity of reward currency based on the third reward distribution grid and the third quantity of earned ad points. Associating the shopper with a first reward distribution grid can include associating a first pod node of the shopper with a first node of the first reward distribution grid, where the first node of the first reward distribution grid inherits a plurality of conditions from the first pod node of the shopper. The method can further include receiving an indication of an acquisition of the advertisement by the shopper, and providing the shopper a fourth quantity of earned ad points based on the acquisition of the advertisement and on the ad point value of the advertisement. The method can further include receiving an indication of a redemption of a second advertisement, where the indication of the redemption of the second advertisement can be provided by the shopper, providing the shopper a fifth quantity of earned ad points based on the indication of the redemption of the second advertisement and on an ad point value of the second advertisement, associating the shopper with a fifth reward distribution grid based on a sum of the first quantity of ad points and the fifth quantity of ad points, and rewarding the shopper with a fifth quantity of reward currency based on the fifth reward distribution grid and the sum of the first quantity of ad points and the fifth quantity of ad points. The shopper can be associated with a plurality of reward distribution grids based on a monetary value of the redemption of the advertisement. The shopper can be associated with a plurality of reward distribution grids based on one or more social network associations. The rewarding the advertiser with the second quantity of reward currency can additionally be based on a rank value of the advertiser. The method can further include associating the shopper with a sixth reward distribution grid based on the indication of the redemption, and rewarding, the shopper with an increase to a rank value of the shopper based on the sixth reward distribution grid. The sixth reward distribution grid can be the same as the first reward distribution grid. The providing the shopper the first quantity of earned ad points can additionally be based on a rank value of the shopper. The method can further include providing, for consideration by a plurality of shoppers, the advertisement with an indication of the ad point value. The providing of the advertisement can further include adjusting the ad point value and providing an indication of the adjusted ad point value. The indication of the redemption can be provided following an online redemption or an in-store redemption. The method can further include adjusting a rank value of the advertiser, where a number of advertisements that may be currently active for the advertiser can change based on the adjustment of the rank value. The method can further include receiving an indication from the shopper of an intent to use the first quantity of reward currency to make a purchase from a retailer, and determining whether the retailer has at least an amount of advertiser reward currency equal to the first quantity of reward currency. When the retailer does not have an amount of advertiser reward currency at least equal to the first quantity of reward currency, the method can further include acquiring for the retailer, via a reward currency exchange market, additional reward currency. The first quantity of ad points is combined with ad points of another shopper, wherein the shopper and the another shopper are associated in a group and are collectively associated with a reward distribution grid. The method may further include allocating, to nodes of the first distribution grid, monetary value collected in a plurality of transactions.

Other features, objects, and advantages of the technology described in this document will be apparent from the description and the drawings, and from the claims.

### BRIEF DESCRIPTION OF THE DRAWINGS

FIG. 1 is a conceptual block diagram of an example collaborative reward system.

FIG. 2 is a conceptual block diagram of an example collaborative reward system.

FIG. 3 is a conceptual diagram of an example computer server that can be used to provide example collaborative reward systems.

FIG. 4 is a flowchart of example steps that can be used to provide a collaborative reward system.

FIG. 5 is a flow diagram of example steps that can be used in an enrollment and/or registration process.

FIG. 6 illustrates example parameters that can be used to implement a rank measurement grading method.

FIG. 7 illustrates example tables and parameters that can be used to grade actions and events for determining a rank grade value.

FIG. 8 is a flowchart of example steps that can be used for an enrollment process.

FIG. 9a is a flow chart diagram of example steps that can be used to create an advertisement and assign ad points to the advertisement.

FIG. 9b illustrates example codes that can be used to classify advertisements or reward distribution grids.

FIGS. 9c and 9d illustrate example tables with example parameter values for example discount-plus-point and point-only ad types, respectively.

FIGS. 9e and 9f illustrate example tables with example parameter values for an example point-only ad.

FIGS. 10a and 10b illustrate tables of example advertisement parameters.

FIGS. 10c and 10d illustrate tables pertaining to advertisement scheduling and release, and example ad parameters.

FIG. 11a illustrates an example global distribution grid variable that is active for a cycle term, and example criteria that can be used to obtain the grid variable.

FIGS. 11b and 11c are tables with examples of methods that can be used to obtain a discount variable, which can be use used to convert an advertisement's assigned discount percent to an ad point value.

FIG. 11d is an example table of three example variable values that can be applied to a discount variable or to an ad's assigned ad point value.

FIG. 12a is a flowchart of example steps that can be used to convert an ad's discount percentage to an ad point value.

FIG. 12b is an example graph of an example base ad point range and example mid-point value.

FIGS. 12c, 12d, 12e, 12f and 12g illustrate aspects of an example method that can be used to implement an active-discount-percentage-to-ad-point conversion rate adjustment.

FIG. 13 illustrates tables of example parameters, including a distributor variable that can be used to dynamically affect an advertisement's ad point value.

FIGS. 14a, 14b, 15a and 15b are conceptual diagrams of example screen layout views that can be used to present example advertisements.

FIG. 16 is a view of example advertisements presented via an ad catalog on an interactive media device, such as a television.

FIGS. 17a, 17b, 17c, and 18 are conceptual diagrams of example screen layout views that can be used to present example advertisements on a mobile computing device.

FIGS. 19a, 19b, and 19c conceptual diagrams of example ads provided in example print publications.

FIG. 20a is a conceptual diagram of an example web-application interface for an example online store.

FIG. 20b is a series of conceptual diagrams of example check-out carts interfaces.

FIG. 20c is a flowchart of example steps that can be used to provide a collaborative reward system.

FIGS. 21 and 22 are conceptual diagrams of example reward distribution grids and of representations of associations of end users to the reward distribution grids.

FIG. 23 is a conceptual diagram of example pod node groups, example representations of the nodes' state of activity, and example activation conditions.

FIGS. 24a and 24b illustrate an example method that can be used to calculate base ad point conditions for pod nodes.

FIG. 25 is a flowchart of example steps that can be used to adjust an end-users base point ad conditions, and a table of example parameters and example calculations.

FIG. 26a is a flowchart of example steps that can be used to link pod nodes to reward distribution grid nodes.

FIG. 26b is a conceptual diagram that illustrates an example transaction and an example of how social associations can be used in linking a shopper's pod nodes to reward distribution grids.

FIGS. 26c and 26d are conceptual representations of an example product-family-class tree structure and an example distributor-product-family-class tree structure, respectively.

FIG. 27 is a conceptual diagram of example reward distribution grids and of example parameters that can be used to configure the reward distribution grids.

FIGS. 28a and 28b are tables of example parameters that illustrate how RDG base allocation percentages can vary.

FIG. 28c is a graph of example RDG parameters.

FIGS. 29a, 29b, 29c, and 29d are conceptual diagrams of example reward distribution grids with example patterns of RDG nodes.

FIGS. 30a, 30b, and 30c are tables of example parameters, and illustrate how ad points can be accumulated over multiple transactions or events, to provide an accumulated benefit.

FIGS. 31a, 31b, 31c, 31d, 31e, 31f, 31g, and 31h are tables with example parameters and conceptual representations of an example reward distribution grid and an example pod node group that can be used to provide a collaborative reward system.

FIG. 32 is a flowchart of example steps that can be used to provide collaborative ad point grouping.

FIGS. 33a and 33b are tables of example parameters that can be used for collaborative group ad point determinations.

FIG. 34 is a conceptual diagram of actors and parameters that can be used for reward currency transactions.

FIG. 35 is a conceptual diagram of an exchange market a actors that can use the exchange market for reward currency purchases to satisfy pair conditions for reward currency transactions.

FIGS. 36a, 36b, and 36c illustrate various example pair conditions for example reward currency transactions.

FIGS. 37a and 37b are conceptual representations example second, reward currency transactions between a shopper and an advertiser.

Like reference symbols in the various drawings indicate like elements.

### DETAILED DESCRIPTION

Described herein are systems, devices and methods that can be used to provide a collaborative transaction and reward system that rewards users based on one or more offer, ad or reward transactions, including incentivized offer, ad or reward transactions, by one or more of the users. In some implementations, the system can include advertisements associated with points (hereinafter, “point advertisements” or “point ads”), and can also include one or more reward distribution grids and a currency exchange market. In some implementations, use of the systems, devices, and methods discussed herein can result in reduced advertising expenditures, and increased consumer ad engagement, as consumers may be more likely to seek out the corresponding advertisements and engage with the advertisements. In some examples, the collaborative techniques, including collaborative ad point techniques, discussed herein can allow consumers, advertisers and advertisement distributors to benefit from each other while conveying product discovery, acquisition and monetization benefits and results.

Some examples of the collaborative transaction and reward system include point advertisements, pod nodes and pod node groups, reward distribution grids and a currency exchange market. The advertisement may include an applied discount percent that can be converted into ad points, earnable by an end-user, such as a consumer or shopper (and also by an one or more associated stakeholders in some examples), when the advertisement is redeemed. The ad points may be accumulated, and may satisfy one or more ad point conditions that, for example, can continuously grant them one or more pod nodes that can be synced or be linked to one or more nodes of one or more reward distribution grids. In some examples, the reward distribution grid nodes have stored monetary value derived from one or more monetary discount values of one or more redeemed ad transactions. In some examples, the system awards, to the owner of the pod node for each pod node that is synced, the stored monetary value as reward currency. In some examples, one or more pairing conditions, which may impose a requirement that must be satisfied before a transaction can occur, can apply to use of awarded reward currency. In some examples, reward currency may be spent using a variety of payment methods. In some examples, a currency exchange market can be used to exchange reward currency or other items of value, for example so that one or more pairing conditions may be satisfied and a corresponding transaction may occur.

In some examples, neither a discount percentage nor a monetary discount value of an advertisement offer is made known to either end-users (e.g., consumers) or competing advertisers. In some examples, a discount module is used to convert an advertisement's value (e.g., discount value) into ad points. A discount percentage can be applied as a floating-point number (e.g., 12.59%) or as a whole number (e.g., 12%) or a fixed monetary discount can be applied (e.g., $5 off a $50 amount), and the discount percentage can be converted into ad points, in some examples. The discount module can convert the discount percentage into an ad point value using the ad's discount percentage. In some examples, a facilitator (e.g., an owner or operator of the system) may impose a fee (e.g., as a percentage of a value of the ad). The facilitator may for example directly debit a fee from a discount percent of offer, which may affect result of ad point conversion (e.g. for an advertisement with a discount percent offer of 20.00%, a facilitator fee of 7.49% may be imposed, resulting in 12.51% discount percent to be used for ad point conversion). The fee can be variable, and can be based on advertiser rank values and grade, in some examples. In some examples, the imposed fee can be added to the discount percent of offer, which may increase a cost to advertiser. In some examples, a discount point rate can be used, which can affect a result of discount to ad point conversion. When applied, the discount point rate may increase the discount percent being converted, in some examples. Following the conversion, the ad's discount percentage value may not be made available or provided (e.g., may not be displayed with the ad), such that prospective consumers, shoppers, or competing advertisers may not be able to discern the ad's discount percentage, according to some implementations. Instead, a numerical point value (e.g., ad point value) may replace the discount value, and the numerical point value may be made available or provided (e.g., displayed with the ad). In some examples, such a conversion of a discount percentage to an ad point value can be applied to any incentivized or discounted advertisement used with the techniques discussed herein. Such advertisements may pertain, in various examples, to products or services, and may apply to transactions in a consumer-to-consumer environment, a business-to-consumer environment, or a business-to-business environment, without limitation.

In some examples, an advertiser or merchant (hereinafter, advertiser) can offer end-users (e.g., consumers or shoppers) a variety of ad types. In some examples, an advertisement module can be used to create an advertisement. As one example, the advertiser may offer a point-only ad type, which may not include an inherent discount (e.g., markdown) of the product or service, but which offers ad points for transactions associated with the advertisement. As another example, the advertiser may offer a discount-plus-point ad type, which may include a discount (e.g., markdown) for the product or service, and may additionally include an offer of ad points for transactions associated with the advertisement. Discount-plus-point ads may convey an immediate discount from the advertised price, such that a consumer purchasing the corresponding good or service pays less than retail price, and may grants ad points when the advertisement is redeemed (e.g., when a purchase is made of the associated good or service). Ad points may be awarded to the consumer, and in some examples ad points may also be awarded to the advertiser (or to another stakeholder, such as a distributor of the ad, for example).

In some examples, in addition to ad points being award when an ad is redeemed, ad points may also be awarded when the advertisement is acquired (e.g., selected or otherwise identified by an end user). In some examples, ad points awarded for acquisition of the advertisement may remain pending until the advertisement is redeemed. In some examples, rank increases can be awarded when various actions or events are performed or realized by actors (e.g. shopper, advertiser or distributor), such as saving an offer, redeeming an offer, referring a friend, satisfying point milestones, and the like. When rank increases, an actor can be awarded various incentives or upgrades such as more linkable pod nodes, lower pod node conditions, or earned ad point multipliers.

Referring again to the conversion from a discount percentage of an ad to a point value, which may be performed by the discount module, the conversion may be based on one or more of a base point, base percent by industry/product-family/class, one or more variables of the advertisement environment, an advertiser's industry characteristics, a timing apparatus, and parameters of end-users (e.g., advertisers). In some examples, the discount to ad point conversion can be affected by various other end-user or reward distribution grid variables. In some examples, an advertiser's industry, product-family or product-class of product offer can affect discount-to-ad-point conversion. In some examples, the discount to ad point conversion rate will vary for advertisements and will fluctuate in real-time. The amount of fluctuation can vary by the environment factors of advertisements, offer ledgers and various configuration tables. Because of the possibility of real-time fluctuation, the discount to ad point conversion rate may be referred to as being elastic, according to some implementations.

In some examples, a facilitator (e.g., an owner or operator of the system) may charge a fee for use of the system. In some examples, the fee may relate to a purchase amount or redemption amount associated with the ad. Such fees, or electronic representations of the fees, may be directed into one or more reward distribution grids, according to some examples. Reward distribution grids may be associated with an offer or rank parameter, such as ad point or rank. Each reward distribution grid can be associated with a single value, (e.g. 12.05), or a range of values (e.g. 12.00 to 12.05). A number of reward distribution grids created and made available can be based on an offer or measurement value range, in some examples. (E.g. ad-point range of 0 to 1,000 with an configured range of 0.01 to 1.00 may result in 1,000 available grids). The reward distribution grids can further be segmented by class, (e.g., consumers, with advertisers, or with distributors), according to some examples. Fees may be directed into a reward distribution grid based on a parameter of the advertisement or on a parameter associated with an end-user, such as a point value or a rank value of the advertisement or end user. A reward distribution grid may include a series of nodes in a variety of arrangements (e.g., nodes connected by edges or links in the grid), and each reward distribution grid node may store a monetary value, for example. Direction of a fee into a reward distribution grid may result in one or more stored monetary values at one or more nodes of the grid. Following a redemption of an advertisement (e.g., a purchase of a good or service associated with the advertisement), the system may award the advertiser monetary value equal to the transaction amount less the facilitator's fee and the monetary value of the applied discount percentage, according to some implementations.

When a point type advertisement is redeemed, the result in some examples is the end-user paying a higher price (e.g. retail, MSRP, listed) for the product or service, as compared to redemption of a discount-plus-point ad. However, a greater number of ad points may be awarded, as compared to the amount of ad points awarded with a discount-plus-point ad, and in some examples this may eventually benefit the end user more than an original discount would have. As initial compensation for the sale, the advertiser may receive the amount the shopper paid minus an amount corresponding to the applied discount percentage, and the amount corresponding to the applied discount percentage may be directed into a reward distribution grid (e.g., to one or more nodes of the grid) based on a parameter of the advertisement or on a parameter associated with an end-user, such as a point value or a rank value.

In some examples, various variables, such as a rank variable, rank grade, or other variables can be assigned to stakeholders (e.g., advertisers, consumers, distributors of advertisements). The variable values and incentives can affect other values and conditions that can include, but are not limited to, an assigned ad point value of an ad, ad point conditions of pod nodes and/or reward distribution grids, an amount of ads that can be released (e.g., over a given time period), ala-carte benefits available, or reward currency holding limits. The measurement (e.g., rank) variable values can be obtained using various advertisement usage and performance activities of a stakeholder, for example. When graded, variable values can be provided to stakeholders, and incentives associated with achieving those values can be realized based on the values.

In some examples, a measurement module can be used to grade actions and events of shoppers and advertisers. The measurement module can be used to provide elastic timing, action and effects aspects to the system, in some examples. For example, a graded action or event that occurs at a first time can result in a redirection to another set of action and event factors for a second time. An elastic rank value may be awardable and adjustable in real-time, for example based on a sequence or activities of a shopper or advertiser. The measurement module may use a timing function and action or events historical data of a shopper or advertiser to assign a grade or rank to a shopper or advertiser, which may then be used in determination of benefits awarded to the shopper or advertiser.

A reward distribution grid module may manage the reward distribution grids. In some examples, reward distribution grids can be segmented and can include multiple nodes. For example, a reward distribution grid can be segmented by class based on parameters of an end-user, or segmented by point value based on parameters of an advertisement, such as an ad point value or rank value. A reward distribution grid can be segmented by divisions of point parameters, (e.g. 20.00-21.00 ad point equal one RDG grid, segment division or rank value, e.g. 20.00-20.50, equal to one RDG grid, segment division), of an advertisement or end-user, such as an ad point value or rank value.

In some examples, monetary value amounts applied to a reward distribution grid can be further allocated as a percentage of the collected money. Monetary value amounts can be can be allocated based on end-user types, such as shopper or advertiser or distributor. Monetary values can be directed into a reward distribution grid based on advertisement or end-user parameters, for example. For example, using an ad point parameter, collected money can be directed into a reward distribution grid associated with ad point value. Each node of a reward distribution grid may be associated with a particular shopper, advertiser, or distributor, for example, and may be associated or awarded in a reward state or a rank state, for example. A reward state may convey a monetary reward, while a rank state may convey a reward of increased rank for the corresponding shopper, advertiser, or distributor.

The use of reward distribution grids, in some examples, may permit disparate shoppers, advertisers, and distributors to collaboratively associate and globally interconnect. For example, a Minnesota shopper may benefit from a California shopper using the systems and techniques discussed herein, or a Minnesota advertiser may benefit from a California advertiser.

As described above, shoppers, advertisers, or distributors can earn ad points based on transactions or actions related to advertisements associated with the ad points. In some examples, a point module can be used to award the ad points. Ad points can be issued by advertisers and earned by shoppers, for example. Ad points may not have an implicit or inherent monetary conversion rate or attachment; for example, based on a given number of ad points associated with an advertisement, it may not be possible for a shopper, advertiser, or distributor to discern a corresponding monetary value associated with the number of ad points. In some examples, ad points can be used to determine whether one qualifies for an award. When ad points are earned by shoppers, for example, the advertiser and distributor of the offer may also receive ad points (e.g., a same number of ad points, a percentage of the ad points earned by the shopper). Earned ad points may be accumulated. In some examples, earned ad points may remain valid or usable for a period of time.

Ad points can be earned based on a transaction or action initiated by a given actor (e.g., based on that actor's individual effort), and in some examples can also be earned based on transactions or actions initiated by another actor. In some examples, ad points earned as a result of various transactions or actions can be combined. Earned ad points, such as ad points earned based on actions or transactions by the actor, can be used to satisfy one or more ad point conditions of one or more pod nodes.

In some examples, ad points owned by various users may also be combined and summed for a collaborative or group ad point count value. Such a group may include of multiple shoppers, advertisers or distributors. The group ad points may be used, for example, to satisfy one or more pod node conditions. The collaborative or group ad points can be summed by using, for example, offer and/or measurement parameters, environmental variables, or node patterns. A collaborative or group ad point value (e.g., the sum of ad points of various members of the group) may be compared to a collaborative ad point conditional or threshold value, and when the collaborative or group value exceeds the threshold value, the group members (e.g., shoppers, advertisers or distributors) can receive reward incentives (e.g., a

A pod module may be used to manage the pod nodes in the system. Pod nodes may be part of pod node groups. Each pod node can have a variety of base and qualifying conditions. In some examples, the pod module can assign pod nodes to shoppers, advertisers or distributors based on a variety of actions or transactions, such as making or accepting a qualified offer, or initiating or participating in a purchase event. In some examples, such actions, transactions, or events may be monetary evens or non-monetary events.

The conditions of the pod nodes can be static, or can be elastic and can change when measurement figures or parameters of the shoppers, advertisers or distributors change. In some examples, a number of pod nodes that may actively be used to earn monetary rewards for a shopper at a given time may be limited, but in other examples there may be no limit on the number of such pod nodes. Some pod nodes can be used to access monetary rewards of a reward distribution grid node, while others can be used to increase measurement figures or incentives, such as a rank or effect. This can lead to increases and expansion of active pod nodes monetarily rewarding concurrently, i.e. one time. When a pod node is linked or assigned, for example, it may remain active and capable of providing an award for a temporary period of time, which may be measured by a cycle counter. Upon depletion or expiration of the cycle counter, the pod node may be unlinked or unassigned from a reward distribution node and may become available for another linking or assignment session, or with another reward distribution grid node. Such a subsequent linking or assignment can occur, for example, when the actor makes a subsequent qualifying offer or purchase event.

Pod nodes can be linked to reward distribution grid nodes, in some examples. As such, the shopper, advertiser or distributor associated with the pod node may participate via the reward distribution grid, based on the linking of the pod node with the node of the reward distribution grid. When such a link occurs, the reward distribution node may temporarily inherit base conditions and values of the corresponding pod node (e.g., base ad point conditions, cycle count conditions, award conditions, timer conditions, end-user adjusted ad point conditions and their earned ad point value). For the duration of the pod node's active link to the reward distribution grid node, the corresponding shopper, advertiser or distributor may benefit by receiving rewards via the reward distribution grid.

A reward distribution grid module may be used to manage the linking of pod nodes to reward distribution grid nodes, and to manage the awarding of benefits from the reward distribution grids. In some examples, each reward distribution grid can be associated with a user class (e.g., shoppers, advertisers, distributors, or other actors), and can be associated with an offer parameter (e.g., an ad point value) or end-user parameter, such as rank. An appropriate reward distribution grid may be determined based on the selected parameter value. Each reward distribution grid can include many disjointed nodes.

A particular reward distribution grid may serve a particular class of actors or end users. For example a first reward distribution grid may serve shoppers, a second reward distribution grid may serve advertisers, and a third reward distribution grid may serve distributors. As such, reward distribution grids may belong to a particular class of grids. Each reward distribution grid includes nodes that can store indications of monetary value collected from shopper transactions and indications of monetary value associated with discount percentage values applied by an advertiser. When monetary value is collected, it can be allocated as a percentage into the different classes of reward distribution grids and nodes of the grids. Allocation percentages can fluctuate in some examples, which can result in variable distribution of collected fees into reward distribution grids.

In addition to the base allocation described above, each reward distribution grid can receive a segment of that allocation percentage, which may also fluctuate or be elastic in configuration. For example, a mean point may be established in a min/max scale, and the mean point may be assigned an allocation percentage value. Afterwards, it can be segmented into different ranges within that min/max scale. Each range may include an allocation percentage that is either descending or ascending to its threshold percentage. In some examples, reward distribution grids that are more difficult to link to may provide greater incentives or benefits.

Reward distribution grid nodes can have various states. For example, a reward distribution grid node may be associated with a payable-measured state, so that a shopper, advertiser or distributor whose pod node is associated or linked with the reward distribution grid node may be eligible for a monetary and/or rank reward. As another example, the reward distribution grid node may have a measured-state, so that a shopper, advertiser or distributor whose pod node is linked to the reward distribution grid may be eligible for a rank increase. In some examples, any qualified action by a shopper, advertiser, or distributor may result in a link or association of a pod node (e.g., associated with the user) to a reward distribution node having a payable-measured state or a measured state.

In some examples, a reward distribution grid's stored monetary value can be issued as reward currency, where the reward currency is associated with a reward currency group (RC-group) (e.g., shopper group, advertiser group, or distributor group) and reward currency type (RC-type) (e.g., shopper type, advertiser type, or distributor type). When advertisers, shoppers or distributors become beneficiaries of a reward distribution grid fund, they can receive reward currency.

An advertiser RC-group may include any stakeholder selling a product or service to a shopper in exchange for profit in a first transaction with new money (e.g., currency from outside of the system and excluding transactions that use reward currency from within the system). A shopper RC-group can include any stakeholder that purchases a product or service using an advertisement from an advertiser by using cash, credit, or the like in a first transaction (e.g., using currency from outside of the system and excluding transactions that use reward currency from within the system). A distributor RC-group may include distributors of the advertisements.

By associating reward currency with RC-groups and RC-types, restrictive exchanges between similar RC-groups can be used to prevent recirculation or double-use of reward currency that has been awarded. For example, business-to-business transactions (e.g., company B advertises, and company A purchases based on the advertisement) may also be eligible for reward benefits. In this example, company A is a shopper and company B is an advertiser. Company A may receive shopper incentives and company B may receive advertiser incentives.

After one reward currency transaction, the shopper can be provided with a product, the advertiser can be provided monetary gains, and the facilitator can collect a fee. The RC-group or RC-type association may prevent reward currency from being used multiple times, which could undesirably affect and diminish economic value of the reward currency.

Additionally, for an advertiser to monetize their reward currency, in some examples, a paired monetization condition may be required in a reward currency transaction. In some examples, a shopper's group reward currency must equal an advertiser's group reward currency of shopper's reward currency transaction (e.g. shopper reward transaction amount is $10.00 requiring $10.00 of shopper group reward currency, therefore also requiring $10.00 of advertiser group reward currency to satisfy a paired monetization condition). Then when $10.00 of shopper group RC equals $10.00 of advertiser group RC, advertiser of the reward transaction can be the recipient of a payment from facilitator.

In one reward currency transaction, there can be at least three (and in some cases more) beneficiaries: shopper (e.g., buyer of product or service), advertiser (e.g., seller of product or service) and seller of reward currency in an exchange market (e.g., who is selling reward currency to advertisers that are, likely, the entity directly transacting with a shoppers in reward currency transaction in-store, online or virtually).

When an advertiser, for example, buys reward currency in the exchange market, the seller of reward currency can receive monetary value from the sale of reward currency. The amount of monetary value conveyed can be determined by a market rate and buy price. In some examples, a purchase of reward currency from the exchange market can have either a positive or negative monetary profit/benefit for the buyer or seller. Depending on the market price of reward currency when purchased, the buyer (e.g., an advertiser) of reward currency can gain or lose value from the exchange transaction. When the market rate is greater than the shopper's exchange rate, (i.e. one), the buyer (e.g., advertiser) will lose value from a reward currency purchase from the exchange market while the seller gains value. However, when the market rate is lower than the shopper's exchange rate, (i.e. one), the buyer (e.g., advertiser) gains from the reward currency purchase while the seller loses value.

In some examples, an exchange market that includes a variable market rate can be used to permit exchanges and purchases of reward currency between or among end-users (e.g., shoppers, advertisers, distributors) of the system. The currency exchange market may permit stakeholders of similar or dissimilar RC-groups and RC-types to exchange, barter, share, give or sell reward currency to each other.

In some examples and for some RC-groups, awarded reward currency can be autonomously directed into the exchange market and sold at a market rate. The market rate can be determined, for example, by an amount of advertiser reward currency compared to an amount of shopper reward currency currently in circulation within the market. Because the amount of the different types of reward currency in circulation will vary over time, the market rate may vary over time, which can result in variable prices for reward currencies.

In some examples, an autonomous purchasing event can occur within the exchange market when a RC-advertiser lacks adequate reward currency to equally pair with a shopper's reward currency. For example, the system may require that a pair condition be satisfied before a transaction is allowed to occur. An example of a pair condition may be a requirement that, for a proposed transaction between an advertiser with advertiser reward currency and a shopper with shopper reward currency, the advertiser must have at least as much advertiser-RC as a shopper has shopper-RC in order for the transaction to be allowed to occur, and for the advertiser to receive monetization. Some pair conditions may require that the advertiser and the shopper have an equal amount of reward currency for the transaction to be processed. In a situation where the advertiser has an insufficient amount of advertiser RC to satisfy the pair condition, reward currency may be autonomously purchased such that the pair condition may be satisfied.

In some examples, a shopper may use a computing device to enroll in the system, as by providing information via user interfaces provided by a facilitator's authentication and user modules. For example, a shopper can input personal information and in some examples can select a personal identification number (PIN). In some examples, after enrolling, the system may present the shopper with an offer to upgrade their membership, such as to increase their rank starting value. In some examples, the system can award rank increases based on various actions or events performed by actors, (e.g. shopper, advertiser or distributor) such as saving an offer, redeeming an offer, referring a friend, satisfying point milestones, and the like. When an actor's rank increases, in some examples, the system may award the actor with various incentives or upgrades, such as an increase in a number of linkable pod nodes assigned to the actor, lower requirements or conditions for the user's pod nodes, or earned ad point multipliers.

Within the system, over time, the system can cause rank values to increase, decrease or stay the same. In some examples, various time measurement points, measurement cycles, gradable actions and events, configuration tables can be used in determining rank value changes. Measurement points may include a range of events and actions having a minimum configured value. When one or more configured values are satisfied by an advertiser, shopper or distributor, for example, the system may increase the rank of the advertiser, shopper, or distributor. When rank values increase or decrease, the system may direct the corresponding advertiser, distributor or shopper to a new configuration table of different configured values and result in rank increasing, staying the same or decreasing, in some examples.

Rank grade increases can provide advertisers, shoppers and distributors upgrades and incentives. Such incentives and upgrades may temporarily cause an increase in the number of pod nodes available, beneficially affect the ad point conditions of pod nodes, or reduce facilitator fees for advertiser or distributor, in some examples.

In some examples, an advertiser's industry, selected product-family or product-class of offer can affect discount-to-ad-point conversion. Each industry or product may have its own discount-to-ad-point conversion rate, in some examples.

In some examples, the facilitator may impose a fee as a percent, directly debiting from discount percent of offer, (e.g. discount percent offer is 20.00% less imposed fee of 7.49%, resulting in 12.51% discount percent for ad point conversion), and affecting a result of the ad point conversion. The fee can be variable based off advertiser rank values and grade, in some examples. In some examples, the imposed fee can be added to the discount percent of the offer, increasing a cost to the advertiser (e.g. for discount percent offer of 20.00% and a fee of 7.49%, may result in a 27.49% reduction from listed retail price).

An ad award time may be associated with an advertiser's rank value and grade. The system may use ad award time to limit a number of offers released concurrently, in some examples. When rank increases or decreases, the amount of award ad time may also fluctuate, in some examples. The system may award an increase or decrease of award ad time based on acquirable rank value or grade. In some examples, each offer released by the system may result in a debit from award ad time, in some examples.

An advertiser rank can affect the debit cost of award ad time for a calendar time or day, in some examples. The system may present options, via a table, for example, to an advertiser regarding award ad time debit values for specific times, ranges and days. The advertiser may select, for example, a day, time and the amount of offers to release during the specified time is selected, it may be debited from advertiser's award ad time, in some examples. In some examples, the system selects one or more of the day, time, and amount of offers to release during the specified time. Advertisers' award ad times to release an offer may also vary from advertiser to advertiser based on their current rank value and grade, in some examples.

In some examples, an advertiser who accepts a cash redemption from a shopper may require an escrow account with facilitator. The escrow account may store monetary funds available for withdrawal by the facilitator for direction into an associated reward distribution grid of offer when redeemed by shopper, in some examples. This may ensure that sufficient funds are available such that the monetary discount of the offer can be applied into an associated reward distribution grid. In some examples, an advertiser may use a float, which may allow the advertiser to issue offers in numbers greater than their available escrow account balance, in some examples.

When a shopper is accepting a cash offer redemption, presentation and activation of offer via a computing device may be used, in some examples. When activated, a timer or activation code may be presented to the shopper. The shopper can present the activation code to the advertiser or receive from the advertiser an activation code, in some examples. When the activation code validates, confirmations may be sent to the shopper and advertiser, in some examples.

When buying an offer for a product or service online, a shopper can buy using an online checkout process including entry of payment and identification information, in some examples. An offer can also be purchased by selecting a displayed offer and being presented with a checkout process without navigating or being redirected from current view, in some examples.

A shopper can associate an offer by card-linking, in some examples. Card-linking may permit the shopper to associate their payment card with the offer, without providing payment or commitment at that time. When an offer is associated with a payment card, the shopper can use that payment card at a point-of-sale terminal to redeem the offer without presenting the offer to a clerk or retailer, in some examples.

In some examples, a shopper can pay for an offer, and then later arrive at a store's physical location or storefront to complete the transaction. The shopper can pay for the offer using card-link technology or web-authentication (e.g., which may be used to validate), and can receive credit for the transaction when the transaction is completed at the store's physical location. In some examples, the shopper can present the offer via a computing device when redeeming the offer.

In some examples, the discount to ad point conversion can be affected by various other end-user and reward distribution grid variables. For example, the conversion from a discount percentage of an ad to a point value, which may be performed by the discount module, may be based on one or more of a base point, one or more base percent by industry/product-family/class, one or more variables of the advertisement environment, an advertiser's industry characteristics, a timing apparatus, and parameters of end-users, (e.g. advertisers). An amount of fluctuation in the conversion rate can vary by the environment factors of advertisements, offer ledgers and various configuration tables. Because of the possibility of real-time fluctuation, the discount to ad point conversion rate may be referred to as being elastic, according to some implementations.

In some examples, a first-party application to acquire, view, and store offers, and use as a digital wallet while also being able to view offers acquired from third-party applications may be provided by the system. Before a third-party distributor can present offers, a software development kit comprising of various modules may be installed, in some examples. To authenticate and identify distributor, an enrollment process may be used, in some examples.

In some examples, a distributor variable can affect an offer's ad point value. The distributor variable may be calculated using various parameters of a reward distribution grid and its nodes (e.g., number of nodes in payable-measured state, number of nodes in measured state, current amount of total RDG nodes, or threshold percent). When applied, the distributor variable can assist in creating ad point variation of offers displayed, for example, by first distributor and a second distributor, such that the same ad point offer differs based on the distributor, in some examples.

Point offers can be presented on a mobile computing device within a web-application in various positions and arrangements on a screen of the computing device, such as in sidebar, or at or near the top or bottom of the screen as display advertisements, in some examples. In some examples, point offers can have a selectable type, such as discount-plus-point or point-only. For example, the point offer can be presented as a display advertisement and, upon selection of the point offer, the selector may have the opportunity to choose whether the offer is a discount-plus-point offer type or point-only offer type.

In some examples, the system may ask the shopper to register when the shopper selects an advertisement offer, as by providing a modal or alert box (or other) that requests authentication and/or registration. In some examples, a modal or form requesting a PIN may be presented. When PIN input is successful and the shopper is verified, the system may associate the offer with the shopper's account, in some examples.

For a selected advertisement offer, the system may require a payment card for association with the selected advertisement offer (e.g., by a modal or form requesting payment card). A payment processing entity may process the information, and the system may return a token to associate the current and future selected offers with the payment card, in some examples.

In some examples, offers can be presented within an offer-catalog, which may include a search input field and/or navigational menu, and may be expandable or retractable from view on a screen of computing device. In some examples the computing device may include a web-application. In some examples, the computing device may be an interactive media device (e.g. television). Offers can be displayed and/or presented within a mobile application as a display, native and as an interstitial or within an expandable/retractable offer-catalog. Authentication steps can be presented when an offer is selected.

Offers can further be positioned or displayed within printed material, and can include a scannable or readable (e.g., by a computing device) code, or can include a code that may be manually entered into a device. In some examples, the offers can be verified. Offers in printed publication can be activated or deactivated after publication, (e.g. it available and in circulation). Additionally, offers of this type can be configured in real-time, such as by limiting or increasing availability to times, days and/or amounts, in some examples.

In some examples, shoppers can buy directly from a web-application interface, (i.e. online-commerce), using a checkout process. Upon checkout, offers (e.g., product-offers), can be added, deleted, removed and bought. In some cases, local offers can be saved and picked-up in-store. In some examples, a combination of products that were paid for and processed through a checkout cart can later be picked up in-store.

An offer transaction that is presently paid-for by a shopper can result in the shopper receiving one or more pod-node-to-reward-distribution-grid-node links, in some examples. In some examples, awarded rewards may be immediately available, and in other examples awarded rewards may not be immediately available when awarded and earned.

The system may preliminarily associate a shopper accepting an offer with parameters of the offer (e.g., ad points, shopper, advertiser, distributor), and may similarly associate the offer's advertiser and, if applicable, the offer's distributor, with parameters of the offer.

In some examples, the system can use allocation percentages and assign a class to a reward distribution grid (RDG). An RDG may be associated with a single or ranged point value, and each RDG may be segmented into a particular class, (e.g. one or an advertiser, shopper or distributor class). Each node of an RDG may receive a percent of its class allocation, which may be determined by a total number of qualified nodes in the RDG. Each node of the RDG may further be configured to receive a portion of collected discount money from offers, in some examples.

A shopper's offer transaction may result in an advertiser, distributor, and the shopper earning and receiving ad points. Further, pod nodes (e.g., associated with the advertiser, distributor, or shopper) may be linked to nodes of the RDG associated with the offer transaction, or with ad points or rank points, in some examples.

The system may use pod node cycle counters to manage time periods during which ad points can be earned (e.g., by shoppers, advertiser or distributors), or which such earned ad points may be valid in some example. When a pod node cycle counter expires, a decrease of shoppers', advertisers', or distributors' accumulated earned ad points may result, in some examples. When pod nodes are linked to RDG nodes as a result of a shopper's qualified offer transaction, earned ad points can increase for shoppers, advertisers and distributors (e.g., their accumulated ad point figure can increase), in some examples.

In some examples, a shopper who has attained or satisfied various rank or ad point values or conditions can increase a number of concurrently activated pod nodes. By contrast, when the shopper no longer qualifies or satisfies the values or conditions, the total number of pod nodes available to shopper can decrease, in some examples. This elastic effect can similarly occur for advertisers and distributors.

In some examples, pod nodes of shoppers may comprise of a group of connected or disjointed nodes, each capable of being configured with different parameter conditions such as base ad point conditions, cycle counter, or awardable monetary amount. Each shopper pod node can be in an active or deactivated state, in some examples. Each pod node can further include configuration parameters that can be useful for award determination when linked to a RDG node, in some examples.

In some examples, pod nodes of advertisers or distributors can be unlimited in monetary benefit and linking capacity to RDG nodes, and can be relevant to shopper transaction occurrences. A shopper may determine when an advertiser or distributor activates a pod node, which may result in a link to a RDG node, in some examples. In some examples, when a pod node of an advertiser or distributor is linked to an RDG node, configured base parameters of the instigating shopper (e.g., the shopper associated with the transaction) may be inherited for a temporary period by the RDG node to which the pod node links, in some examples.

In some examples, the system may elastically (e.g., variably over time) configure base ad point conditions of a shopper's pod nodes. The configuration can be based a figure that can be calculated based on factors such as a number active end-users, a number of pod nodes, a number of redeemed offers occurring during a predetermined or calculated time, a number of ad points awarded, or a break point percentage figure. The calculated figure can then be used to assign a starting base ad point condition for pod nodes, in some examples.

In some examples, the system can temporarily modify base pod node conditions for shoppers, advertisers or distributors. Using rank values of the shopper, advertiser or distributor and a threshold percent condition, the system may determine whether a pod node qualifies for a temporary modification, in some examples. Such a modification may provide a benefit for the shopper, advertiser or distributor, such as a reduction in an amount of ad points required to qualify for an award from a RDG node, for example.

In some examples, the system can link pod nodes to RDG nodes, where the RDG nodes may have different states. The state of the RDG node may determine whether the RDG node can qualify for a monetary award, a rank award, or both a monetary and rank award. Example RDG node states include a payable-measured state, which may convey a monetary award and a rank award opportunity, and a measured state, which may convey a rank award opportunity, in some examples.

In some examples, when a shopper offer transaction occurs, the transaction amount may determine whether the transaction qualifies for multiple pod-node-to-RDG-node links from single transaction (e.g. a $50.00 shopper transaction may qualify the shopper for five shopper pod nodes to be linked to five (e.g., different) RDG nodes). Variability in an amount of pod-node-to-RDG-node linking based on a transaction can further vary by industry, product-family or product-class. In some examples, when a shopper's transaction can qualify for multiple links, the shopper's social network can be used to determine whether the shopper's pod nodes link to any other RDG nodes. A potential benefit, in some examples, is that such linking can result in the shopper associating with many different reward distribution grids, which may increase award opportunities for some (e.g., larger) transactions, while also creating a more engaging experience for the shopper, for example. In some cases, the transaction can also give advertisers or distributors associated with offer the same or a similar benefit, in some examples.

In some examples, upon a shopper offer transaction that result in multiple pod-node-to-RDG-node links, a shopper's social association with other shoppers can be used in a determination of which RDG, and which nodes of the corresponding RDG, the shopper's multiple pod nodes will link to. A shopper can associate with other shoppers by inviting or referring other shoppers to their social network, in some examples. A shopper may also be able to select or use other social networks to invite friends to participate, assist and help each other in accumulating rewards. When a shopper is in a social network of another shopper, for example, transaction segment links can be configured to associate with certain other shoppers of the network. Also, in some examples, linking priority to other shoppers can be selected and configured.

A distributor can distribute ads electronically, in print, or at a physical location. The distributor can use a web-domain, an in-store or virtual storefront, an interactive media brand, a manufacturer brand, a print publication brand or entity and/or a mobile application, in some examples.

In some examples, the system can use product-families to identify a group of product-classes and parent identifier of its subset of products.

Reward distribution grid nodes can be represented in a two-dimensional grid (e.g., with an x-axis and a y-axis), in some cases. In some examples, reward distribution grids may increase or decrease in size as pod nodes are linked (activated) or unlinked (deactivated) to nodes of the RDG, in some examples. For example, a number of links occurring to a single grid can vary substantially due to actions determined by, sometimes, unpredictable end-users.

A timing module may be used to manage various cycle and timing parameters. For example, one or more timing modules may manage one or more of global-cycle timers; award timer cycles; shopper, advertiser or distributor rank cycles; shopper, advertiser or distributor rank grading cycles; discount adjustment/measurement cycles; pod node cycle counters; RDG allocation cycles; market rate cycles; and ad release cycles. The facilitator of the system may configure the time and cycle term of one or more, or all, of the aforementioned cycle times, for example. In some examples, configured cycle parameters can be superseded or affected by an end-user's (e.g., shopper, advertiser or distributor) rank value and grade effects. For example, a temporary modification of a pod node's cycle counter may occur based on an end-user's rank value. The cycle and timers can be used to manage timed events that can be associated with clock time, (e.g. hours, minutes, seconds, milliseconds).

Each pod node can have a different cycle and timer counter configuration. The configuration can apply to each cycle in some examples, and in others may not apply to each cycle. In an example, a pod node #1 and a pod node #2 may have configured cycle counters of 7 and 7, respectively, but may have timer counters of 12 and 16, respectively. This can mean that pod #1 can require 12 cycles of award timer (e.g. one award timer configured to occur every 30 minutes and with a timer counter of 12, a first cycle counter of pod 1 can be equivalent to 6.0 hours), whereas pod #2 may require 16 cycles (e.g. 8.0 hours, a result of calculated figures ((30*16)/60 minutes). While in a cycle counter of 2 for pods 1 and 2, timer counters may be configured to require 11 and 15 cycles of award timer. This configuration can increase, decrease or remain the same for subsequent cycle counters of pods 1 and 2 in this example.

Reward distribution grids include nodes that can store indications of monetary value collected, for example, from shopper transactions, and can store, for example, indications of monetary value associated with discount percent values applied by an advertisers offer. When monetary value is collected, it can be associated with an offer's assigned point value, (e.g. monetary value can be directed into an RDG based on an offer's assigned 25.23 point value), or with an offer's adjusted point value, (e.g. monetary value can be directed into an RDG based on an offer's 21.22 adjusted point value), or with a end-users rank value, (e.g. monetary value can be directed into a RDG based on an user's rank value of 78.23) and allocated as a percentage into, for example, different classes of reward distribution grids.

Within each distribution grid, nodes of the grid may store indications of monetary value based on one or more transactions associated with an advertisement. The monetary values or deposits may correspond to collected money from an advertiser's monetary value of an applied discount percentage or fee collected by a facilitator. Whether the monetary value originates from the discount percentage or fee can depend, for example, on the advertisement offer type.

A particular reward distribution grid may serve a particular class of actors or end users. For example a first reward distribution grid may serve shoppers, a second reward distribution grid may serve advertisers, and a third reward distribution grid may serve distributors. As such, reward distribution grids may belong to a particular class.

RDG classes can have base allocation percentages associated therewith that the system can use to determine how to allocate or direct collected discount money from advertiser offers into respective RDGs. Each RDG can include multiple nodes, and each of the nodes may receive a percentage of the class percent allocation, for example.

In some examples, an unequal award of reward currency among class groups (e.g., a reward currency award to an advertiser group different in amount from a reward currency award to a shopper group) can cause the system to modify base allocation percentages of the corresponding RDG classes. This can cause, for example, an increase or decrease in award amounts for advertiser or shopper groups.

In some examples, the system can use three primary measurement points: low, mid and high. The mid-point can be a configured measurement point, for example, or can be based on ad points or advertisements award or use. Using the mid-point, the system can set an allocation percentage to receive any desired configuration value (e.g. 50%) of offer transaction money directed into that RDG. A low-point measurement point can be configured at a minimal value point (e.g., 35%) and a high-point can be configured at a maximal value (e.g., 135%). Allocation percentages from mid-point to low-point may decrement, and allocation percentages from the mid-point to high-point may increment, with each subsequent RDG (e.g. a 525 RDG equal to mid-point (e.g., 50%), and mid-highpoint, (e.g., 65%) allocation and a next one 526 RDG allocation percent increasing (0.085%) to 50.085% for RDG range of 525 to 700 (175/0.15) and so forth up to RDG 700), in one example.

In some examples, a linked pod node's modified ad point condition can be temporarily applied to an RDG node. The modified ad point condition can vary by an end-user's pod node position or rank value and grade, in some examples. A configuration of group ad point conditions may represent a sum of the conditions associated with a group of pod nodes linked to reward distribution grid nodes. Each pod node may have different modified ad point conditions that can be affected by end-users rank value or grade. In some examples, calculated group ad conditions may lock in for the duration of the linked pod node's cycle counter.

When end-users qualify for an award, RDG nodes may be grouped in various configurations. In some examples, patterns of various configurations may be used for grouping a collection of RDG nodes into a group temporarily. In another example, a rank value or grade may be used to group pod nodes linked to RDG nodes. In yet other example, multiple environmental factors such as a time of day, current cycle counter, or end-users' total cycle count may be used in combination with above or alone to determine group configuration, in some examples.

A calculated group ad point condition of a pod node that is linked to an RDG node can be divided by a base cycle counter value. The system (or a facilitator) may assign a base cycle counter value of 7, for example. The system can use the applied base cycle counter to determine a group ad point condition of one cycle counter of that pod node. In this example, a group ad point condition of 700 points is determined for the pod node. The group ad point condition (700 points) may then be divided by the base cycle counter value (7 in this example) to obtain a calculated result of 100 points. The group ad point condition for one cycle counter of that pod node may then 100 points. For each incremental cycle counter of that pod node, the group ad point condition value can be added to the preceding cycle counter group ad point condition. So for example, in determining the value for cycle counter 2, 100 points may be added to the previous condition value of 100 points, for a value of 200 points. For cycle counter 3, 100 points may be added to the previous condition value of 200 points, for a 300 point condition value, and so on.

A pod module may be used to manage the pod nodes in the system. Pod nodes may be part of pod node groups. Each pod node can have a variety of base ad point conditions, cycle count conditions, activate conditions, deactivate conditions, timer conditions, and the like. In some examples, the pod module can assign pod nodes to shoppers, advertisers or distributors based on a variety of actions or transactions, such as making or accepting a qualified offer, or initiating or participating in a purchase event. In some examples, such actions, transactions, or events may be monetary events or non-monetary events. In some examples, the conditions determine whether an end-user qualifies for reward, when linked to an RDG node. When a pod node is linked to an RDG node, the system may temporarily assign the base conditions of the pod node to the corresponding RDG node.

Configured base ad point conditions of pod nodes can be modified by an end-user's rank value or grade, in some examples. When certain rank grades are achieved, incentives such as a reduction in base ad point conditions of pod nodes can result. Such a reduction may allow the end-user to satisfy higher ad point conditions of pod nodes, in some examples.

As described above, shoppers, advertisers, or distributors can earn ad points based on transactions or actions related to advertisements associated with the ad points. In some examples, a point module can be used to award the ad points. Ad points can be issued by advertisers and earned by shoppers, for example. Ad points may not have an implicit or inherent monetary conversion rate or attachment; for example, based on a given number of ad points associated with an advertisement, it may not be possible for a shopper, advertiser, or distributor to discern a corresponding monetary value associated with the number of ad points. In some examples, ad points can be used to determine whether one qualifies for an award. When a shopper earns ad points, for example, the advertiser and distributor of the offer may also receive ad points (e.g., a same number of ad points, or a percentage of the ad points earned by the shopper). Earned ad points may be accumulated. In some examples, earned ad points may remain valid or usable for a period of time.

Ad points can be earned based on a transaction or action initiated by a given actor (e.g., based on that actor's individual effort), and in some examples can also be earned based on transactions or actions initiated by another actor. In some examples, ad points earned as a result of various transactions or actions can be combined. Earned ad points, such as ad points earned based on actions or transactions by the actor, can be used to satisfy one or more ad point conditions of one or more pod nodes.

Earned ad points can be accumulated and used to satisfy ad point conditions of pod nodes linked to RDG nodes. In some examples, ad points earned from individual transactions may be combined with ad points of other end-users, which may result in a group earned ad point value. In some examples, when using similar grouping methods of ad point conditions, a group earned ad point value can also be determined. Also, the result of a group's earned ad point value may vary (e.g., in an elastic way) with each subsequent award timer cycle. In some examples, such variation may be caused by cycle counters of pod nodes that are linked to RDG nodes unlinking or deactivating, or by an end-user grouping or linking with another temporary set of end-users. End-users may benefit by accumulating a greater amount of ad points by collaborative efforts, which may provide more opportunity to earn awards, in some examples.

When an end-user increases their rank value (e.g., grade may also increase) and accumulates ad points, pods may be activated and linked to RDG nodes. The pod nodes may be deactivated or unlinked when the pod node conditions (e.g. rank or ad point) are no longer satisfied.

Each cycle can include a range of group ad point conditions, for example bounded by a minimum group ad point condition and a maximum group ad point condition. In some examples, satisfying a larger portion of the group ad point condition may result in awarding a larger portion of the available monetary reward associated with the reward distribution node. In some examples, satisfying the minimum group ad point condition may result in awarding (for example) 50% of the available monetary reward associated with the reward distribution node; satisfying the maximum group ad point condition may result in awarding 100% of the available monetary reward; and satisfying a group ad point condition between the minimum and maximum condition may result in awarding a percentage between 50% and 100% of the available reward.

A reward module can be used to manage benefits awarded to shoppers, advertisers, or distributors. In some examples, the benefits may be partially determined by an amount of ad points earned individually and as a group. Each pod node can include one or more limits (e.g., a minimum and maximum) corresponding to amounts that can be received by the pod node per award cycle, according to some examples. The monetary limits can be temporarily passed to, or inherited by, the reward distribution grid node to which the pod node is linked.

In some examples, a monetary minimum can be awarded, per cycle, merely for obtaining the link (that is, at such time as the pod node is linked to a reward distribution node). In some examples, the awarded monetary minimum amount may be, for example, 50% of a possible 100% maximum amount.

The remaining 50%, in this example (the amounts may be different in other examples), of the maximum awardable amount may be awarded only if certain ad point conditions are satisfied, according to some examples, where the ad point conditions may also be passed to the reward distribution grid node so that the reward distribution grid node inherits the conditions from the linked pod node.

The state of reward distribution grid nodes can affect group ad point conditions and earned ad point values. In some examples, values of reward distribution grid nodes in a measured-state can be included in determination of an award. When measured-state nodes are included in group earned ad point values, an actor may increase their opportunity to qualify for an award. If measure-state RDG nodes are not included, a lower group earned ad point value may apply, which may result in reduced opportunity to qualify for an award. The system may determine whether or not to include measured-state RDG nodes based on an actor's rank value and grade, in some examples.

When reward currency is awarded, for example, the reward currency can be associated with either a shopper group or an advertisers group. In some examples, a first transaction role can determine which reward currency group is awarded to an advertiser, shopper or distributor. Reward currency types can include: advertiser, shopper and distributor.

When RC is used in a reward currency transaction, the associated group and type of RC can determine, in some examples, whether a monetization event can occur. For example, a monetization event may occur when two opposing RC groups equally pair in an RC transaction (e.g., the advertiser's reward currency amount in a given transaction matches the shopper's reward currency amount).

In some examples, an advertiser can satisfy a reward currency pair condition without buying additional reward currency from an exchange market and can double their return and the monetary value of a shopper's reward transaction. For example, in a reward currency transaction where the shopper would purchase a product or service for $20.00, the system may require the advertiser to also have $20.00 in reward currency to satisfy a pair condition. If the advertiser has an adequate reward currency balance $20.00 (or more), the advertiser may receive the shopper's $20.00 and the system may release the $20.00 held in their account, for a total payment of $40.00. As such, the monetary value of the shopper's reward transaction may be doubled.

Similar RC groups can exchange, share, give, sell and buy reward currency with others through an exchange market, in some examples. In the exchange market, RC can be sold and bought from other advertisers, shoppers or distributors at a prevailing market rate.

In some examples, the facilitator can provide the advertiser, shopper or distributor with a physical card (e.g., reward debit card) or a digital substitute (e.g., digital wallet) to use for reward currency transactions, or to directly fund an account, such as a bank account, when eligible. When the system awards reward currency, the monetary funds can become available for use with their physical payment card or digital wallet, in some examples. In various examples, the type of reward currency available and loaded into the users' accounts can be of any intrinsic type (e.g., dollar, euro, bitcoin), and can be selectable by the advertiser, shopper or distributor.

An advertiser group can include shoppers, advertisers and distributors who are sellers of products (e.g., sellers to other shoppers). When a first transaction of this type occurs (i.e. shopper, advertiser or distributor is the issuer of an offer), benefits and conditions of the advertisers group can be associated with the seller of the product or service and can include, but are not limited to, additional pod nodes, additional RDG nodes, better measurement parameters, or allocations and reward incentives.

A shopper group can include shoppers, advertisers and distributors who buy products from the advertisers group. When a first transaction of this type occurs, (i.e. shopper, advertiser or distributor is buying an offer), the shopper, advertiser or distributor can receive benefits and conditions associated with the shopper group that can include, but are not limited to, improved pod node limits, improved pod node conditions, improved RDG conditions, or a reward amount.

The distributor group can also include shoppers, advertisers or distributors who provide distribution channels in which offers can be acquired. Distribution of offers can originate from physical, online or print landscapes that can include, but are not limited to, in-store and online storefronts, mobile and web applications, domains, interactive media (e.g., television, radio, etc.), and printed publications such as signage, magazines, newspapers, flyers and the like. When reward currency is awarded and issued to members of a distributor group, the reward currency can be autonomously directed into the exchange market and made available for purchase by advertiser group members.

Depending on the prevailing market price of reward currency when purchased, the buyer (e.g., an advertiser) of reward currency can gain or lose value from the exchange transaction. For example, when the prevailing market rate is greater than the shopper's exchange rate (e.g., greater than 1.0), the reward currency buyer loses value and the reward currency seller gains value. However, when the prevailing market rate is lower than the shopper's exchange rate (e.g., lower than 1.0), the reward currency buyer gains value and the reward currency seller loses value.

The system can determine the prevailing market rate using reward currency factors, such as reward currency circulation amounts between advertiser and shopper groups, in some examples.

A strike price may represent a desired selling price that a seller of reward currency is trying to gain from the sale. The seller can set a strike price, such that the reward currency will not be sold until the strike price is met or its valid offer term expires, for example.

In some examples, a reward currency holding cap or limit (e.g., a maximum amount) can apply for each advertiser, shopper or distributor. An advertiser's holding cap, for example, can be determined by factors such as, but not limited to, advertiser size, transactional volume, offer performance, offer quantity, discount percent assignments, expenditures, and the like. Reward currency earned by a shopper above their holding cap can be autonomously directed into the exchange market and made available for purchase by other shoppers, in some examples. When an advertiser's reward currency holding cap is exceeded, the excess reward currency can be autonomously directed into the exchange market for their benefit.

Described herein are systems and methods that use point advertisements, reward distribution grids, and an exchange market, in some implementations. Discount percentages can be converted into ad points, which may be earned by end-users and associated stakeholders when the point advertisements are redeemed. Accumulated ad points can be used to satisfy various conditions, and pod nodes can be activated or linked to reward distribution grid nodes that can have associated therewith stored monetary value derived from the monetary discount percentage values of redeemed advertisements or purchase transactions. Each linked node can store monetary value as reward currency, and the system can award the reward currency. In some examples, pairing conditions can be associated with certain transactions or advertisements, and in response to a failure of a pairing condition, reward currency may be acquired via exchange market so that the pairing condition may be satisfied, for example.

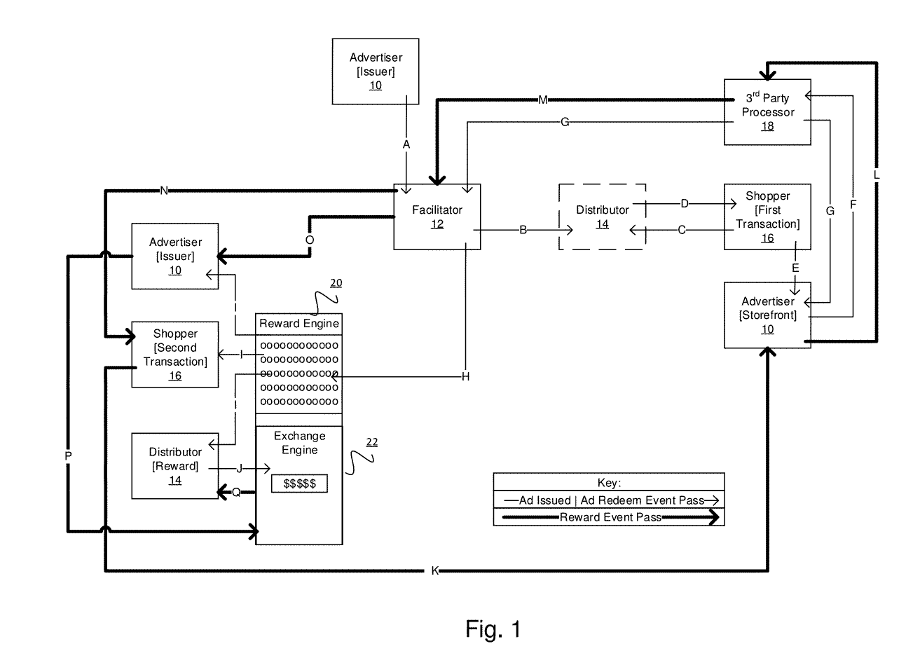

FIG. 1 is a conceptual block diagram of an example collaborative reward system. The lettered arrows A-Q represent examples of steps that can be performed to provide a collaborative reward system. At step A, an advertiser 10 contacts a facilitator 12 (e.g., an operator or owner of the collaborative reward system) with intent to create an incentivized offer that is associated with a percentage value. The facilitator 12 (e.g., using the system) may convert the percentage value of the incentivized offer into ad points, and the offer may be referred to as a point offer or an incentivized point offer. At step B, the facilitator 12 optionally distributes the incentivized point offer through one or more distributors 14, which in some examples can include the facilitator 12 (e.g., if separate distributors 14 are not used in some examples). At step C, a shopper 16 acquires or buys an incentivized point offer from the distributor 14. At step D, the shopper 16 is associated with the incentivized point offer. At step E, the shopper 16 redeems the incentivized point offer, in this example at a storefront of the advertiser 10. At step F, the advertiser 10 processes the shopper's payment for the transaction using a 3rd party processor 18. In some examples, the 3rd party processor 18 may be an internal component of the system. At step G, the 3rd party processor 18 settles the shopper's payment transaction and credits the advertiser 10, and in some examples credits the facilitator 12.

At Step H, the facilitator 12 links or associates pod nodes associated with the advertiser 10, shopper 16 and distributor 14 (in this example) to reward distribution grids of a reward engine 20 (representationally shown as a grid in FIG. 1) and to nodes of the reward distribution grids. The system may activate a number of links between the pod nodes and the nodes of the reward distribution grids. In some examples, a number of activated links can be determined by an amount of the shopper's transaction and a plurality of parameters, including collaborative parameters in some examples. At step I, the reward engine 20 awards the advertiser 10, shopper 16 and distributor 14 reward currency based on collaborative parameters. The shopper's awarded reward currency may be deposited into an account of the shopper 16, and the advertiser's awarded reward currency may be deposited into an account of the advertiser 10. At step J, the distributor's awarded reward currency is directed into an exchange engine 22, which can manage an exchange market.

At step K, the shopper 16 makes a purchase from the advertiser 10 in second transaction. In contrast with the first transaction, which was paid for using currency from outside of the system, the second transaction may be paid for using currency from within the system (e.g., using reward currency), and may be a reward transaction. While in this example the shopper's second transaction is shown as occurring between the shopper 16 and the same advertiser 10, in other examples the shopper may use their reward currency in a second transaction with a different advertiser, for example. The second transaction may involve use a facilitator-provided payment instrument. At step L, the shopper's second transaction is processed by the 3rd party processor 18. At step M, the 3rd party processor 18 requests approval from the facilitator 12 for shopper's second transaction. At step N, the facilitator 12 verifies that the shopper's reward currency account (which may be maintained in the system) includes sufficient reward currency for the second transaction. At step O, the facilitator 12 validates that the advertisers' reward currency account (which may be maintained in the system) includes sufficient reward currency for the second transaction. In some cases, in validating that the advertiser's account includes sufficient reward currency for the second transaction, the system verifies that the advertiser's account includes sufficient reward currency to satisfy a pairing condition, such as a condition that the advertiser have at least a an amount of reward currency equal to the reward currency used by the shopper for the second transaction (e.g., at least a matching amount).

In this example, assume that the advertiser 10 does not initially have a sufficient amount of reward currency to satisfy the pair condition. At step P, following a determination that the advertiser 10 does not have sufficient reward currency to satisfy the pairing condition, the advertiser 10 purchases additional reward currency via the exchange market of the exchange engine 22. The purchased additional reward currency, combined with the advertiser's previously acquired reward currency, may permit the pairing condition to be satisfied, and the second transaction may be processed. In some examples, the reward currency purchased at step P may correspond to the reward currency provided to the exchange market by the distributor 14 at step J following the first transaction. At step Q, the exchange engine 22 releases funds to the distributor 14 as compensation for the exchange market purchase of the distributor's reward currency by the advertiser 10 at step P.

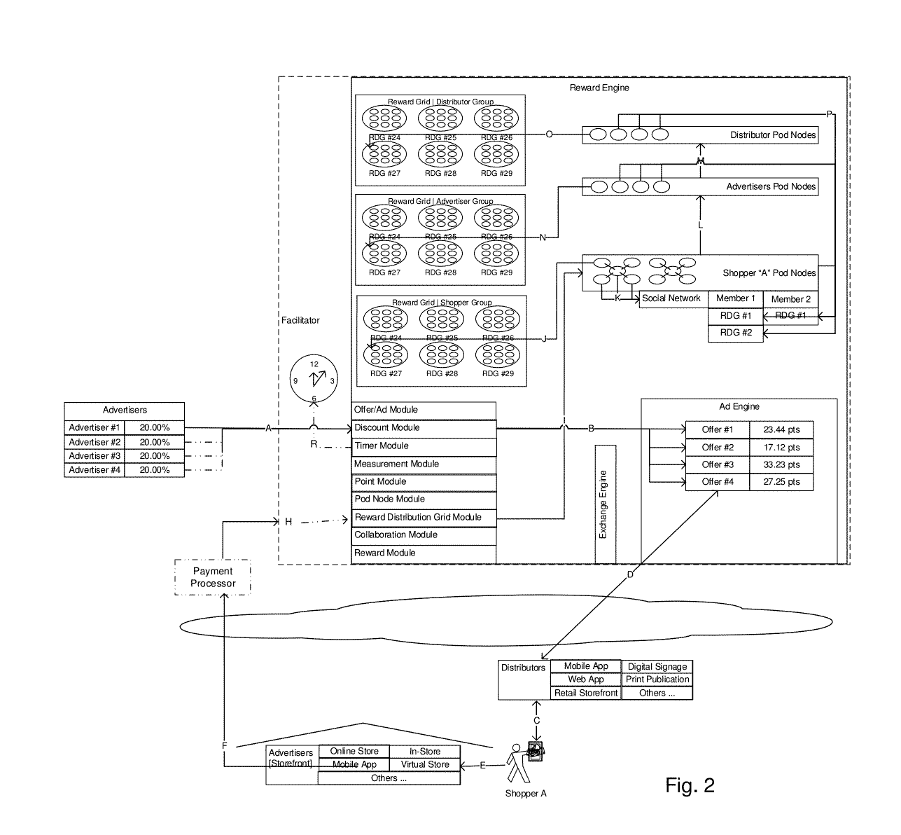

FIG. 2 is a conceptual block diagram of an example collaborative reward system. The lettered arrows A-R represent examples of steps that can be performed to provide the collaborative reward system. At Step A, one or more advertisers create and offer incentivized offers with discount percentage rates, and submit the offers to a facilitator (e.g., an owner or operator of the collaborative reward system). At Step B, the facilitator processes the incentivized offers and determines an appropriate ad point value for each of the offers. The system may use a discount module to determine the ad point value for each of the offers. As representatively shown in FIG. 2, even though each advertiser is offering exactly the same incentive, (i.e. a 20% discount percentage in this example), ad point values assigned to incentivized offers #1 through 4 can differ. For example, Offer #1 includes 23.44 ad points; Offer #2 includes 17.12 ad points; Offer #3 includes 33.23 ad points; and Offer #4 includes 27.25 ad points. At Step C, shopper A receives, for example on a mobile computing device, an incentivized offer from a distributor. Without limitation, the distributor may distribute the incentivized offer via a mobile app, a web app, a retail storefront, digital signage, print publication, or in other ways. In some examples, the facilitator may distribute the incentivized offer without using a separate distributor.

At Step D, shopper A receives incentivized point offer #4 from an ad engine of the facilitator through a representative distributor, and the ad engine associates shopper A with incentivized point offer #4. At Step E, shopper A redeems incentivized point offer #4. In this example, shopper A redeems the offer at an issuer (e.g., advertiser) storefront by engaging in a transaction. In other examples, the shopper may redeem an offer via an online store, via a virtual store, or the like, and the shopper may use a mobile computing device in redeeming the offer. The shopper may provide currency for the transaction, and the currency may come from outside of the system. At Step F, the advertiser requests compensation for the transaction from a payment processor, and compensation is provided to the advertiser after the transaction is approved. In some examples, the compensation to the advertiser can be the transaction amount minus a monetary value of incentivized point offer #4.

At Step H, the monetary value of the incentivized offer #4 is provided to a reward distribution grid module of the system. At Step I, the reward distribution grid module, and in some examples with assistance from other modules of the system, determines a number of qualified pod nodes that can be assigned to shopper A based on the transaction and which are eligible to link to nodes of reward distribution grids. The reward distribution grid module may also determine allocation percentages as to how the monetary value associated with the transaction will be allocated. At Step J, the pod nodes determined in the previous step for shopper A are linked to associated nodes of a reward distribution grid determined to be applicable to incentivized offer #4, and applicable to shoppers (e.g., shopper reward distribution grid #27 in this example).

At Step K, the reward distribution grid module determines that the transaction involving offer #4 can provide eligibility for additional pod node links to a reward distribution grid. In this example, the system provides additional associations or links between pod nodes assigned to shopper A to nodes of reward distribution grids associated with Member 1 and Member 2 of shopper A's social network. In this manner, shopper A may benefit by access to reward distribution grids that they would otherwise not have access to but for the association via the social network. In other examples, the system may link the pod nodes of shopper A to other reward distribution grids (e.g., reward distribution grids RDG #28 or #29 in the Shopper Group of FIG. 2) without using connections via the social network. In this example, the system links pod nodes for shopper A to reward distribution grids #1 and #2 associated with Member 1 of shopper A's social network, and links a pod node for shopper A to reward distribution grid #1 associated with Member 2 of shopper A's social network. In this example, then, four pod nodes for shopper A may be linked to reward distribution grids based on the transaction that involved offer #4. In some examples, the linking of pod nodes to RDG nodes based on social network associations is not used.

At Steps L and M, the system temporarily associates the advertiser and the distributor of incentivized offer #4 with shopper A, based on the transaction that involved offer #4. At Steps N and O, the system links pod nodes assigned to the advertiser and the distributor, respectively, to nodes of reward distribution grids associated with advertisers and distributors, respectively, and associated with shopper A (e.g., advertiser reward distribution grid #27, and distributor reward distribution grid #27 in this example).

At Step P, the advertiser and distributor are permitted additional pod nodes to link to advertiser or distributor reward distribution grids, respectively, of shopper A's social network, thereby also resulting in four link events for each of the advertiser and distributor, in similar fashion as shopper A was granted four link events. At Step R, one or more timer modules expire and reset, causing a plurality of other modules to adjust, modify, award benefits, and execute changes within the reward engine. These updates can apply to advertisers, shoppers, and distributors.

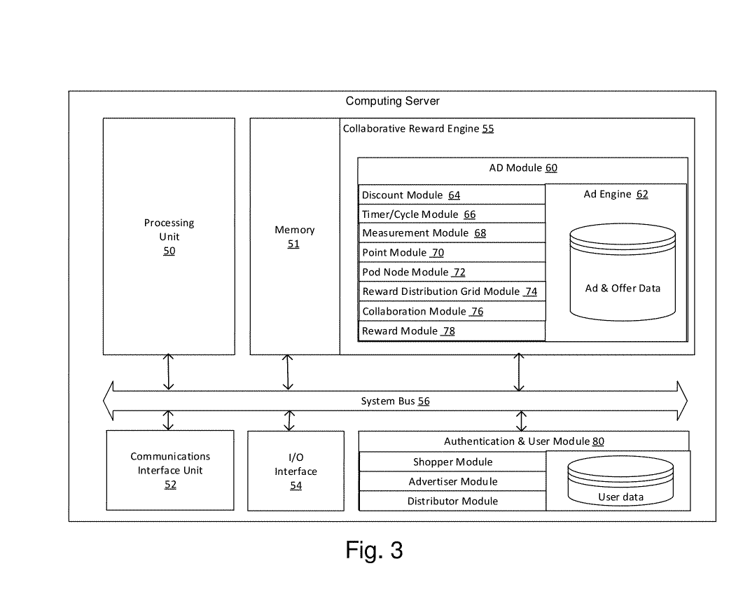

FIG. 3 is a conceptual diagram of an example computer server that can be used to provide example collaborative reward systems. The computer server includes a processing unit 50, which may include one or more processors that can execute instructions to perform tasks for the collaborative reward system. The server also includes a memory 51, which may store instructions that can be executed by the processor 50 and which may store data for use by the processor 50. The server includes a communications interface 52 that can be used to communicate with devices external of the server, for example over one or more communications networks. The server includes an I/O interface 54 for receiving input and providing output to or from the system. The server includes one or more system busses 56 over which communications among various components or modules of the server may communicate.

The server includes a collaborative reward engine 58, which includes several modules used to implement the collaborative reward system. An ad module 60 manages an ad engine 62 that can be used to create advertisements, such as incentivized ad offers associated with a discount percentage of the offer. A discount module 64 can be used to determine a value of ad points associated with an offer, based on the discount percentage of the offer and on a number of other factors associated with the corresponding advertiser and with parameters of the advertisement, for example. A timer or cycle module 66 manages a plurality of timers or cycle counters used in implementing the collaborative reward system. A measurement module 68 can be used to grade actions and events of shoppers, advertisers and distributors. A point module 70 can be used to award ad points to shoppers, advertisers, or distributors, for example. A pod node module 72 can be used to associate pod nodes with advertisers, shoppers or distributors. A reward distribution grid module can be used to manage reward distribution grids, and in some examples can be used to link a pod node to a node of a reward distribution grid, and to manage inheritance by the reward distribution node of parameters of the pod node when the pod node is linked to the reward distribution grid node. A collaboration module 76 can be used to determine collaborative relationships among actors participating in the system. A reward module 78 can be used to manage benefits awarded to shoppers, advertisers, or distributors. The collaborative reward engine 58 can include one or more data stores for storing data or information used in operating the collaborative reward system.

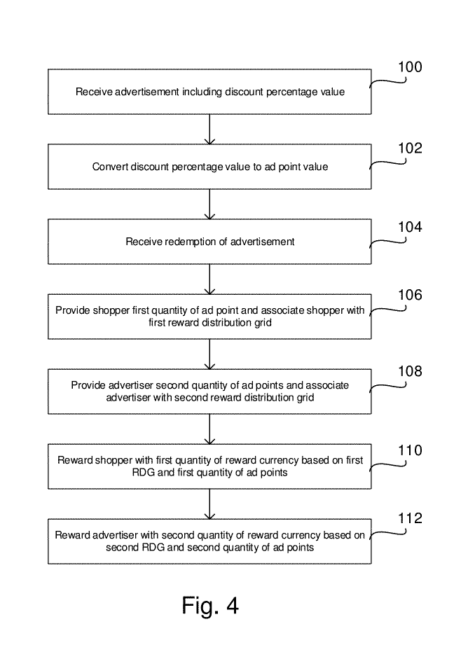

The collaborative reward engine 58 also includes an authentication & user module 80 (shown separately in FIG. 3 for convenience), which includes a shopper module, advertiser module, and distributor module for managing aspects of the system pertaining to each of shoppers, advertisers or distributors, respectively. The module 80 can also include one or more data stores for storing system data. FIG. 4 is a flowchart of example steps that can be used to provide a collaborative reward system. At a first step 100, an advertisement is received, at a central computer system, where the advertisement includes a discount percentage value for the advertisement. The advertisement may be received from an advertiser, for example. At a second step 102, the discount percentage value is converted, by the central computer system, to an ad point value. At a third step 104, the central computer system receives an indication of a redemption of the advertisement, where the indication of the redemption of the advertisement is provided by a shopper. At a fourth step 106, the central computer system provides the shopper a first quantity of earned ad points based on the indication of the redemption of the advertisement and on the ad point value of the advertisement. The central computer system further associates the shopper with a first reward distribution grid based on the first quantity of earned ad points. At a fifth step 108, the central computer system provides the advertiser a second quantity of earned ad points based on the indication of the redemption of the advertisement and on the ad point value of the advertisement, and associates the advertiser with a second reward distribution grid based on the second quantity of earned ad points. At a sixth step 110, the central computer system rewards the shopper with a first quantity of reward currency based on the first reward distribution grid and the first quantity of earned ad points. At a seventh step 112, the central computer system rewards the advertiser with a second quantity of reward currency based on the second reward distribution grid and the second quantity of earned ad points.

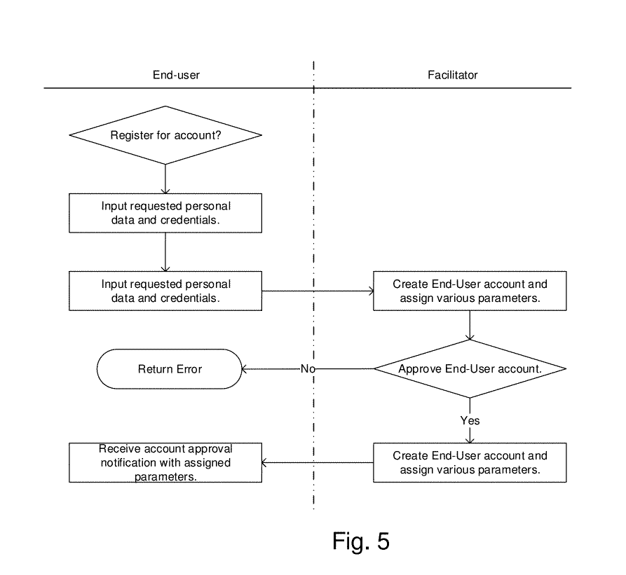

FIG. 5 is a flow diagram of example steps that can be used for registration. An end-user (EU) can enroll for an account in the system (e.g., via the facilitator) by accessing a dashboard interface, navigating to an enrollment form, and providing requested data (e.g., name, email location, password and personal identification number (PIN)). The dashboard interface can include interactive content, forms and controls, and layout, interactions and controls can vary based on a type of computing device used by the EU. The facilitator may receive and validate the information, and create an account for the EU. Various parameters can be assigned to the account, including a measurement value and its associated measurement grade, username and identity. In some examples, the assigned measurement grade may be based on a measurement value. In some examples, the EU select from different levels of membership when enrolling, where each membership level includes a particular starting measurement value as an incentive. In some examples, the system (e.g., the facilitator) may assign a default measurement value, which may be associated to measurement grade, to the newly enrolled EU.

After enrolling, an EU can increase their measurement value by engaging in various activities that include, but are not limited to, reviewing an offer, reviewing an advertiser, and other activities such as sharing, liking, clicking and trying or returning to advertisers for a second purchase event and attaining various point, expenditure and reward milestones.

Over time, the system can increase or decrease an EU's measurement value based on EU actions. When an EU's measurement value increases, the EU may receive incentives that can include, but are not limited to, a reduction in pod node point conditions, a shortened cycle counter (which may permit more frequent reward opportunities), or increased association opportunities with pod nodes, which may afford the EU opportunities to receive larger or more frequent monetary rewards, for example.

The system may determine measurement values and grades, and may consider various actions or events that occur in various time periods. For example, various actions and events of a shopper, advertiser or distributor can be graded at various predefined points in time. During grading, each qualified action and event can be given one action point that may not be disclosed, and the action points can be accumulated for the given actor.

Measurement points may correspond to points in time where action points are divided by a root base action point figure, for a given actor. In some examples, the root base action point figure can vary with each measurement point and can be, for example, a maximum number of action points obtainable during a measurement-cycle-term. Additionally, the measurement points can be direct to another set of configured measurement points by using various threshold percentages (e.g., use second measurement point configuration for 100 to 120 action points, or when over 10% but under 12%) associated with various measurement grade levels.

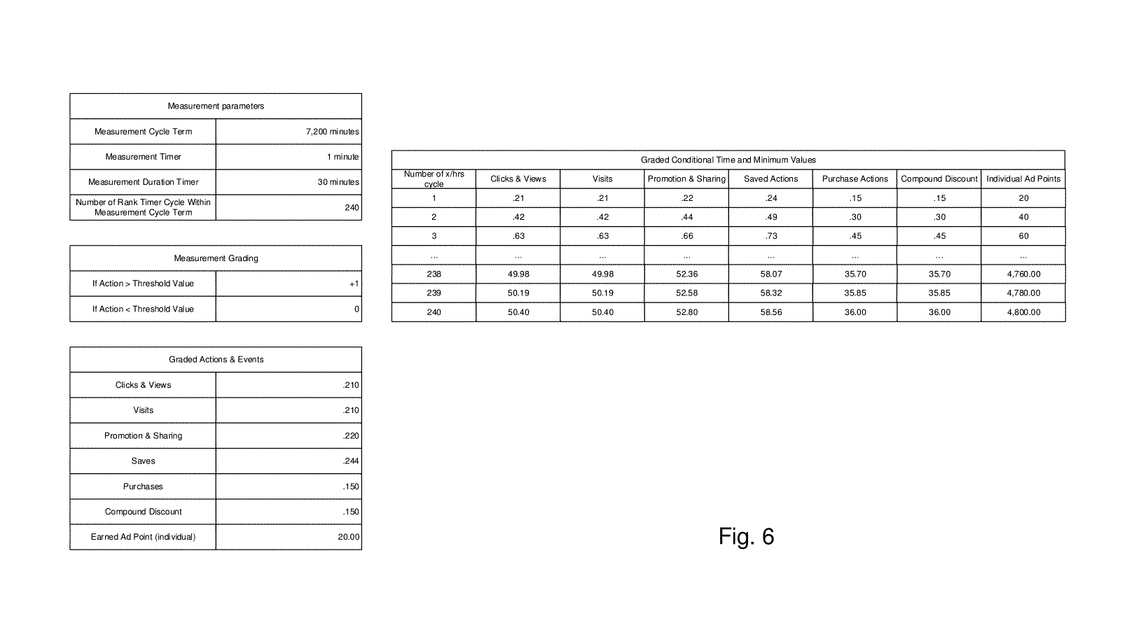

FIG. 6 illustrates an example rank measurement grading method. FIG. 6 shows a table that sets a measurement cycle term value (MCTERM) (e.g., 7200 minutes), a measurement timer value (e.g., 1 minute), and a measurement duration timer value (e.g., 30 minutes) for this group of measurement parameters. Although this example only shows three timing parameters, in other examples there may be more or fewer timing parameters. During an active period of an MCTERM, there may be segments of measurement points, where at each segment a grading event may occur. The depicted example includes 240 measurement timer cycles (e.g., 7200/30), and thus 240 different measurement points.

When a measurement point occurs, the system may award action points for a qualifying action or event (e.g., “clicks & views,” “visits,” “promotion & sharing,” “saves,” “purchases,” “compound discount,” “earned ad points (individual)”—see Graded Action & Events table in FIG. 6), such as actions or events that satisfy values of the Graded Conditional Time and Minimum Values Table of FIG. 6. A Measurement Grading Table shows a number of awarded action points per satisfied figure. The action points can be accumulated for the duration of the current measurement cycle term. Upon expiration of the measurement cycle term, the EU's current measurement grade value and grade can become a starting point of another set of measurement configuration tables and parameters (e.g. ending MCTERM at brown level 3 may direct to a brown level 3.1 measurement configuration table).

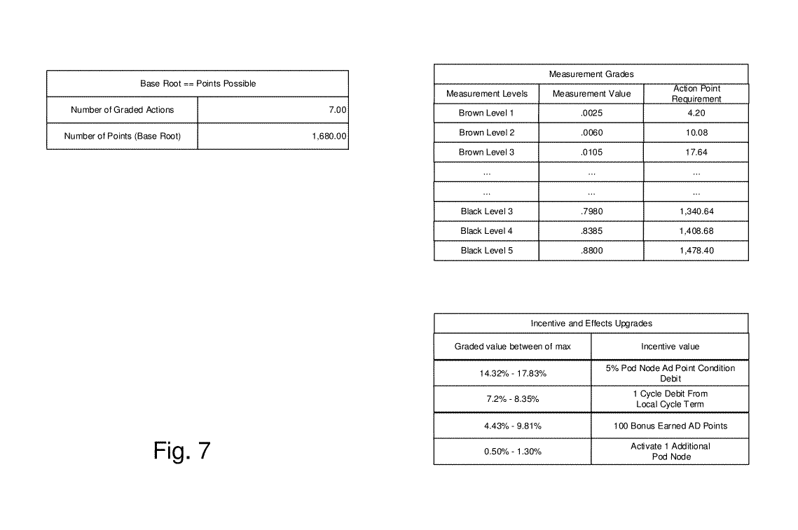

FIG. 7 illustrates example tables and parameters that can be used to grade actions and events for determining a rank grade value. An example measurement grades table that provides example measurement values, associated measurement levels, and action point requirement values. During the course of an MCTERM, the EU's accumulated action point values can increase or decrease. When an EU's action points increase, the system may award levels of measurement and incentive upgrades, and when an EU's action points decrease, the system may pull-back levels and incentives, for example. An Incentive and Effects Upgrades Table of FIG. 7 shows examples of incentives (e.g., activating an additional pod node, awarding bonus ad points, debiting a cycle from a local cycle term, debiting a percentage from a pod node ad point condition). Action point thresholds and requirements may change with each graded measurement point and/or in a subsequent MCTERM, according to some examples. This possibility of variability can either make level requirements more difficult or easier to attain, depending on the example.

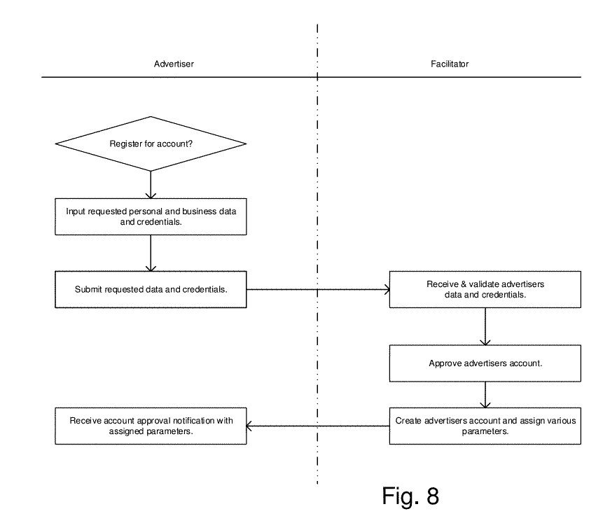

FIG. 8 is a flowchart of example steps that can be used for an enrollment process. For example, an advertiser may enroll in the system, for example via a facilitator. The advertiser can access the facilitator's dashboard interface and navigate to an enrollment form and provide information (e.g., name, business name, type, size, phone, email, location, password). The dashboard interface can include interactive content, forms and controls, and layout or presentation can vary depending on a type of computing device the advertiser is using to access the software application. The facilitator may validate the advertiser's application submission and create an account. The system may assign parameters to the account, such as a measurement value associated with a measurement grade, a username and identity.

In some examples, an advertiser can create advertisements by contracting work to an intermediary, for example using a self-service dashboard. The intermediaries can be the facilitator or a third-party agent (e.g., selectable via the dashboard), in various examples. The advertiser can provide designs, images and descriptive work to the intermediary. The facilitator can review and approve the designs, and store in a storage location (e.g., a library location) for the advertiser. The advertiser may be able to access the library and reuse design work of past product advertisements, in some examples, for creating new advertisements. An intermediary may receive monetary compensation for each advertisement acquired (e.g., saved, redeemed, resulting in a purchase). The intermediary can be paid in reward currency for the advertisement design work performed by the intermediary, in some examples. Such reward currency can later be monetized following a purchase (e.g., by an advertiser) of the reward currency from the exchange market to satisfy a pairing condition, for example.

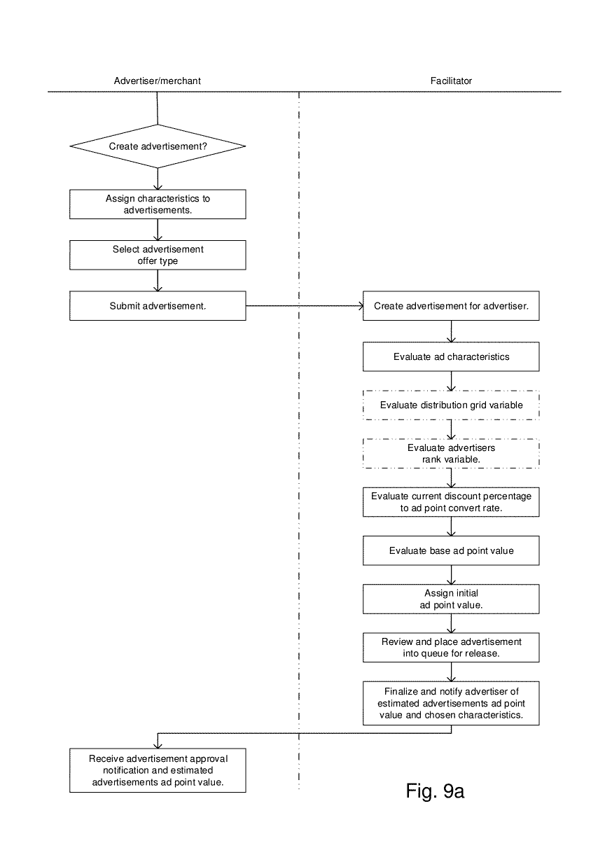

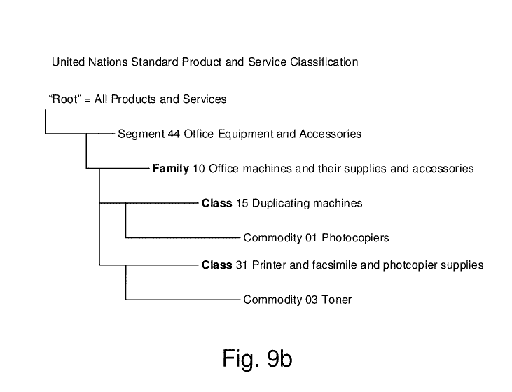

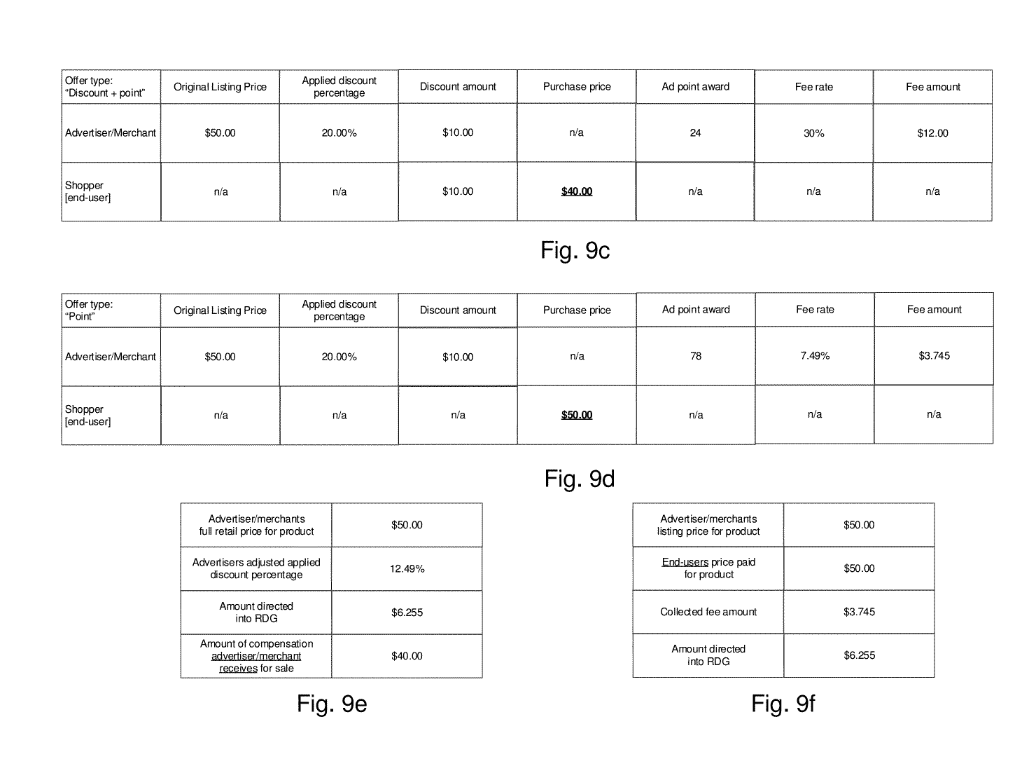

FIG. 9a is a flow chart diagram of example steps that can be used to create an advertisement and assign ad points to the advertisement. In some examples, the advertiser can select advertisement designs from a library of available designs or descriptive work, or can create a new design or create new descriptive work. An advertiser may select various advertisement characteristics, such as, for example, a product family (e.g., selected from an array of product families or classes) and an advertisement offer type, a minimum and maximum dollar value for the offer, a discount percentage figure, an issuance amount, a release time and schedule, a distribution method, location options, a name, and acceptable redemption methods.

FIG. 9b illustrates example codes that can be used to classify advertisements or reward distribution grids. The advertiser can select a product-family and product class for advertisements. A product-family may group together similar product-classes, which may be identified using alphanumerical characters. In some examples, the system may use the United Nations Standard Product and Services Code (UNPSC) (an example of which is shown in FIG. 9b) and/or GS1 standards to identify a product-family and its product-classes of products. In some examples, the North American Industry Classification System (NAICS) may be used to identify the type and operational segment of an advertiser. The system may also use a proprietary identification system to identify assigned advertisement characteristics, in some examples. In cases where advertisers sell products from multiple product-families, an advertiser can create multiple ad campaigns using different product-families, for example up to an issuance limit (e.g., total ad offers concurrently available at a given time) that may be assigned to the advertiser.

FIGS. 9c and 9d illustrate example tables with example parameter values for example discount-plus-point and point-only ad types, respectively. FIG. 9c pertains to discount-plus-point ad types (e.g., that provides to a shopper an immediate markdown or discount from an original price, plus ad points), while FIG. 9d pertains to point-only ad types (e.g., that provide a shopper ad points but do not provide an initial discount in price). Ad advertiser may select an ad type. An ad point value for an ad may be assigned by the system based on an applied discount percentage of the advertisement and an ad-point-to-discount-percentage conversion rate. Discount-plus-point ads can provide a benefit of providing a discount for shoppers accustomed to immediate discounts, and also providing ad points that can provide reward incentives via reward distribution grids. A service fee may be collected by the facilitator and directed into a reward distribution grid. The tables of FIGS. 9c and 9d provide examples of what a shopper may pay for a product, and illustrate differences in purchasing the product via a discount-plus-point ad versus a point-ad. In the discount-plus-point example of FIG. 9c, an advertiser may receive $28.00 initially on a sale of a product having an original listing price of $50.00 (the $40 paid by the shopper when a 20% discount is applied, less a $12 fee deducted by the facilitator in this example).

FIGS. 9e and 9f illustrate example tables with example parameter values for an example point-only ad. Point-only ads may not provide an initial discount in price to a shopper. However, a monetary amount based on a discount percentage value of the advertisement may be directed into a reward distribution grid following a redemption of the ad, which may provide the shopper and advertiser an incentive to receive an undisclosed and variable rebate amount for a period of time after the redemption (e.g., purchase of product or service based on the ad).

FIG. 9e, for the example point-only ad of FIG. 9d that includes a discount percentage of 20%, shows that $40.00 ($50 less the 20% discount percentage) is the amount received by the advertiser when a shopper makes a purchase for $50.00 in this example. Note that the shopper still pays $50.00 in this example, and the facilitator may collect the remaining $10.00 as a fee. A portion of the $10.00 fee may be then directed into a reward distribution grid, as shown in the tables of FIGS. 9e and 9f. For example, $6.255 (based on an adjusted applied discount percentage) may be directed into a reward distribution grid. Following a redemption of the point-only ad of FIG. 9d, the shopper, advertiser and (if applicable) the distributor may receive the ad point award shown in FIG. 9d. The system may determine appropriate reward distribution grids to which pod nodes for the shopper, advertiser or distributor may be linked, and which may provide participation in the reward system, where the collected fee (and other collected fees) may be returned as a reward.

Benefits for an advertiser using a point-only offer type can include reduced ad costs or marketing costs, no out-of-pocket service fees, participation in the monetary reward system, returned revenue/profit from applied discount percentage, greater reward possibility and increased shopper engagement, in some examples.

When an advertiser selects an offer type, a floating-point discount percentage (e.g., 24.77%) can be selected and applied. Alternatively, depending on the offer parameters selected, the advertiser may be required to assign a minimum and maximum dollar value instead. When a min/max dollar value is used, its dollar value can be converted into a discount percentage figure. The discount percentage figure can be converted by the system into an ad point value using the current discount-percentages-to-ad-point conversion rate (DCTOAD).

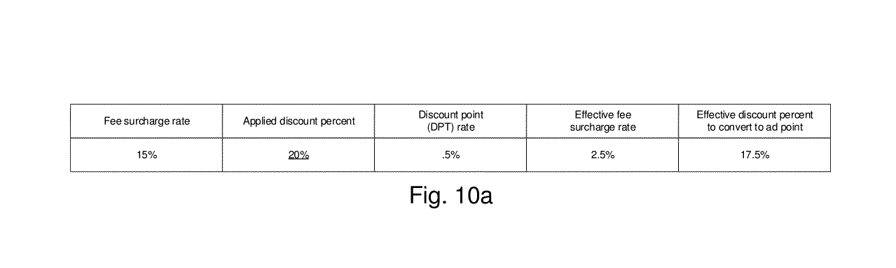

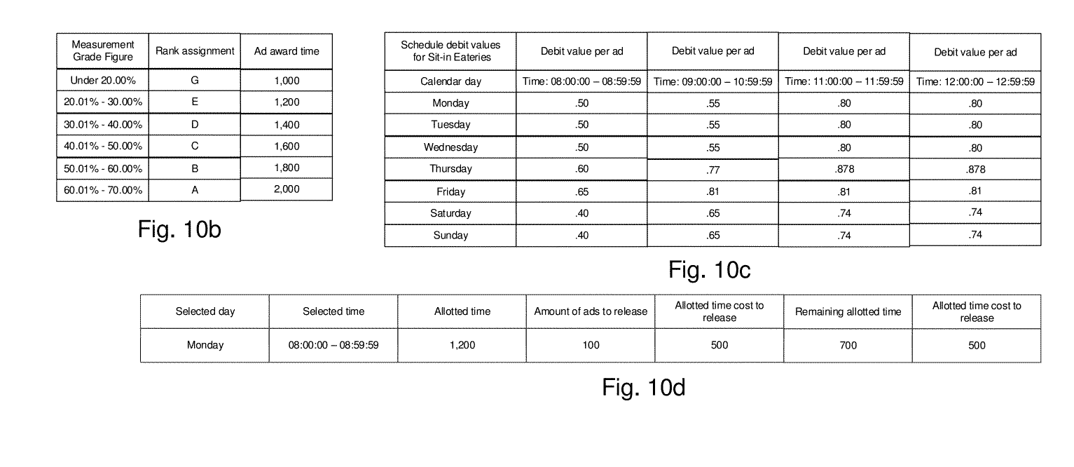

FIG. 10a illustrates fee debit parameters prior to ad point conversion. A fee surcharge percentage rate can be debited from the advertisement's applied discount percentage prior to converting the applied discount percentage. In an example, the fee surcharge percentage rate may be 15% and the applied discount percentage rate may be 20%. In some examples, the fee surcharge percentage rate can be multiplied by the applied discount percentage rate, resulting in a calculated fee surcharge percentage rate of 3.00% in this example. The DPT rate may be 0.5% in an example, and can be debited from the calculated fee surcharge percentage rate, to produce effective fee surcharge rate of 2.5%, which can be directly debited from the applied discount percent prior to converting it into an ad point figure. The effective discount percent to convert to ad point can then be used for the conversion. When a purchase transaction occurs, the facilitator may collect the effective fee surcharge rate as a fee. In this manner, the fee may be captured from the shopper rather than from the advertiser, for example.

In some examples, the fee surcharge percentage rate may be an implicit addition or debit from the applied ad discount percentage rate. For example, a fee surcharge percentage rate of 7.49% can either be added to or debited from an applied ad discount percentage rate.

When added to an assigned ad discount percentage rate, the discount percent to ad point conversion can occur prior to adding the fee surcharge percentage rate. For example, an advertisement can be assigned a discount percentage rate of 20.00% with a fee surcharge rate of 7.49%. The 20.00% value can be used for the discount-to-ad-point conversion, and the additional 7.49% can be collected after a transaction occurs, for a total discount percentage amount of 27.49%. In some examples, a debit of a fee surcharge percentage rate from an ad's assigned discount percentage can result in a total discount percentage amount of the assigned figure (e.g., 20.00%) and discount to ad point conversion applied to 12.49%, the debit of the fee can affect the ad point figures assigned to an ad offer.

An ad campaign size can be selected. The advertiser may select a desired number of advertisements and a release schedule. In some examples, the system may place restrictions on the number of advertisements that can be created, released or active based on the advertiser's current measurement figure and associated grade. For example, an ad award time limit can affect a number of ads that can be concurrently created, active and released, in some examples.

The system may limit, in some examples, release of ads having different product-families or product-classes. In some examples, such ads may be required to be within a scope of products sold by the advertiser. For example, for ads offered for line-item products, such as, but not limited to, those in the consumer's packaged goods (CPG) and prepared foods industry. Benefits for setting release limits can include, in some examples, greater spread of monetary distribution into reward distribution grids, targeted ad offers specific to a brand or product, offer limitations, increased amount of pod node and reward distribution grid node links, searches by product type, and limiting circulation of ads that are, for example, too similar.

As shown in FIGS. 10b, 10c and 10d, the advertiser may select a scheduled release time and duration. An amount of advertisements the advertiser is allowed to release can be directly related to their active ad award time, in some examples. The amount of active ad award time can be increased by attaining a greater measurement figure and grade level, as shown in the example table of FIG. 10b. When an advertiser is able to increase its measurement grade figure, the system may increase award additional active ad award time, for example. Conversely, when an advertiser's measurement grade figure declines, the system may reduce ad award times. In this manner, ad award time may be elastic and, at least partially, based on performance.

When an advertiser selects a release time, the advertisement can be associated with calendar day and time slots, as shown for example in FIG. 10c. In general, the release day and times can be scheduled in any desired way, but in some cases can be limited to an amount of available ad award time for the advertiser. For example, an advertiser having 1,000 hours of available ad award time can release advertisements up to that amount (e.g., concurrently).

For every ad released and active, the system can debit an amount from the advertiser's available ad award time. In some examples, it may be desirable to limit a number of offers and allow strategic scheduling, such as in a competitive offer environment. When advertisements are scheduled and released, the corresponding ad award time may not be replenished or returned to the advertiser until the advertisement is either redeemed or expires, in some examples.

With reference to FIGS. 10c and 10d, a time figure (which may vary based on the timing of the ad's release) may be debited for each ad released. Debit amounts for prime days and/or times may be higher than debit amounts for less desirable or popular days/times. In some examples, the selected day, time and duration can affect the ad's calculated live ADPT figure.

The advertiser can select redemption methods by which the ad may be redeemed, such as, for example, cash tender, online-purchase, purchase via card-linking, or purchase with web authentication. The cash method can allow a shopper to redeem an ad by digitally presenting it to an advertiser (e.g., on a mobile computing device) and activating the ad, and the system may verify the redemption using a validation method at the time of checkout. An advertiser using a cash redemption option, however, may be required by the system to have monetary funds or reward currency that has converted into cash in an escrow account. The escrow account can be used to ensure that monetary funds are available for direction to reward distribution grids associated with the ad following a redemption of the ad. For cash redemption options, an advertiser's escrow balance can limit an amount of ads that can be concurrently issued, in some examples.

In some examples, the facilitator may offer an advertiser a float figure that can represent an amount of ads that an advertiser can release above what might ordinarily be permitted given the advertiser's existing escrow balance. The float figure can be assigned by the facilitator and can act as credit, allowing the advertiser to increase a number of available ads in some examples.

For cash-redemption ads, the system may require a min/max discount value so that an estimated payable reward amount can be determined. In some examples, the float may be based on the ad value and current escrow balance. A float value may be a multiplier so that, for a float of 1.35, for example, a permissible number of ads may be 1.35 times the number of ads ordinarily permitted based on a current escrow balance. For example, if an advertiser assigns a max discount value of $10 and has an escrow balance of $100, a 1.35 float may allow $135 worth of ads, as opposed to $100. As such, the float may increase an offer availability count from 10 to 13.5, in this cash-redemption example.

To redeem a cash-redemption ad, the shopper may first acquire the ad, for example on a mobile computing device via a distributor source. The ad may be saved and available within the shopper's account. When the shopper wants to redeem the cash-redemption ad, the shopper may visit the advertiser, and activate the ad using a computing device, for example. Upon activation, the system may initiate a timer and provide an authorization code. The shopper can present the offer to the advertiser to redeem the ad (e.g., using a computing device). In some examples, a transaction amount can be input to the computing device and the advertiser can provide an authorization code. In some examples, the shopper provides the advertiser with the system-provided authorization code. The system may send an electronic confirmation message to the shopper and the advertiser. The system may award ad points to the advertiser, shopper and distributor.

For an online-purchase, the shopper may select an ad and redeem the ad using a computing device. In some examples, ads presented as display advertisements can be redeemed without navigating from a current view. For example, a modal or other web-interface panel that provides a check-out process can be presented. The system made award ad points to the shopper, advertiser and distributor following the redemption.

In some examples, a shopper can redeem an ad by associating the ad with a payment card, which may be referred to as card-linking. A payment gateway (e.g., of an existing payment network infrastructure) can recognize the payment card event when the payment card is swiped or keyed-in at point-of-sale (POS) terminal, for example. The payment processor, or the system in some examples, may then apply monetary discount offer incentives at settlement. The system (e.g., for the facilitator) may capture monetary fees and credit the amounts to one or more reward distribution grids associated with the offer or the shopper, advertiser, or distributor. Card-lined redemptions may reduce a redemption burden on advertisers, in some examples.

As another example of a redemption method, a shopper may provide an indication of a pre-purchase or pre-redemption of the ad, and may finally redeem the ad at a later time, for example in-store. The shopper may select an ad for pre-purchase. In general, ads may be presented to a shopper (e.g., on the shopper's computing device) via a first-party or third-party distributor channel. The shopper may select a “buy” option, and payment can be requested from the shopper. The shopper can provide payment card information to purchase the ad. The payment may be processed, and details of the ad can be card-linked to the payment card. The system can award the shopper, advertiser and distributor ad points. The shopper can then visit the advertiser's retail location and check-out with that payment card. The payment can be processed, and the card-link provider can be notified of the purchase event. Upon settlement, the pre-bought value of the product or service can be applied as return credit.

Alternatively, a shopper may pre-buy a good or service via an ad, and then redeem in-store with web & mobile authentication. The shopper may pre-buy as described above (e.g., using an ad from a distributor). The system may send an ad link to the shopper, for use as a redeemable voucher in-store. The shopper can activate the ad (e.g., using a first-party mobile application or clicking the ad link), and at check-out the shopper may be required to confirm a second-time their intent to redeem the ad. Details of the ad may be provided to the advertiser, and the ad redemption can be confirmed.

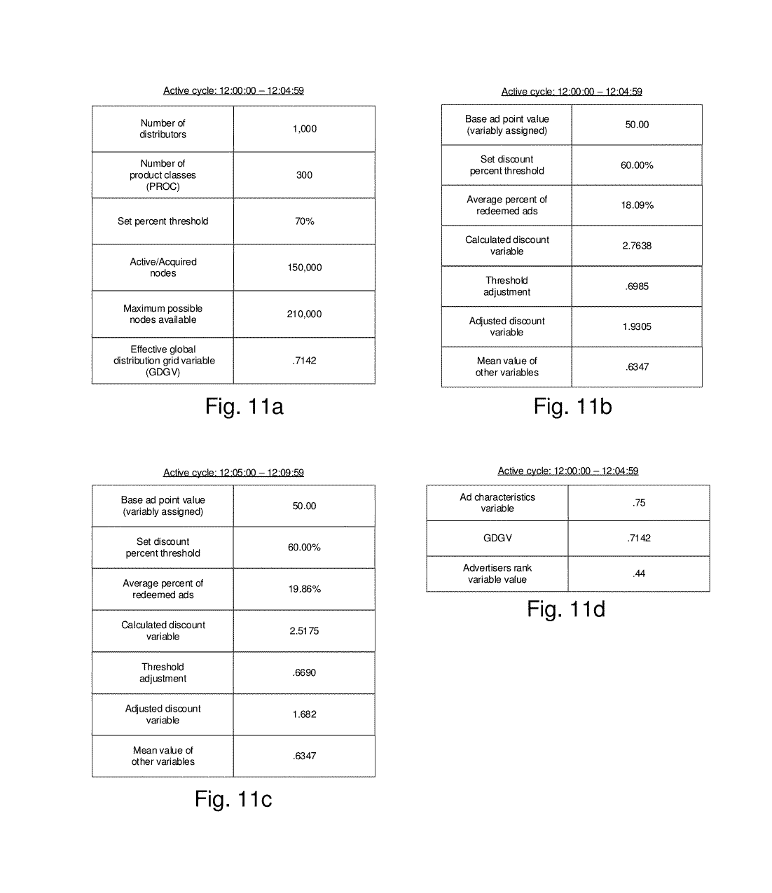

FIG. 11a illustrates an example global distribution grid variable that is active for a cycle term, and example criteria that can be used to obtain the grid variable. FIGS. 11b and 11c are tables with examples of methods that can be used to obtain the discount variable, which can be used to convert an advertisement's assigned discount percent to an ad point value. The ad point values determined in FIGS. 11b and 11c can prevail for one active cycle term. The ad point values can be based, at least in part, on a particular product-family or product-class and its value used in an active cycle term. The example of FIG. 11c uses different criteria than does the example of FIG. 11b. Mean figures of various example variables can be applied to a discount-percentage-to-ad-point convert rate (DCTOAD). The DCTOAD convert algorithm can use environmental factors of one point in time or over a period of time. Computation and updating of the convert rate can also occur in real-time or at various measurement points or defined conditions. The environmental factors can include, but are not limited to, a base ADPT value, a set discount percent threshold, an average redeemed ads discount percentage within a period of time, and a fluctuation percentage of available ads from a period of time.

When that algorithm is computed and updated, a snapshot of environmental variables occurring within that scope of time can be used. The facilitator may configure the scope of time measurement point. When the event executes, the environmental data can be compiled and a preliminary convert rate can be calculated. Next, a mean figure of various variables can be applied to the preliminary convert rate to provide an effective convert rate, which may then be used to convert an ad's discount percentage to an ad point value. FIG. 11d is an example table of three example variable values that can be applied to a discount variable or to an ad's assigned ad point value.

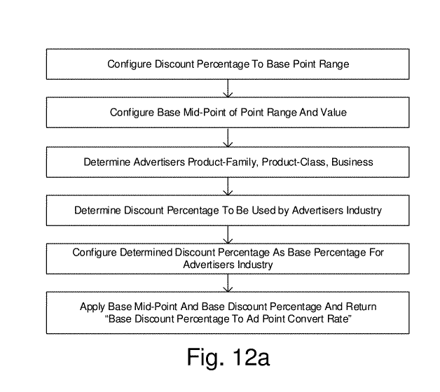

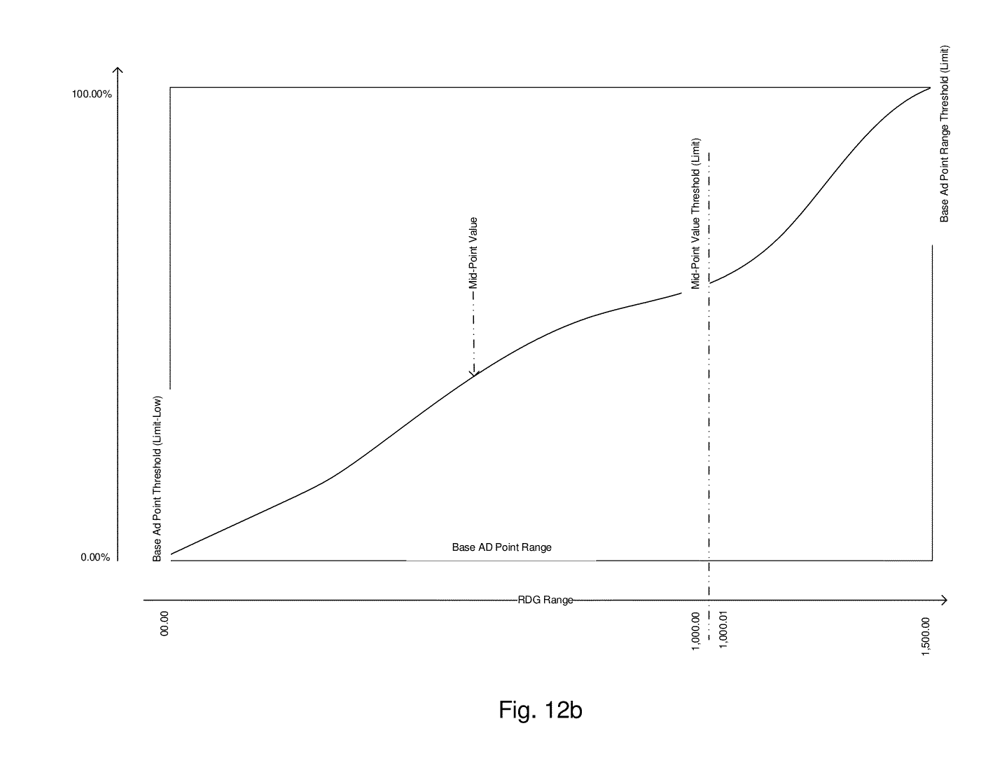

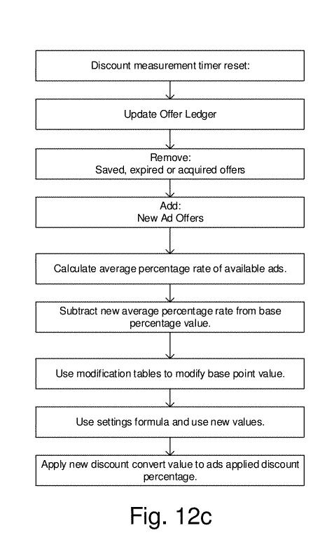

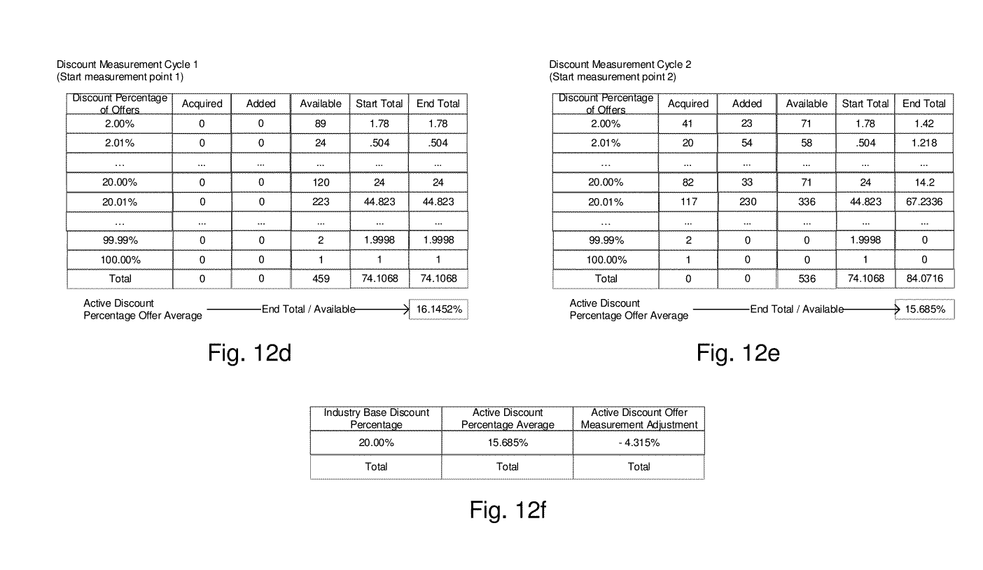

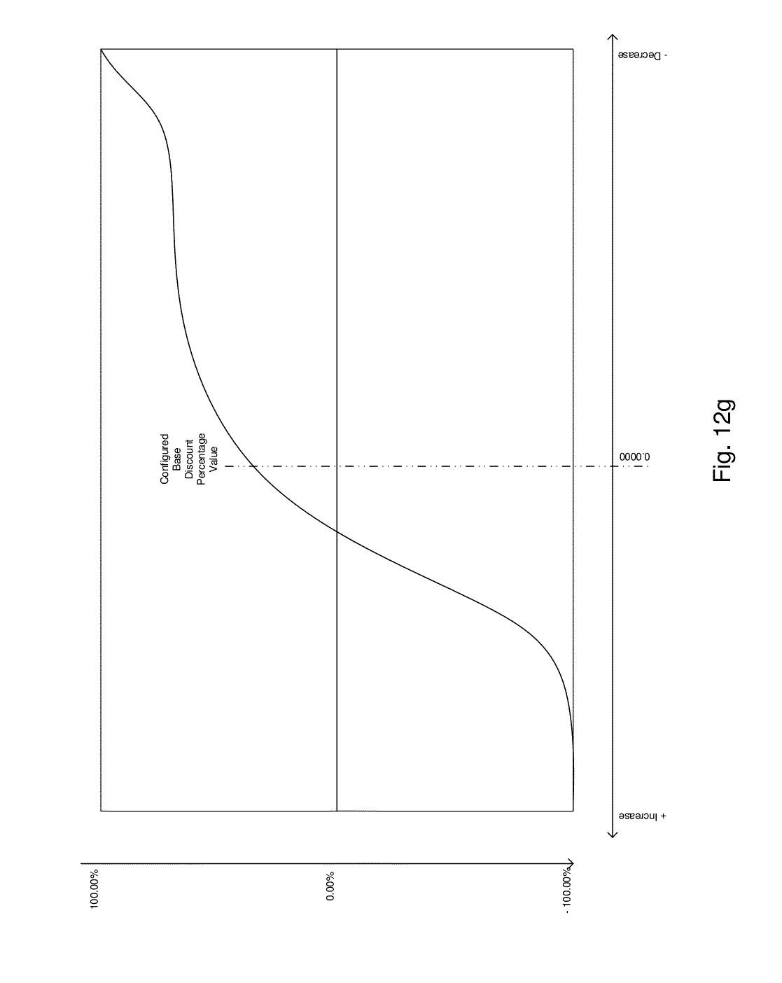

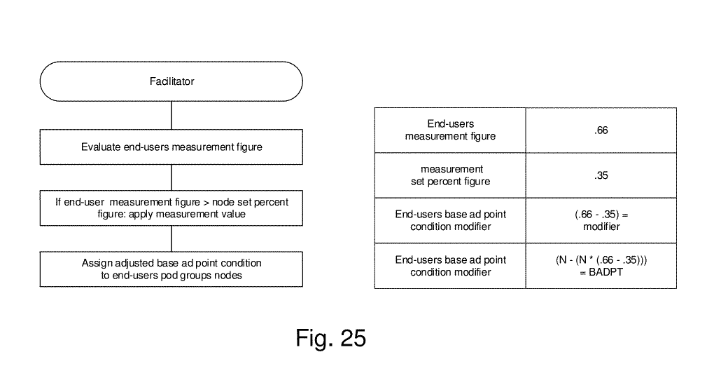

FIG. 12a is a flowchart of example steps that can be used to convert an ad's discount percentage to an ad point value. A ranged global base ad point value, which may be bounded within a range (e.g., 0.00-1,000.00 floating-point range). A point figure can be selected within the range as a mid-point value (e.g., 500 or 50% of bound point range). A discount percent rate based, at least in part, on an industry desired discount percent rate can be used. As an example of the calculation, a bound rate of 500 and an average industry/product discount percent rate of 20% may result in a discount-to-ad-point conversion figure 25.00 ad points for every 1% of applied discount percent value.

FIG. 12b is an example graph of an example base ad point range and example mid-point value. The mid-point value can be configured at any measurement point within the Base Ad Point range (e.g., it may be at a 40% point, 45% point, 50% point, 55% point, 60% point, or other appropriate point within the range). For an example Base Ad Point range of 0.00 to 1,000.00, the mid-point value can be any value within that range. In some examples, earned ad point events can exceed the base ad point range, and can be associated with an available reward distribution grid. In some examples, the Base Ad Point Range can be used to create and associate pod nodes with reward distribution grids.

The system may determine a figure to use as the base discount percentage for each business, product family and/or class using a combination of industry classification systems (e.g. NAICS, UNSPSC) that can use business, product families and classes for identifying an advertiser's mode of business operation. For example, a general retail clothing store may have an industry mean discount percentage figure of 25.00%, whereas designer clothing store may have an industry mean discount percentage figure of 10.00%. As such, in some examples, a lower discount percentage in a first industry can have a similar impact to a high discount percentage in a second industry because of industry segmenting (e.g., each can have ads with a common ad point value (e.g., 124), despite having very different applied discount percentages (25.00% and 10.00% in this example)). A Base Discount percentage to ad point convert rate can be determined based on a Base Discount Percentage associated with an advertiser's industry, product-family or class, and a configured Base Mid-Point value.

FIGS. 12c, 12d, 12e, 12f and 12g illustrate aspects of an example method that can be used to implement an active-discount-percentage-to-ad-point conversion rate adjustment. For example, a base ad point figure can be modified in real-time and can be variable. The system can use an algorithm based on a plurality of base figures, a ledger, and various configuration and measurement tables. An example offer ledger, depicted in FIGS. 12d and 12e, can be used to maintain real-time records of all available ads. In some examples, an amount of available discount percentages of the ads can be used as an influencing modifying factor. When various events occur, such as acquiring or saving an ad, redeeming an ad, or expiration of a discount measurement cycle, the offer ledger can be updated.

As shown in FIG. 12f, a resulting active discount percentage average figure can be debited from a configured industry base discount percentage figure (which can vary by industry and/or advertiser). The system can apply the active discount percentage average figure using multiple configuration and measurement tables, in some examples, and one or more modifying factors can be applied to determine and temporarily set a new base ad point convert figure for new ads. When adjustment and modification factors are determined, the graph of FIG. 12g may represent the modification effects by a positive or negative active discount measurement adjustment, for example. Variation in assigned and displayed ad point values within ads may thus be possible. FIGS. 12c, 12d, 12e, 12f and 12g illustrate aspects of one example, and in other examples a plurality of different measurement parameters and configuration tables can be used to produce variable results.

When ad point value has been calculated for an ad, the system can assign an alphanumeric identifier store in a memory location, such as a memory location within an advertisement engine (ADE). In some examples, the ADE can store, package, associate and distribute advertisements. The alphanumerical identifier can include of alphanumerical characters to identify one or more of the advertiser, a distribution type, the type of the ad, the ad's assigned discount percentage, product-family, product-class, an ad sequence number, distribution and redemption methods, a current state, applied variables, and the ad discount percent convert rate.

A shopper or other end-user can view ads using, for example, an internet-connected computing device with an application capable of communicating with the system. In some examples, ads can be viewed in print media publications. In general, ads can be accessed and viewed using a first-party application (e.g., provided by the facilitator) or a third-party application. In general, the applications may be used to redeem electronic or digital ads, or ads provided in print publications, displays, or other tangible sources.

For ads displayed in print publications, displays, or other tangible sources, a user may scan the ad or a portion of the ad, or may manually input information associated with the ad (e.g., an offer code) into a computing device (e.g., smartphone with application able to communicate with the system). The system can authenticate and/or validate the ad (e.g., by validating the offer code or the scanned information). In some examples, a shopper can receive an ad via a first-party application (FPSA), which can be used to access, store and view available ads, view reward and redemption histories and reward currency similar to a digital wallet, or display acquired ads (e.g., from third party applications). When a shopper acquires offers from a third-party software application (TPSA), the offer may be accessible and available using a FPSA.

The application may use a software development kit (SDK) that can include various application programming interface (API) modules, including layout, design, and programming and code instructions. The application can electronically communicate with the system (e.g., the facilitator's ADE) and can be used to receive and present ads, and in some examples to distribute ads.

To obtain access to the SDK and its components, the TPSA or third-party physical application (TPPA) provider can enroll through a facilitator's or a broker partner self-service application dashboard. The self-service application dashboard can be accessible from any computing device with valid login credentials, for example. The facilitator can request the TPSA and TPPA supply identifying information so that an account can be created and access granted. To create an account, the TPSA and TPPA may be required to input identifying information (e.g., username, address, location, business structure, business size, business type, business operation type, tax-id, phone, email, software application name, application URL, and desired password) into an electronic form presented within a self-service application dashboard. The facilitator can review the data received, create an account, and assign identifying credentials.

When an end-user initializes a TPSA, a script may execute an event and may electronically send data about the event to the facilitator or broker partner servers. An event originating from a broker partner may create an asynchronous session with the TPSA over an electronic communication network, for example.

When the facilitator receives a request event from a shopper or other end-user, the facilitator identifies the shopper or end-user and precompiles ads that may be relevant to the shopper based on, for example, the shopper's location, preferences or past history. The transmitted data event can include information such as device type, device operating software, device model, application type, application name, username, time, date, IP-address, and location.

When a shopper or end user initializes, engages and interacts with a controls of a TPSA containing a script, a request can be invoked. If the control has a script, the shopper's TPSA can transmit a request to the facilitator's ADE for ads. When the shopper makes a request, by executing a script, the system can compile relevant offers to return to the shopper, and transmit (e.g., asynchronously) to the TPSA as a single ad or series of ads over an electronic communications network. In the event the shopper is not recognized, the system may compile offers based off historical data and popularity.

When a request event occurs, the system may execute an offer prevalence algorithm, and may update results with each request or at timed intervals, for example. The algorithm can use data from all available offer activities and reward distribution grid categories that can include, but is not limited to, product-family details, product-class details, offer characteristic details, reward distribution grid availability, shopper or other end-user history, and advertiser performance. The algorithm may consider all active ads within the ADE, and can update the library with new ads, such as those that satisfy scheduled release conditions, for example. The system can release an ad that satisfies release time conditions, and can update the ad's discount-percent-to-ad-point conversion rate or assigned ad points.

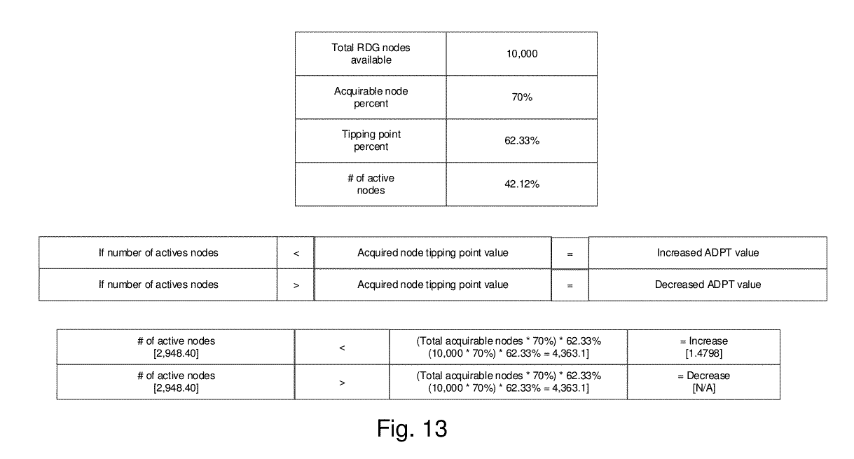

In some examples, an advertisement's ad point value can be dynamically modified by the system while the advertisement is active and available, for example based on a distributor's variable (DISTV). FIG. 13 illustrates tables of example parameters, including a distributor variable that can be used to dynamically affect an advertisement's ad point value. Each distributor may have a distributor variable. In some examples, the system may decrease an ad's ad point value if a number of active nodes exceeds a threshold value (e.g., acquired node tipping point value), and may increase an ad's ad point value if a number of active nodes is less than the threshold value, as will be further described below.

The system can calculate the DISTV based on, for example, a total number of reward distribution nodes of a single distributor or general reward distribution grid, an acquirable node percentage, a tipping point percentage, and a current amount of active/inactive node available from a single distributor or general reward distribution grid. A total number of nodes (e.g., 10,000) can be combined from a distributor or general reward distribution grid, and can then be multiplied by an acquirable node percentage (e.g., 70%), which can be used to set a maximum node acquisition threshold of nodes, (e.g. 7,000) able to connect in payable measured states, for example. Then, in a second calculation, the total number of reward distribution grid nodes can then be multiplied by the acquirable node percentage (e.g., 70%), and then can be multiplied by a tipping point percentage (e.g., 62.33%), for example. The tipping point percent can be a configured value. The resulting value may represent a an acquired node tipping point value (e.g., 4,353.1), which may represent a threshold value. The system can compare the number of active nodes and the acquired node tipping point value. If the number of active (e.g., linked) nodes of a reward distribution grid exceeds the acquired node tipping point value, the system can decrease the current ad point figure of any ads displayed and acquired from that distributor source. Conversely, if the number of active nodes is less than the acquired node tipping point value, the system can increase the current ad point figure for the ads. In some examples, an ad's modified base ad point value can be adjusted based on the distributor variable.

The system can use a prevalence algorithm that uses location. Ads that do not satisfy a location condition can be eliminated or deactivated. Using ad data, the system can grade each ad and assign a prevalence value, which in some examples may be a sum of all graded values divided by a total-possible (e.g., max) value. An ad with a higher prevalence value may be more likely to receive presentation preference versus ads with lower prevalence values, for example. The system can generate a secondary prevalence value that does not consider location when location is considered to be of decreased importance.

A shopper can receive an ad on a computing device from a distributor or the facilitator, for example, where the ad may be transmitted over one or more networks for receipt by the computing device (e.g., a smartphone), and the ad (and in some cases, other data) can be displayed on a display screen of the computing device. Placement, size and methods by which the ads are presented and displayed on a client device can vary by computing device, or by ad. Examples of presentation styles for the ads can include banner ads natively displayed within content or at top, bottom, left or right of a sidebar, interstitial ads, or an expandable offer catalog integrated within an application, to list a few examples.

Data received by a client-side device from the system may include scripts that can be used to track interactions such as clicks, swipes, pauses, inactivity, and scroll speed. In addition, ads may contain additional client-side scripts that can be used to instigate update events such as events to update an offer ledger, displayed ad point values, locational distance, present forms, and can instigate other communication requests.

When an ad script is instigated, it can autonomously occur based on an end-user action. In a web-browser environment, request events from a web-application can execute autonomously while an end-user visits a URL. The request even may continue to execute at timed intervals and may request ad updates from the system (e.g., from the facilitator's ADE). When the system receives such a request, the system identifies the end-user, and considers past history and usage to predict, determine and return relevant ads, in some examples. If the system cannot identify the end-user, ads can be presented according to preferences, activity and history of other end users.

In some examples, an end-user can view an ad catalog on a computing device, and can request ads from the system. When the end-user makes a request from an ad-catalog, the system can compile ads and, in some examples, can maintain an asynchronous session with a web-browser application of the end-user's device. The system can transmit ads relevant to the end-user and the ads can be displayed in a catalog view on the device. In some examples, the offer catalog can expand, render and display the ads received from the system.

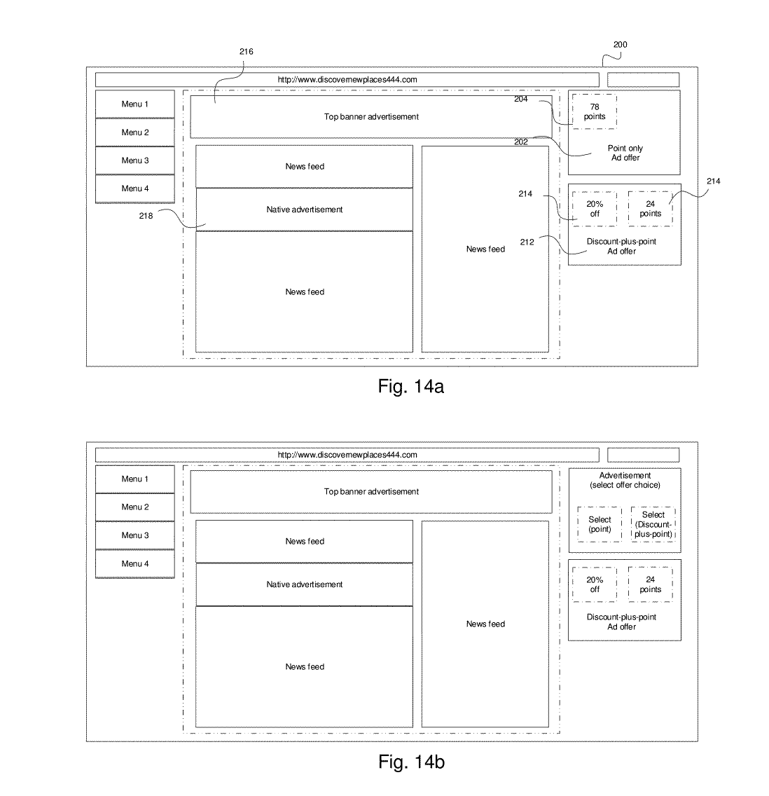

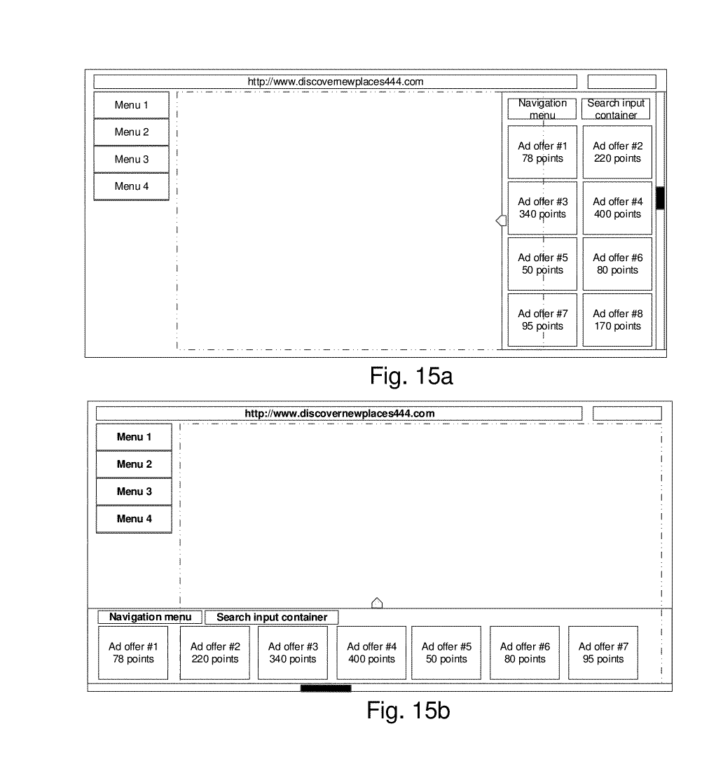

FIGS. 14a, 14b, 15a and 15b are example screen layout views that can be used to present example advertisements. The screen layout views can be presented, for example, on a display screen 200 of a mobile computing device or other computing device, for example as a web-browser. Referring to FIGS. 14a and 14b, each figure includes a web-browser window that displays two offers within the right sidebar. With reference first to FIG. 14a, a first ad 202 is a point-only ad, and is associated with a first amount of ad points 204 (78 ad points in this example). Within the presentation, the first ad 202 may appear in a first container. A second container, below the first container, displays a second ad 212, which is a discount-plus-point ad, that is associated with a discount 214 (30% in this example) and a second amount of ad points 214 (24 ad points in this example). The two ads are presented on the display 200 of FIG. 14a, and a shopper may select from either of the ads 202, 212. A shopper may select an ad in FIG. 14b, and may presented a selection view. The selection view in FIG. 14b may allow the shopper to choose between the point-only ad and the discount-plus-point ad.

With reference again to FIG. 14a, the web-browser window additionally presents a banner ad 216 and a native ad 218, positioned within non-advertisement content (e.g., news feeds in the depicted example). When an ad is selected, a script may execute and transmit a request from the shopper's device to the system. The system may authenticate the shopper and provide additional details of the ad. In some examples, the additional details may be provided in a modal or by enlarging the ad on the screen 200.

When the shopper cannot be identified, an enrollment or log-in form may be presented (e.g., within an ad container or as a modal). The shopper can then provide, for example, their username, password and personal identifier number (PIN), which can be verified by the system. The system (e.g., the ADE) can store and associate the requested ad to the shopper.

In some examples, the shopper can select a redemption method. For a credit card redemption method, the system can verify a valid payment card on file so ads may use card-linking. In the absence of a valid payment card on file, the shopper can provide payment card information. Example methods for card-linking are described in U.S. Patent Application Publication No. 2011/0320550, the contents of which are incorporated by reference. A card-linking provider can provide a token to the system (e.g., the ADE of the system) after receiving the shopper's payment card information, for use by the system in digitally identifying payment events for the shopper. For example, ads requested by the shopper can use the token to card-link ads to that payment card.

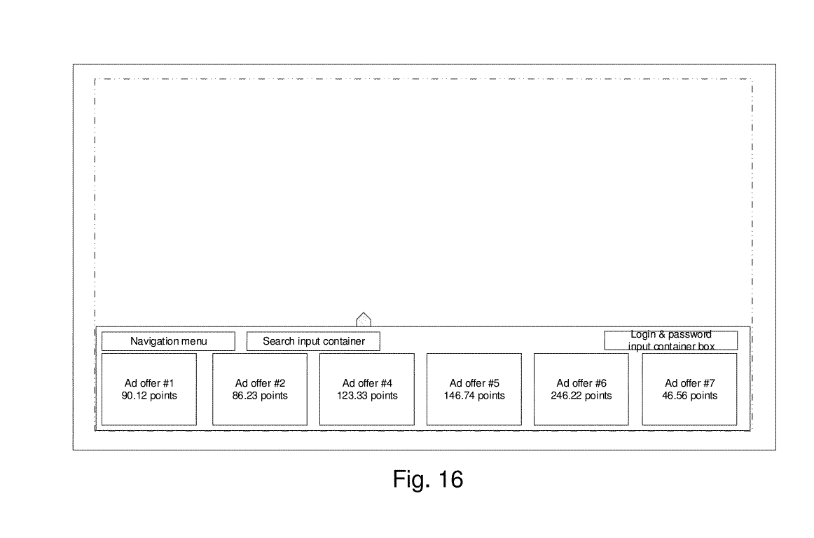

As depicted in FIGS. 15a and 15b, an ad catalog can be presented, where the ad catalog may include an array of ad offers. FIGS. 15a, 15b and FIG. 16 provide examples of an expandable and collapsible ad-catalog menu within a web-browser and interactive media application. When the menu expands, it can contain multiple ads, and the ads may be displayed as an array of ads, for example. Using the ad-catalog menu, a shopper can search and scroll without navigating from currently viewed content. In some examples, the ad-catalog controls depicted in FIGS. 15a, 15b and FIG. 16 can be located in the navigational bar, and a control may be a visible or hidden. Within an ad-catalog container, there may be a navigational menu that permits a shopper to select from a drop-down menu a list of categories. The ad-catalog container may include a search input container for searching on point value, location, offer type, discount amount, name, rating, offer type, and remaining amount, for example. When no defined category is selected from the navigational menu, a search may query the entire ad library. FIG. 16 is a view of example advertisements (that having ad point values expressed as floating point numbers) presented via an ad catalog on an interactive media device, such as a television.

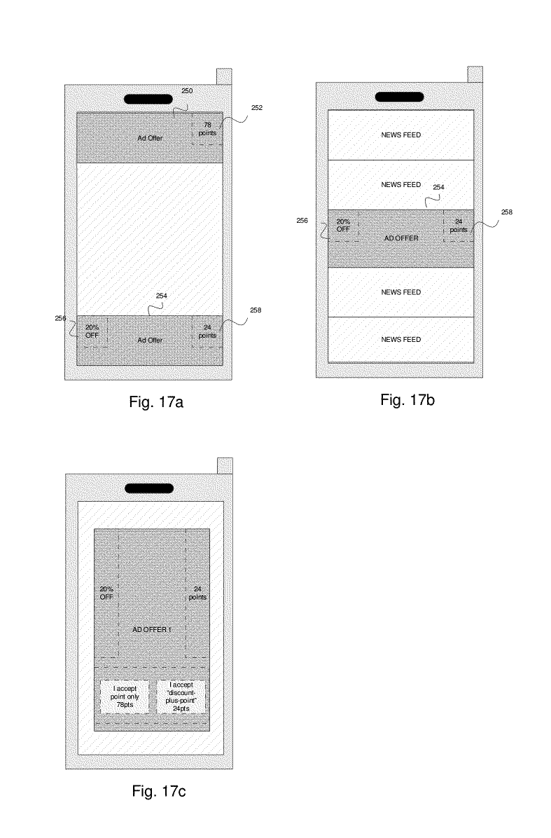

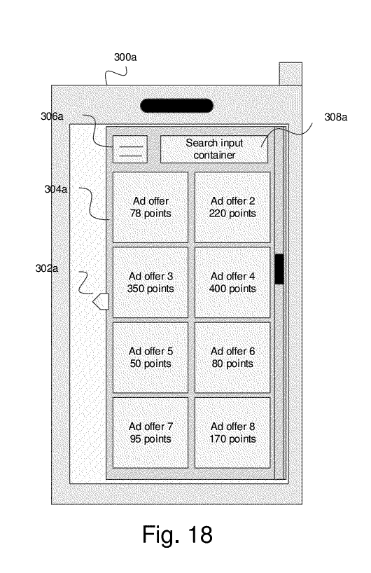

FIGS. 17a, 17b, 17c, and 18 are example screen layout views that can be used to present example advertisements on a mobile computing device. An ad can be displayed and positioned at the bottom and/or top of a display screen (e.g., within or outside of an application window) as shown in FIG. 17a, or can be displayed as a banner ad. FIG. 17a shows a point-only ad 250 near the top of the screen, which is associated with an amount of ad points 252 (78 ad points in this example), and a discount-plus-point ad 254 near the bottom of the screen that is associated with a discount 256 (20% off in this example) and an amount of ad points 258 (24 ad points in this example). FIG. 17b shows the same discount-plus-point ad 254 presented in a different area of the screen, this time natively displayed among non-ad content (e.g., arranged within or between news feeds). FIG. 17c illustrates an ad provided as an interstitial offer overlaying the graphical interface of an application. FIG. 17c also provides an ad selection box that may be directly presented to the shopper or may be available as a selectable option in a modal, as shown in FIG. 17c.

Ads within mobile applications can be presented in an ad-catalog, for example as shown in FIG. 18. The ad-catalog can contain and display multiple ads without exiting the application. To access and expand the ad-catalog, the shopper can instigate a control event that might involve a click, swipe or touch, and interaction with the catalog can cause executable events such as requests for forms, data or details from the system (e.g., the ADE of the system).

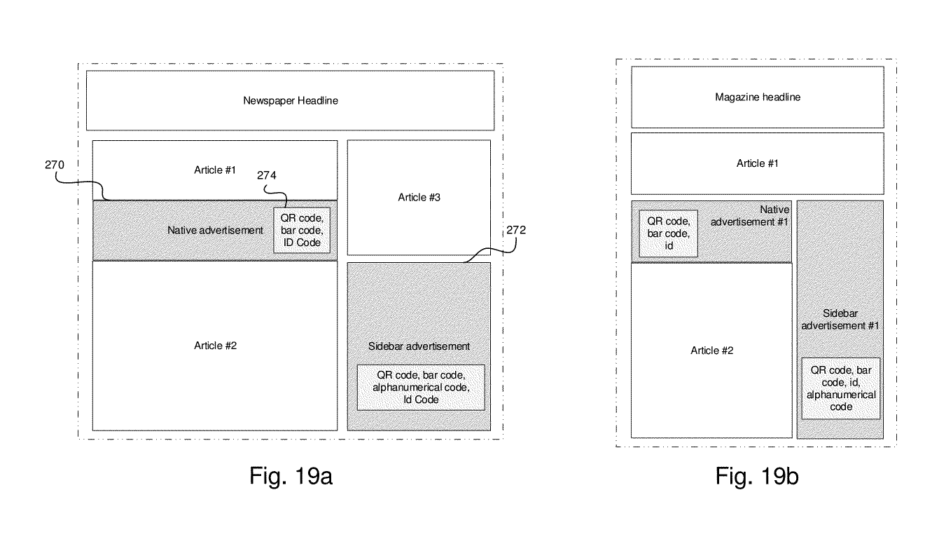

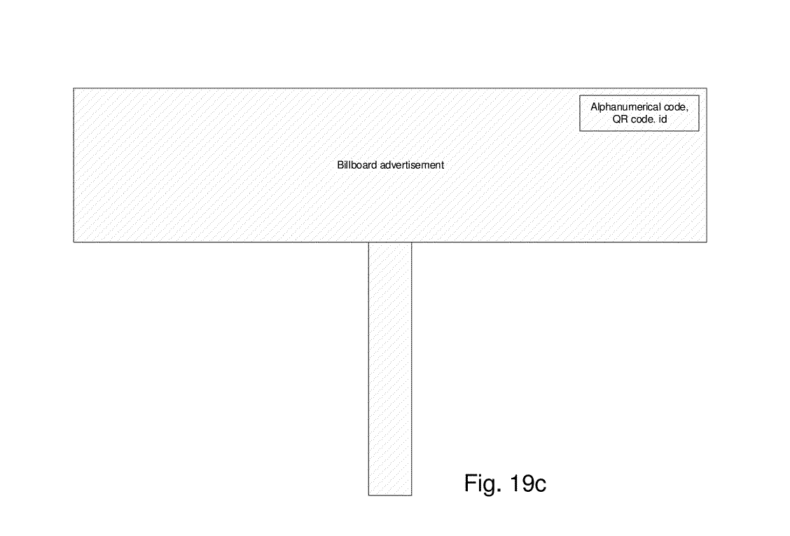

FIGS. 19a, 19b, and 19c illustrate example ads provided in print publications, such as a newspaper (FIG. 19a), a magazine (FIG. 19b) and a billboard (FIG. 19c). In general, the location of ads depicted is exemplary, and any appropriate placement of the ads can be used. The newspaper example of FIG. 19a shows a native ad 270 and a sidebar ad 272, each of which may include an identifier 274, such as one or more of a QR code, bar code, alphanumeric code, other identifier, or conductive film. The identifier 274 can be used by the system to identify the ad and the corresponding advertiser, for example. A shopper may use a computing device to interface with advertisements in print publications, for example, and the computing device may communicate with the system. The identifier 274 may be scanned or otherwise input to the computing device (e.g., using a FPSA or TPSA, or other), and can be transmitted to the system, which can authenticate the identifier (e.g., using the ADE).

The system can return ad details (e.g., an ad point value) and available redemption methods. In some examples, when the shopper selects an ad type and redemption method, the system associates the ad with the shopper and stores an indication of the association in an account of the shopper. In some examples, the shopper can redeem the ad immediately, or can redeem it later using the computing device (e.g., using a FPSA or TPSA).

In general, ad quantities and conditions can vary in real-time, and values for the conditions can be based on location, time, day, and offer duration, among others. The variability may permit the advertiser to select release schedules and modify availability on the fly, for ads provided digitally on electronic devices and even for ads appearing in print publications (e.g., newspapers, magazines, journals, billboards, books, and the like) that have previously been printed and released. In this manner, ads appearing in older print publications may still be redeemable, for example.

An advertiser can schedule to trickle-release an ad over a specified time period (e.g., over the course of an hour, several hours, one day, multiple days), and can schedule the release in limited or variable amounts. In some examples, ad descriptions displayed in print applications can be minimal, as the system can provide ad details that can be provided on a user's computing device after identifying the ad. Such details can include, but are not limited to, a quantity available, one or more times or time periods available, time and duration an ad is valid or activated, one or more ad point figures or values, one or more discount figures or percentages, and the like. In general, an advertiser may make modifications after the offer is printed and released via a self-service dashboard, for example.

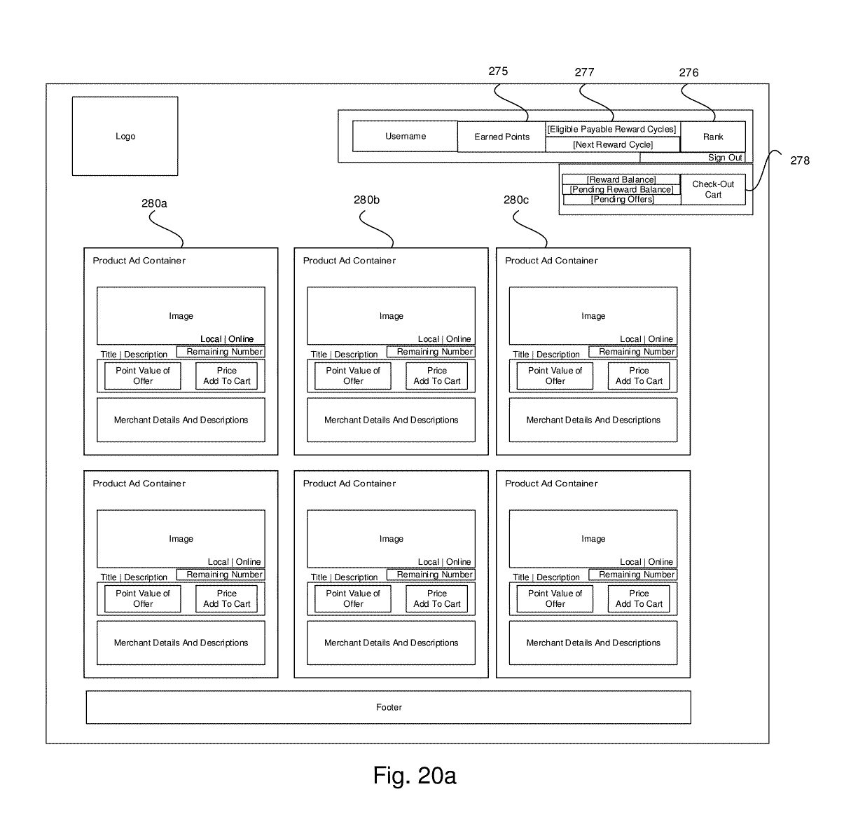

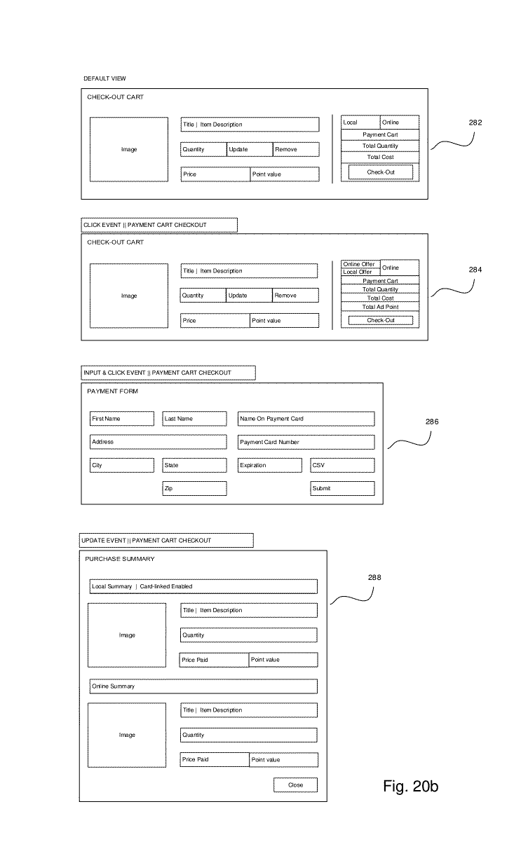

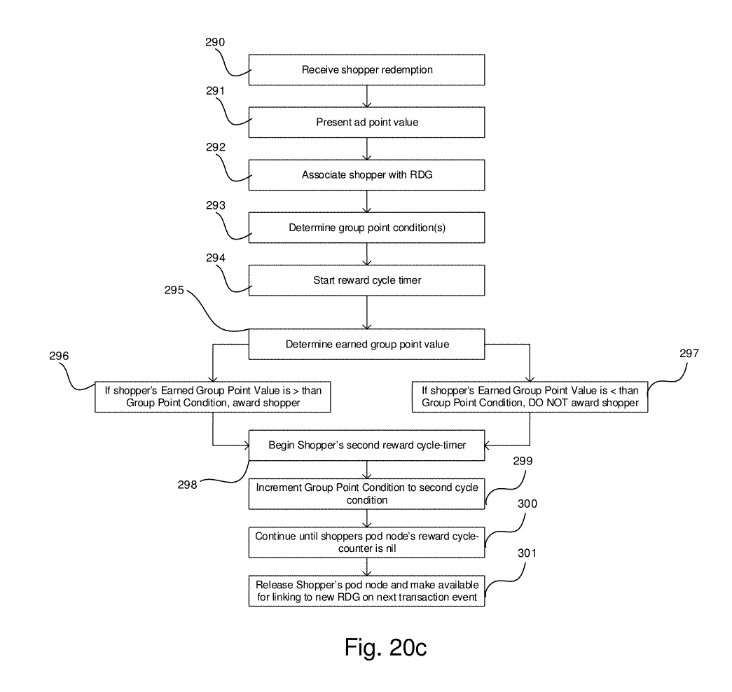

FIG. 20a is a conceptual diagram of an example web-application interface for an example online store. A shopper may use the interface to, for example, view information such as earned ad points 275, rank 276, award cycle information 277, and pending information 278 related to a check-out cart, for example. The shopper may also use the interface to select products available for purchase, in some examples, and may select the product for adding to the check-out cart. In some examples, ad point offers may be displayed with the product displays of the e-commerce store, for example. The interface shows a plurality of ad containers 280a, 280b, 280c, where advertisements can be presented.

FIG. 20b is a series of conceptual diagrams 282, 284, 286, 288 of example check-out cart interfaces. Using the interfaces, a shopper can add an advertisement (e.g., product, merchandise, etc.) to the cart, remove an advertisement from the cart, increase or decrease a quantity of ads in the cart, save an ad (e.g., for later redemption or review), or redeem an ad, in some examples. Some ads may be local ads, and some ads may be non-local or online ads. In some examples, a shopper may be given an option to select between a local or a non-local (e.g., online) ad. In some examples, checkout involving a local ad may result in a zero cost or expenditure at checkout, and the shopper may provide payment card information when the product or service is purchased. At time of purchase, the system may provide information including an amount of awarded ad points, total cost, and other in some cases additional details of the transaction.

In some examples, ad points for advertisements can be pre-awarded to shoppers, such that the shopper may begin earning awards before even redeeming the ad. In some examples, the award may not be granted until certain conditions have been satisfied (e.g., redeeming the ad, or following expiration of a holding period). A first interface 282 and a second interface 284 show advertisements and ad parameters. A third interface 286 shows a form where payment information can be provided. A fourth interface 288 shows purchase information.

FIG. 20c is a flowchart of example steps that can be used to provide a collaborative reward system. A shopper may redeem an ad, for example from an online store, and the system may receive an indication of the redemption (290). The system may determine an ad point value, and may present the ad point value to the shopper (291). In other examples, the system may present the ad point value prior to step 290, or may update the ad point value while ad offer is in the check-out cart. In some examples, the shopper may immediately benefit from the transaction, and may be awarded pod node links and rewards, as will be further detailed. The system may associate the shopper with a reward distribution grid (292), and determine group point conditions (293). The system may start an award cycle timer (294). On expiration of the reward cycle timer, the system may determine an earned group point value for the shopper (295). If the earned group point value exceeds a group point condition, the system may award the shopper (296), and may not award the shopper if the earned group point value fails to exceed the group point condition (297). The system may start a second reward cycle timer for the shopper (298), and may increment a group point condition to a second cycle condition (299). The process may repeat and continue until the shopper's pod node reward cycle counter is zero (300). The system may release or disassociate the shopper's pod node from the reward distribution grid so that the pod node may thereafter be available for linking to another reward distribution grid, for example on a next transaction event (301).

In various examples, the reward distribution grids, pod nodes, and purchase conditions can differ from ad offers that are later redeemed. For example, a shopper may return a purchased item, and in such cases the system may restrict or limit immediate reward availability, or may debit the earned award amount from the shopper's account when the return occurs.

In general, the conceptual views of interfaces presented herein are provided as examples, and other layouts, arrangements, views, or features (e.g., proximity technologies such as ibeacons or Bluetooth can be used to push ads or offers to computing devices) can be used. In general, a variety of computing devices can be used to provide the interfaces discussed herein and to interface with the system, including mobile computing devices (e.g., smartphones, cell phones, tablet computing devices, wearable computing devices (e.g., smart-watch or smart-bracelet)), laptop computing devices, personal digital assistants, e-reader devices, smart-appliances, in-vehicle displays, and others.

In some examples, when the shopper accepts an ad, the system (e.g., ADE of the system) can associate the ad with a shopper account, and can temporarily associate the ad additionally with the corresponding advertiser and distributor. The associations can include associating offer and measurement parameters (e.g., point or rank) and redeemed offer time. In some examples, the associations can temporarily link a pod node to a reward distribution group node (and can cause the RDG node to inherit parameters from the pod node based on the transaction), for example for a duration of a cycle counter for the pod node.

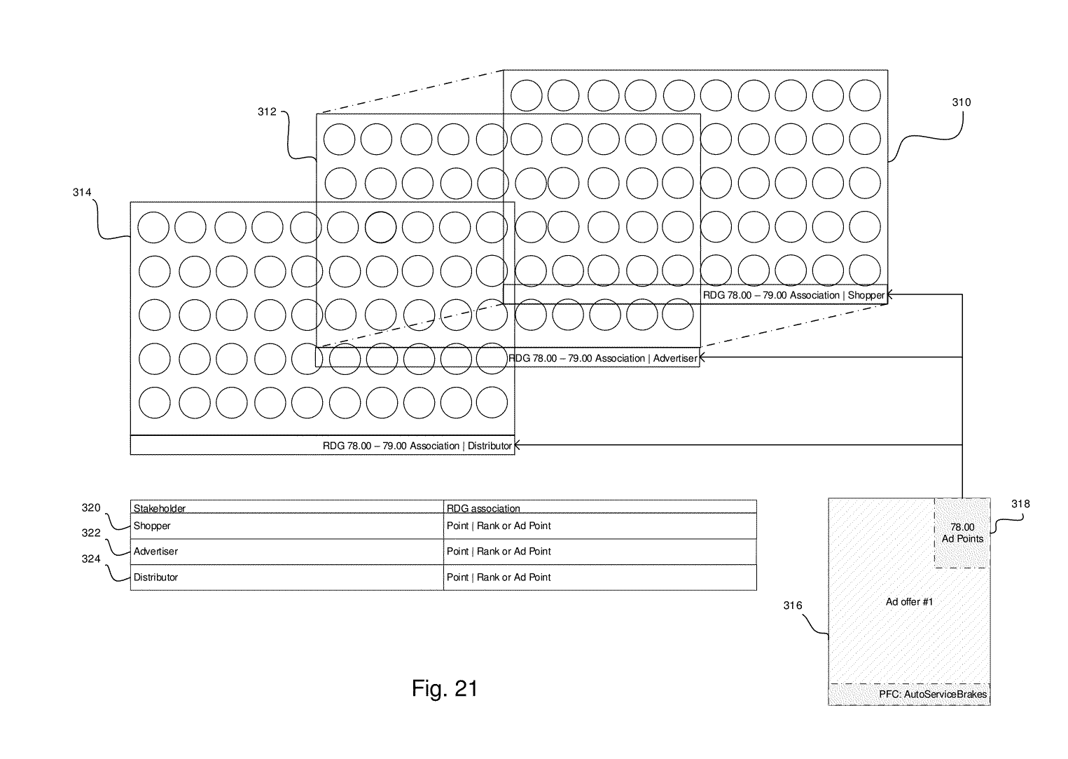

FIG. 21 is a conceptual diagram of example reward distribution grids and representations of associations of end users to the reward distribution grids. A reward distribution grid (RDG) can be associated with an advertisement, and the association can be based on a point value of the advertisement, or on a rank of the corresponding advertiser, in some examples. Each RDG may include a plurality of RDG nodes, where each RDG node may have a reward amount associated it. Conceptually, each RDG node may “store” an award value, for example. When the system directs an award amount to an RDG, the system may associate the award amount, or a portion of the award amount, with one or more nodes of the RDG.

An RDG may be created to correspond to a range of measurement parameters. For example, a given RDG may correspond to a point range or rank range of 78.00 to 79.00. When the system links pod nodes of end users (e.g., advertisers, shoppers, distributors) to an RDG node, each RDG node can be allocated a percentage of available-to-be-awarded currency (e.g., collected discount offer money). In some examples, RDGs can be segmented by class, such as shopper class, advertiser class, or distributor class, such that shopper's participate via shopper-class RDGs 310; advertiser's participate via advertiser-class RDGs 312; and distributor's participate via distributor-class RDGs 314. Each RDG can be configured to receive a percentage of the collected discount offer money from transactions. For example, for an advertisement 316 that is associated with an amount of ad points 318 (78.00 ad points in this example), a shopper RDG 310, advertiser RDG 312, and distributor RDG 314 may allocated currency based on a transaction between a shopper 320 using the ad 316, which may be associated with a particular advertiser 322 and distributor 324.

FIG. 22 is a conceptual diagram of example reward distribution grids and of example allocations to the reward distribution grids. In some examples, the system can assign a base allocation percentage to each RDG class. The example of FIG. 22 shows allocation percentages of 45% to the shopper class, 40% to the advertiser class, and 15% to the distributor class. The base allocation percentage can be used to determine an appropriate allocation amount for collected currency on a class basis. The system can determine an appropriate RDG within a class based on, for example the corresponding ad's point value, or on a measurement figure (e.g., rank) of the corresponding shopper, advertiser, or distributor associated with the transaction. The system can then determine, for each class and for each RDG associated with each class, specific RDG nodes to which the collected currency will be allocated. Currency allocated to RDG nodes becomes stored monetary value that can be awarded to shoppers, advertisers, or distributors whose pod nodes are linked to RDG nodes that store monetary value.

The example of FIG. 22 assumes 400 shopper-class RDG nodes, 400 advertiser-class RDG nodes, and 10,000 distributor-class RDG nodes. The system can determine example node allocation percentages (e.g., 0.001125% for shopper class, 0.001000% for advertiser class, and 0.000015% for distributor class), and for an example monetary amount of $10,000 collected during a period of time, resulting monetary values of $11.25 ($10,000*0.001125) that can be directed to each of the 400 shopper-class reward distribution nodes, $10.00 ($10,000*0.001000%) that can be directed to each of the 400 advertiser-class reward distribution nodes, and $0.15 ($10,000*0.000015%) that can be directed to each of the 10,000 distributor-class reward distribution nodes.

In general, an amount of ad points associated with the ad at the time the ad was acquired or purchased can be used to determine an amount of currency to be directed to RDGs. In some examples, a distributor variable (DISTV) can be applied in real-time to an active ad to dynamically modify the ad point value of the ad, such that variability among distributors may result. The DISTV can be variable and can change based on links and availability in various states. End users seeking a largest number of ad points may seek out distributors with higher distributor variables, for example, while end users seeking a largest amount of monetary value may seek out distributors with lower distributor variables (e.g., and higher volume), for example.

Earned ad points may be active for a duration of a pods node's cycle count (e.g., for a timer duration for a timer associated with the pod node). Upon expiration of the shopper's, advertiser's, or distributor's pod node timers, the ad points can be debited from accumulated ad point figures, which can affect reward earning capacity of other pod nodes. In general, a shopper's, advertiser's, and distributor's pod node timers can differ, and can expire at different times. As such, ad points can be awarded to each end user at different times based on their pod node timers. When another offer redemption or purchase event occurs, ad points can again be awarded, for example.

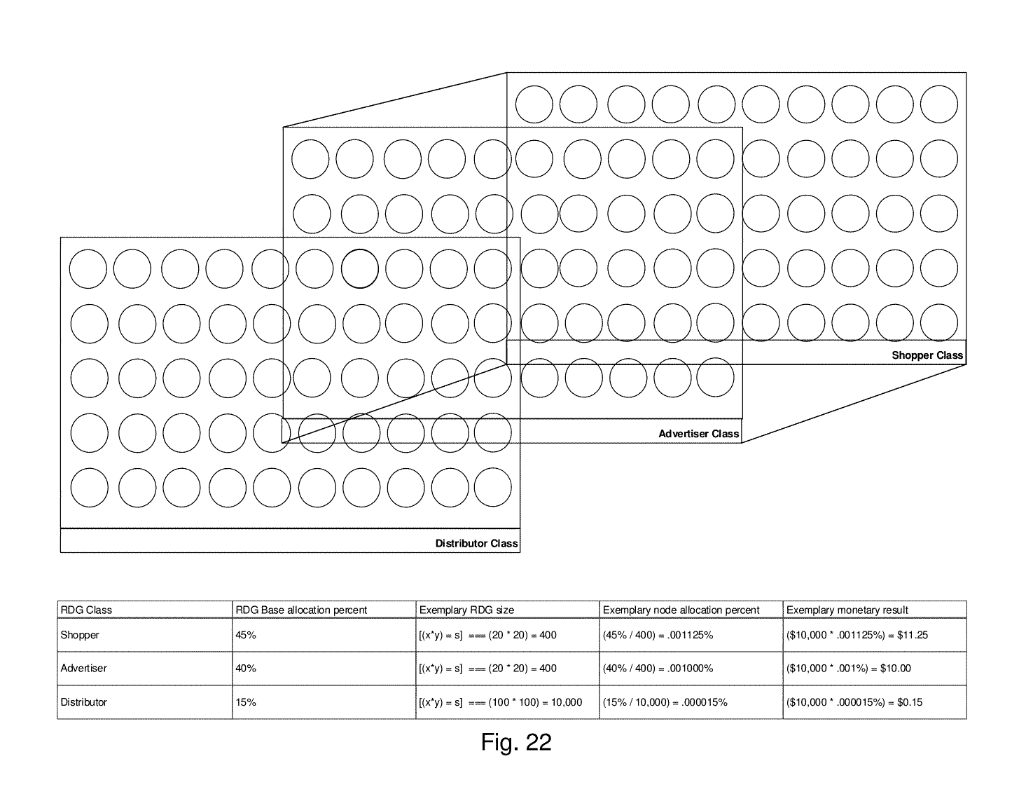

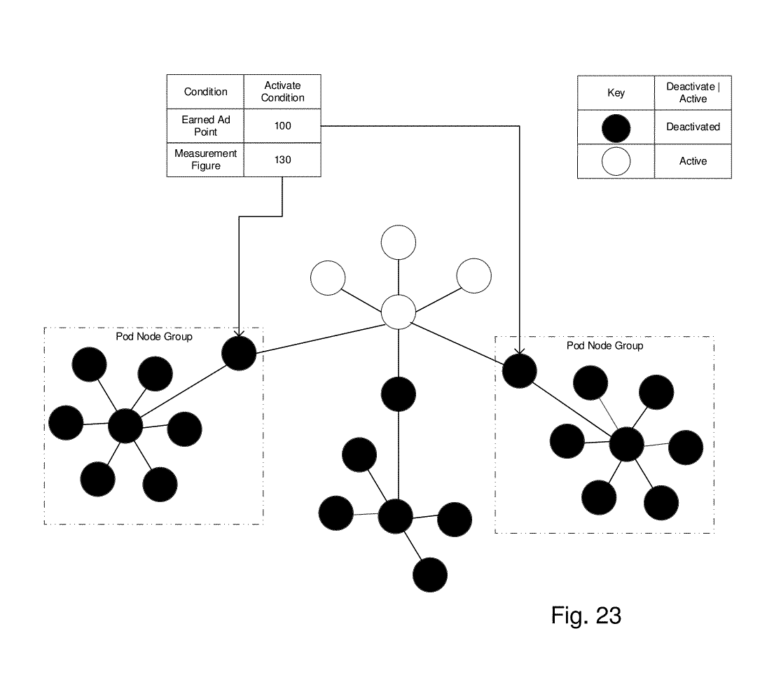

An end user can accumulate earned ad points, and awards can occur at various measurement milestones, in conjunction with activation of pod nodes (e.g., linking pod nodes to RDG nodes). FIG. 23 is a conceptual diagram of example pod node groups, example representations of the nodes' state of activity, and example activation conditions. As depicted in FIG. 23, two additional pod node groups can become available when a shopper accumulates ad points sufficient to satisfy a condition (e.g., earned ad points in excess of 100 in this example). In another pod node group, attaining a measurement figure of 130 can activate that group of pod nodes.

Pod nodes can be available to shoppers, advertisers and distributors, but in some cases activation conditions may vary by class. For example, a shopper may be required to actively satisfy one or more conditions for node activation, while advertisers or distributors may be granted node activation based on a shopper action involving an ad the advertiser or distributor is associated with, for example. Measurement conditions for pod nodes or groups can be based on ad points, rank points, measurement grade, activities or actions. The system can activate or deactivate pod nodes based on satisfying or failing, respectively, the conditions. As such, pod node activation may be elastic or variable over time.

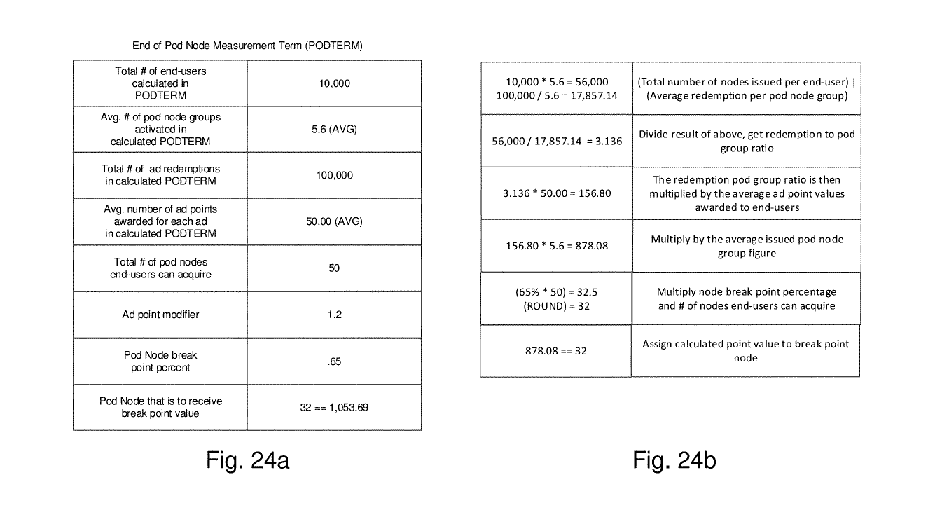

Pod nodes can have base ad point conditions that can be configured statically (e.g., by the facilitator) or variably or elastically with an algorithm that calculates ad point condition figures for temporary assignment to each pod node. FIGS. 24a and 24b illustrate an example method that can be used to calculate base ad point conditions for pod nodes. Factors that can influence the calculation can include a number active end-users, a number of pod nodes, a number of redeemed offer occurring during a calculated time, a number of ad points awarded, and a break point percentage figure, as shown in FIG. 24a. FIG. 24b shows example calculations that can be used to determine ad point condition figures that can be assigned to pod nodes.

A mean base ad point condition can then be applied to a break point pod node, and remaining base ad point conditional figures can be assigned. In some examples, various percentages may be applied, which may increase or decrease a pod node's figure. The calculated pod node figures can become the active figure for the duration of the current pod-node-measurement term, and the figure can be recalculated when the term expires.

FIG. 25 is a flowchart of example steps that can be used to adjust an end-users base point ad conditions, and a table of example parameters and example calculations. In general, after base ad point conditions have been assigned to pod nodes, various measurement variables (e.g., rank) can be used to adjust (e.g., individually for each of shoppers, advertisers and distributors) the base figure. In some examples, when an end user's measurement variable figure exceeds a measurement set percent value threshold condition, the current base ad point conditions of their pod nodes can be modified, where the modified ad point condition can supersede the base ad point condition. For example, for an end user with a measurement figure of 0.66 and where a measurement set percent threshold conditional figure of 0.35 applies, a modification that results in a 31% decrease from current base ad point conditional figures for each pod node may apply.

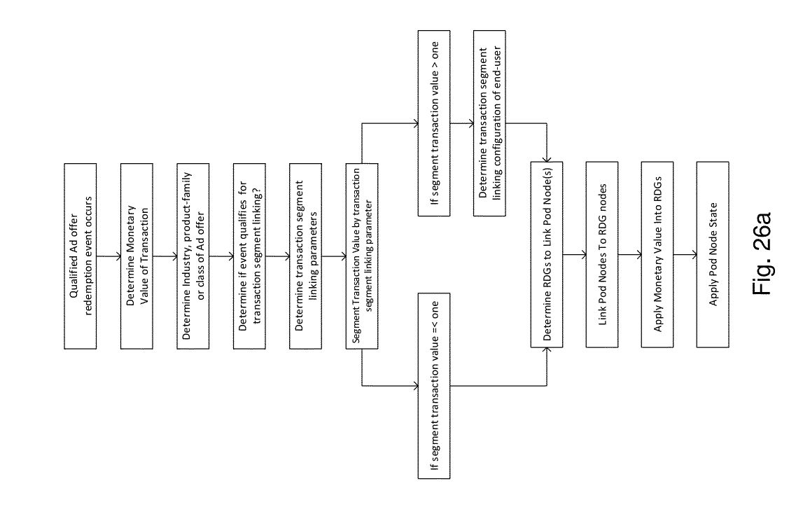

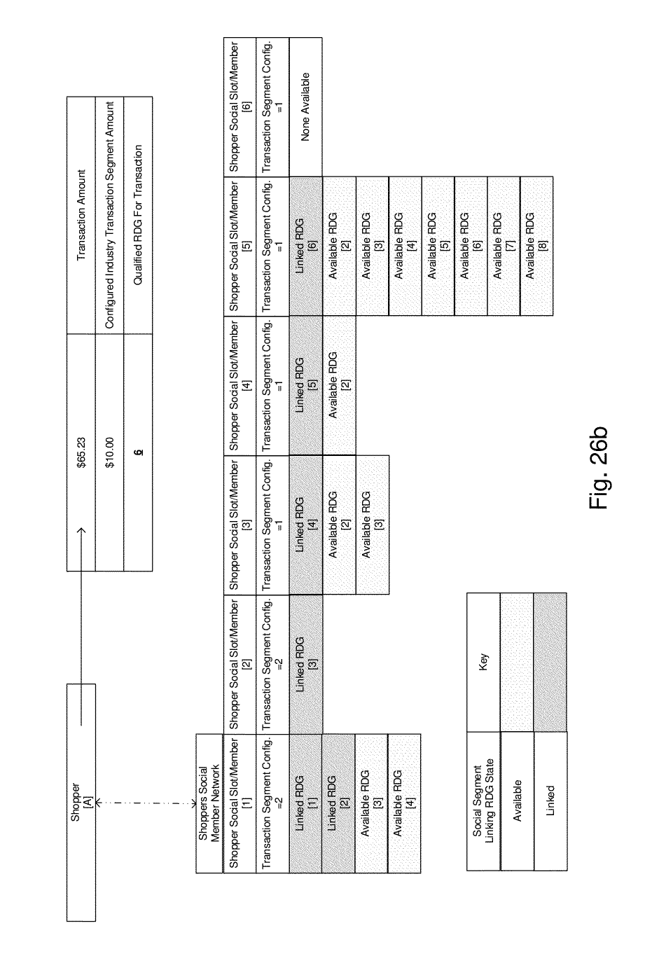

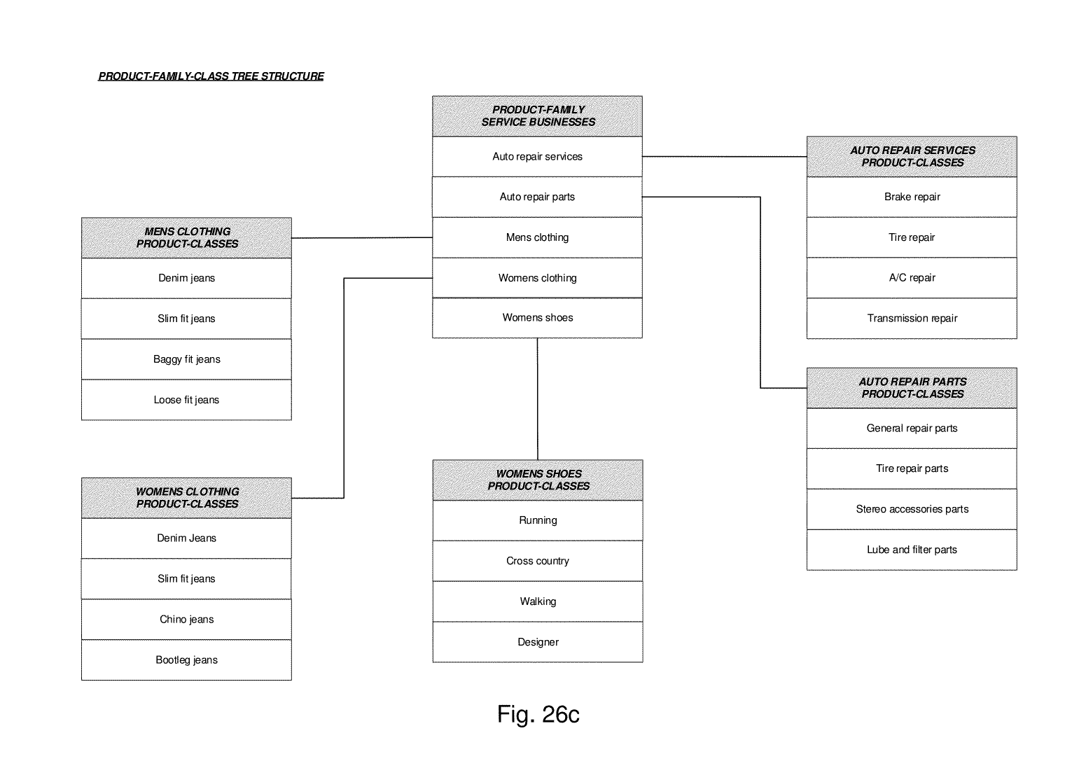

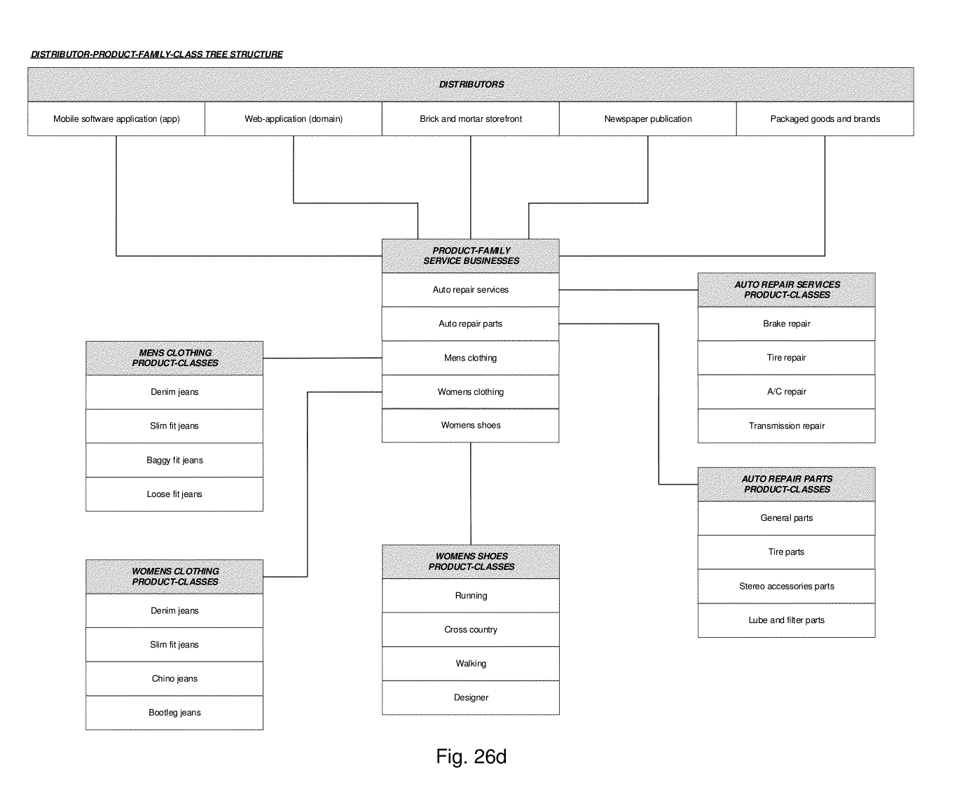

Awarded pod nodes can be linked to a reward distribution node, and the pod nodes can have a payable measured state (e.g., eligible for monetary awards) or a measured state (e.g., eligible for rank rewards, but not eligible for monetary rewards). When a shopper redeems an offer or makes a purchase, the shopper's pod nodes link to RDG nodes in one of the two states. For pod nodes to have a payable measured state, they must have satisfied conditions to be activated, as discussed herein above; if they do not satisfy the conditions for activation, they will be linked to RDG nodes in a measured state. In some examples, pod nodes for advertisers and distributors may have a payable measured state at all times. FIG. 26a is a flowchart of example steps that can be used to link pod nodes to reward distribution grid nodes. In some examples, pod nodes can be linked to reward distribution grid nodes following a transaction. When pod nodes are active and available, for example, a subsequent ad redemption event can cause the next available pod nodes to link to RDG nodes.

In some examples, a single ad redemption event can cause multiple pod nodes to link to multiple RDG nodes for a given end user. For example, social associations can be used in addition to transactional figures (e.g., for transactional figures configured to link multiple pod nodes to RDG nodes for a given expenditure amount (e.g., $10.00), social associations can determine which RDGs the shopper, advertiser or distributor are associated with). FIG. 26b is a conceptual diagram that illustrates an example transaction and an example of how social associations can be used in linking a shopper's pod nodes to reward distribution grids. The shopper's social associations can include shoppers in their social network. In some examples, the shopper may manually select associations. In some examples, the system may autonomously select associations based on, for example, using a referral link sent to others through social media networks, (e.g., FaceBook, Twitter, Pinterest, Linkedin, etc.) or by mobile, video, picture, liking, sharing actions, or email messaging. In some examples, associations may be added based on a facilitator-created social network. While the foregoing provides some examples, there are many additional ways to invite someone to a network, and the system may use any such interactions in determining associations, for example.

When a friend, invite or associate is added to a shopper's network, for example, the system can configure a sequence by which linking order can be added. With reference to FIG. 26b, a shopper may want to add an associate or friend who tends to shop a lot in their #1 position and configure transaction segment links to predominately associate with RDGs that the active-shopper-friend is linked to. Similarly, friends who are less-active shoppers may occupy a lower priority position in the list. In some examples, listing the less-active shopper in the #1 priority position may increase the shopper's measurement parameter or some future social gain, in some examples.

In some examples, a shopper may be able to link to multiple RDG nodes based on measurement parameters (e.g., rank values) of the advertiser and/or distributor associated with a transaction. In some examples, the shopper may have a first pod node that links to a shopper RDG, a second pod node that links to an advertiser RDG based on a rank value of the advertiser at a time of the transaction, and a third pod node that links to a distributor RDG based on a rank value of the distributor at a time of the transaction.

As described above, in some examples a shopper can benefit from multiple RDGs per transaction. In some examples, a purchase amount (e.g., larger purchase amounts, such as purchase amounts above $50 or $100) can be segmented into smaller amounts that can be treated as multiple single line-item transactions. This may reduce or eliminate a need for line-item transaction tracking for the facilitator, and can provide shoppers with greater incentive to participate in larger transactions, as they may benefit from multiple pod-node-to-RDG-node links for a single transaction based on a size of the transaction. The number of such links for a transaction can vary and can be based on, in addition to the monetary value of the transaction, for example, industry segment, product family, product class, average industry expenditures, and discount percentage.

By permitting a shopper additional RDG award opportunities, in any of the various ways described herein, the system may provide the shopper with a more engaging shopping experience, in some examples. Additionally, because advertisers and distributors may similarly benefit (e.g., advertisers and distributors may similarly receive multiple pod-node-to-RDG-node links), the advertisers and distributors may similarly enjoy participation in the system. Also, minimizing or eliminating tracking of individual line-item transactions may alleviate overhead expense, in some examples.

In some examples, collected revenue can be distributed either into a first RDG associated with the transactions, or can be segmented equally over the multiple nodes connecting to from that event. The example of FIG. 26b shows collected revenue being segmented equally over multiple RDGs. A shopper transaction for $65.23 results in $13.09 collected as a discount revenue fee. With a configuration setting of one pod node for every $10.00 expended in a transaction, six shopper pod nodes (because $65.23 can be divided by $10.00 six whole times, with a remainder of $5.23) may be linked to six different RDG nodes. Because the collected fee amount of $13.09 (e.g., the amount directable into RDGs in this example), divided by 6 equals $2.18, each of the six RDGs may receive $2.18.

An ad redemption event can occur when a shopper buys a product from an advertiser using an ad. The system can award ad points to the shopper, and can check individual and collaborative ADPT conditional values of the shopper's pod nodes or pod node groups. For any pod nodes or pod node groups that satisfy activation conditions, the system can activate those pod nodes and make them available for linking to a nodes of an RDG. Appropriate RDGs may be determined as discussed elsewhere herein, for example RDGs relevant to the redeemed ad's associated parameters, RDGs based on social associations, and others.

FIGS. 26c and 26d are conceptual representations of an example product-family-class tree structure and an example distributor-product-family-class tree structure, respectively. The system can use product-families and product-classes for measurements and associations that can affect configured parameter figures (e.g. discount percent to convert rate figures). A product-family can be used to identify a group of product-classes (e.g., auto repair services, auto repair parts, men's clothing, women's clothing and women's shoes). A product-class can be used to identify specific products within the product-family (e.g., auto repair service brakes, auto repair general repair parts, men's clothing jeans denim, women's clothing jeans denim, women's shoes running, etc.)

In various examples, a distributor provide the ad via online, print publication, or physical location distribution methods, which can include, a web-domain, an in-store or virtual storefront, an interactive media brand, a manufacturer brand, a print publication brand or entity and/or mobile application.

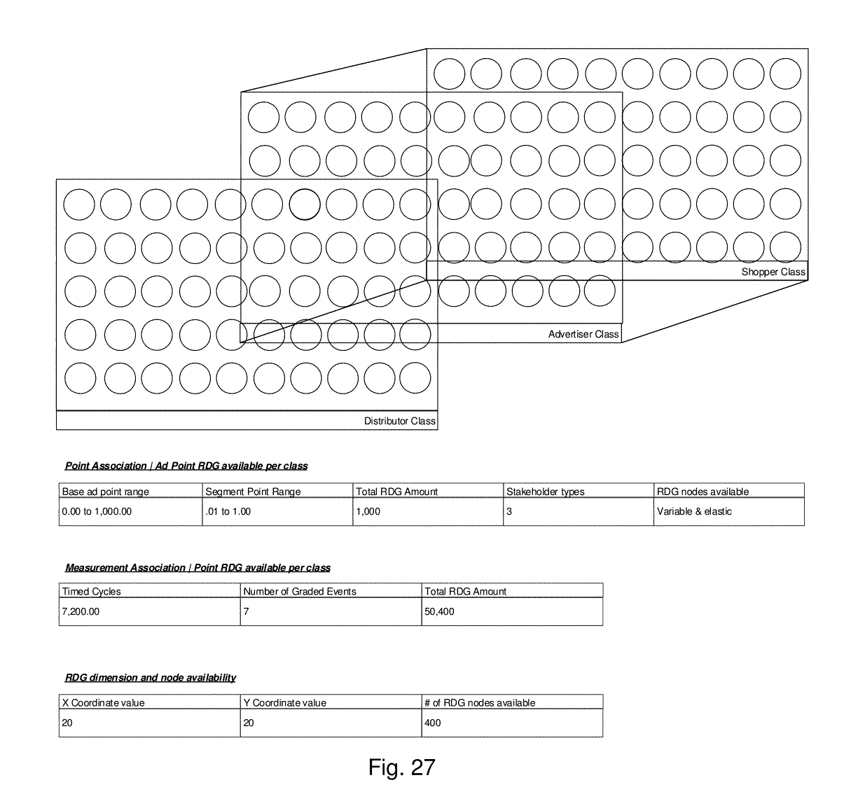

Referring to FIG. 27, the system can determine which RDGs of each class should be made available. Availability may be based on an ad or offer, (e.g., based on ad points, represented by top table of FIG. 27), or on a measurement parameter, (represented by middle table of FIG. 27). When RDG's of each class are created or made available, ranged values can define one or more RDG's for the selected parameter.

When ad points are used as the representative parameter, the determination may use a base ad point range of the discount-percent-to-ad-point convert configuration (top box, column one) and a defined segment point range (top box, column two). For example, a base ad point range of 0.00 to 1,000.00 can be used. For a configured segment point value of 0.01, the system may create 100,000 RDG's created, for example. The FIG. 27 example shows (top table, column 2) a segment range of 0.01 to 1.00, which can result in 1,000 RDGs (top table, column 3) per class. The example of FIG. 27 includes 3 classes, for a total RDG count of 3,000 (e.g., 1,000 for shopper class, 1,000 for advertiser class, 1,000 for distributor class). A number of available RDG nodes can be variable and elastic, for example based on a number of pod nodes available for linking (or becoming unavailable and unlinking).

The system can also use measurement values (e.g., middle table of FIG. 27) as the representative configuration parameter, and can use a total number of timed cycles (middle table, column 1), which can also be referred to as measurement-segment points, and can also use a number of graded events (middle table, column 2) that occur within a measurement-cycle. In the depicted example, a measurement cycle can be configured to have a number of timed cycles (e.g., 7,200), and number of graded events (e.g., 7) per timed cycle. The system can multiply this figures, for example, to determine a total RDG amount (e.g., 50,400, middle table, column 3) per class.

RDGs can be represented as having dimensions, and an available node count can be variable and elastic. For example, an RDG can include x and y coordinate values (bottom table, columns 1 and 2, respectively). The depicted examples show two-dimensional RDGs, and the bottom table shows 400 RDG nodes per 20×20 RDG. The dimensions of each RDG can increase or decrease as pod nodes are activated or deactivated and linked or unlinked, respectively, from the RDG. The examples discussed herein have described two-dimensional RDGs, but in some examples, three-dimensional RDGs can be used.

The system can link a shopper's pod nodes to shopper-class RDGs, can link an advertiser's pod nodes to advertiser-class RDGs, and can link a distributor's pod nodes to distributor-class RDGs. In some examples, a determination of pod nodes and which RDG or RDG node that the pod node can link to can be determined by class, a displayed ad point value, a modified ad point value, an end-user's measurement value, and transactional and/or social associations, in some examples. When ad-points values are used as the RDG representative parameter, an ad-point value of an ad offer can determine an appropriate RDG, and the system can make such a determination when the ad is acquired or redeemed, or when a purchase occurs, for example. In some examples, an ad offer displaying 25.00 ad-points can result in a shopper pod node linking to a RDG node associated with 25.00 ad point value, and similarly for pod nodes of the corresponding advertiser (e.g., whose ad was used by the shopper) and distributor (e.g., who distributed the ad), which may be linked to advertiser- or distributor-class RDGs, respectively.

When measurement values used as the RDG representative parameter, a shopper's, advertiser's, or distributor's current measurement value (e.g. rank value) can be used to determine an appropriate RDG. For example, the system can link a pod node for a shopper having a measurement value of 124 with a node of a shopper-class RDG associated with a measurement value of 124.

When a pod node is linked to an RDG node, pod-cycle and time counters for the pod node can be temporarily associated with the RDG node. A pod-cycle counter can be used to determine when the pod, and thus, the end user, can be rewarded (e.g., monetary reward or non-monetary reward, such as rank increase). In some examples, the reward can be a stored monetary value from a RDG node. A pod-cycle-time counter can also be used, and can represent a number of award cycles required to satisfy a pod-cycle counter. An award-cycle can be used as a universal timing parameter. In some examples, the system may configure award cycle at predetermined times or intervals (e.g., every 30 minutes) such that all pod-cycle-time counters reference this value (e.g., 30 minutes of system time can represent one pod-cycle-time counter).

Other configurations of timers and cycles can include: a global measurement timer that can globally reset and apply new measurement figures, grades and effect parameters to all timers in the system; a shopper measurement timer that can cause a measurement module to evaluate, grade and calculate various activities of a shopper when upon expiration and reset of the timer; an advertiser measurement timer that can cause the measurement module to evaluate, grade and calculate an advertiser's activities and grade results upon expiration and reset of the timer (in some examples, advertiser parameters can be changed in real time); a global award cycle timer that can be used to establish benefit-award time; a discount measurement timer that can cause various updates, adjustments and configuration changes (e.g., to the discount-percent-to-convert-rate) within the discount module; an ad release timer that can be used to determine which ads are released, and when.

Reward currency (RC) can be awarded to shoppers, advertisers and distributors. The monetary value of an applied discount percentage of an offer can be used to convert collected money from a transaction into RC. For example, with a point-only ad or offer type, an advertiser can assigns a discount percentage (e.g. 20.00%) to the ad, and an agreement can be made between the facilitator and advertiser to convey the monetary discount value of an ad offer to the facilitator in exchange for advertising services. As an example, when a shopper engages in a transaction of $65.23 with the advertiser using ad offer, for example, a monetary discount percentage value of $13.09 can be collected by the facilitator, and the remaining $52.14 can go to the advertiser. The amount collected by facilitator, (e.g. $13.09), can then be directed into one or more RDGs, such as one or more RDGs associated with the ad offer, and can later be awarded as RC. The fee that can be debited prior to deposits of money into the RDG.

Referring back to FIG. 22, fees from transactions can be divided among classes of RDG's associated with an ad, for example. Monetary value can be stored in nodes of an RDG by base allocation percentages (e.g., Column 2, Rows 1-3) for each class. Each RDG class of RDG may have a different base allocation percent (e.g., 45% for shopper, 40% for advertiser, 15% for distributor). The base allocation percent can be modified based on RC environmental factors (e.g., circulating amount). Thereafter, node allocation percentages can be determined (Column 4, Rows 1-3) for each RDG class. For example, shopper-class RDG nodes can have a node allocation percent of 0.001125%, (column 4, Row 1), resulting in a node amount of $11.25, for an example amount of $10,000 in collected fees.

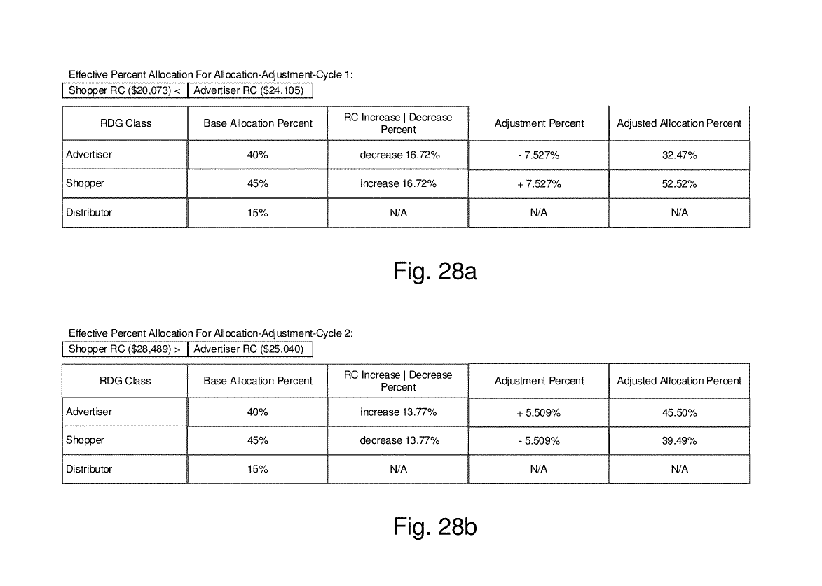

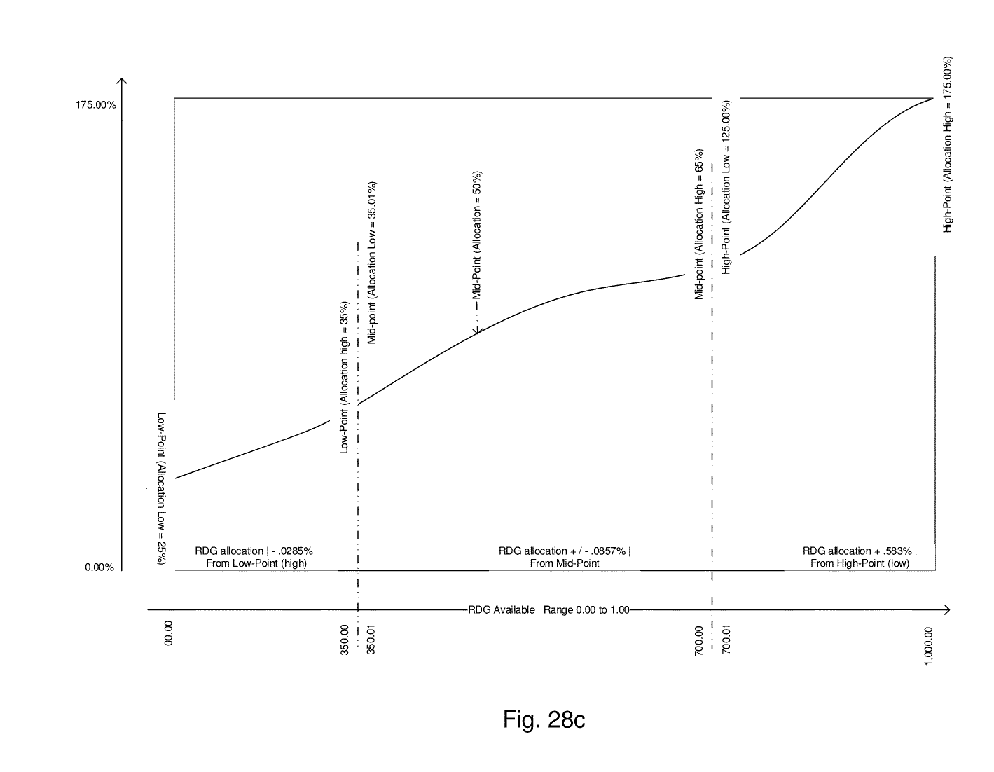

FIGS. 28a and 28b are tables of example parameters that illustrate how RDG base allocation percentages can vary. For example, when RC is circulating unequally between shoppers and advertisers (e.g., unequal amounts of shopper RC and advertiser RC available in RDGs) in an allocation-adjustment-cycle, the system can adjust base allocation percentages by class. The table of FIG. 28a shows that for an example amount (e.g., $20,073) of shopper RC in circulation is less than an example amount (e.g., $24,105) of advertiser RC in circulation, the system can increase the shopper-class base allocation percent, to an adjusted allocation of percent of 52.52%, and can decrease the advertiser-class base allocation percent, to an adjusted allocation of percent of 32.47% (column 5, Rows 1-2). The adjusted percentages can remain valid until the next allocation-adjustment-cycle. The allocation-adjustment-cycle can be time or condition based.

The table of FIG. 28b shows an example where shopper RC in circulation (e.g. $28,489) is greater than advertiser RC in circulation (e.g., $25,040), and how the system can adjust the percentages to decrease the shopper-class base allocation percent, to an adjusted allocation of percent of 39.49%, and can increase the advertiser-class base allocation percent, to an adjusted allocation of percent of 45.50% (column 5, Rows 1-2).

Regarding calculation of the adjusted allocation percent, when the allocation-adjustment-cycle expires and resets, the current state of reward currency circulation from previous and current allocation-adjustment-cycles can be calculated. An amount of increase or decrease in RC by class (see Column 3 of FIGS. 28a and 28b) can be used to determine the adjustment percent (see Column 4 of FIGS. 28a and 28b) for the next allocation-adjustment-cycle. In this manner, imbalances and excessive price swings in the reward currencies market rate may be minimized, in some examples.

In some examples, the RDG class adjusted allocation percentages can further be varied by configuring different allocation percentages for each RDG. For example, an RDG associated with a particular ad point value (e.g., 500.00 ad point value) can be configured to receive a particular allocation percentage (e.g., 50% of 100%) of the RDG class adjusted allocation percent.

FIG. 28c is a graph of example RDG parameters. An example RDG configuration can include three measurement points: low, mid and high. The mid-point can be considered a measurement point where most ad points and advertisements are awarded and consumed. Using the mid-point, the allocation percent may be set to receive 50% (of 100%) of offer transaction money directed into that RDG. The low measurement point can be configured at another point and may be set to receive a lower percentage (e.g., 35% of 100%), and the high measurement point can be set to receive a higher percentage (e.g., 125%, to capture percentages in the range of 125%-175%, for example). The difference of low-point, (e.g. 65% to 75% out of 100%), and mid-point, (e.g. 35% to 64.99% out of 100%). With each subsequent RDG, the allocation percent from mid-point to low-point decrementing and mid-point to high-point incrementing, (e.g. a 525 RDG equal to 50% allocation, a subsequent 526 RDG allocation percent incrementing 0.0857% to 50.0857%).

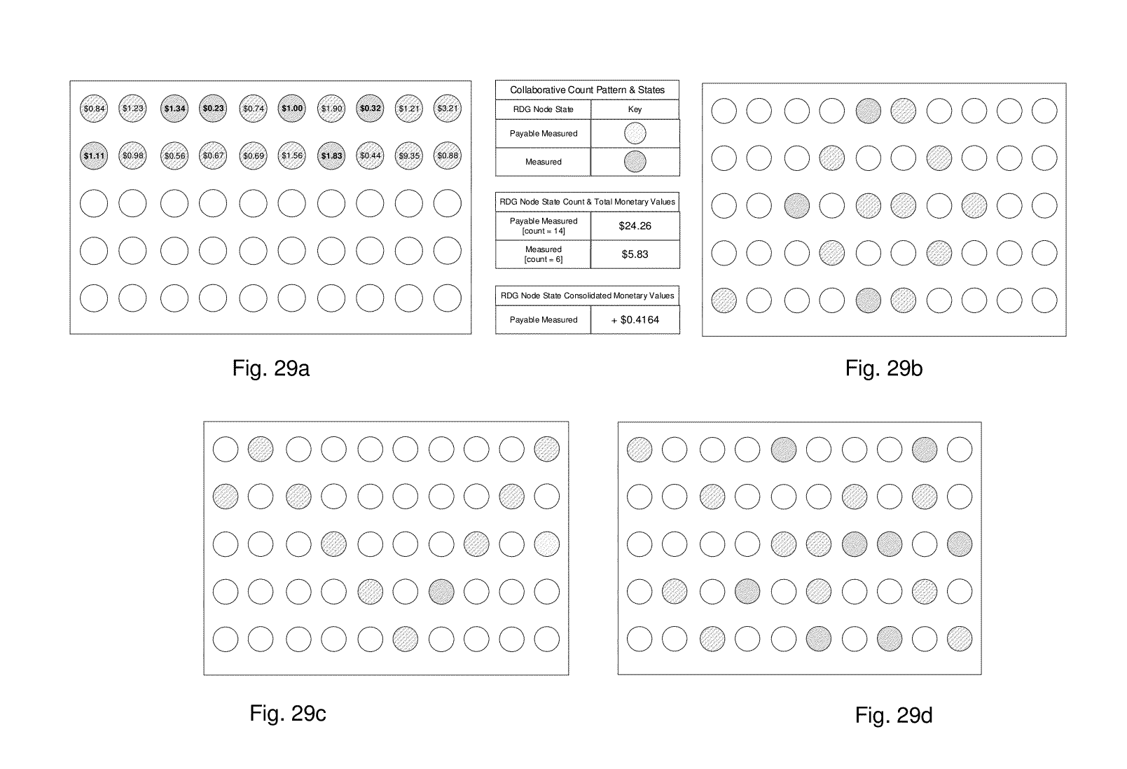

FIGS. 29a, 29b, 29c, and 29d are conceptual diagrams of example reward distribution grids with example patterns of RDG nodes. RDG nodes can be collaboratively grouped by patterns of various configurations and node states. A determined group pattern can differ for each pod node linked to a RDG node, in some examples. In some examples, the collaborative group can vary by offer, environmental and/or measurement values of shoppers, advertisers and distributors (e.g. number of redeemed offers, number of linked pods, number of activated pods). In other examples, it can include RDG nodes in payable-measured and/or measured states that can increase or decrease reward-able benefits.

A group pattern may occur within a single row or column of an RDG, or across multiple rows and/or columns of the RDG, in some examples. Group patterns can include lines (single lines, parallel lines, lines intersecting at an angle), squares, diamonds, rhombuses, rectangles and random arrays of nodes, in some examples. In some examples, a group pattern in a particular RDG class (e.g., in a shopper-class RDG) may be copied or applied to one or more RDGs of different class(es) (e.g., same pattern in corresponding advertiser- and/or distributor-class RDG as used in shopper RDG).

With reference to FIG. 29a, when measured-state nodes are included in a group pattern, monetary value that has been directed and stored into an RDG node can consolidate into payable-measured nodes, in some examples. This can increase the amount of reward-able monetary value from an RDG node. A group pattern depicted in FIG. 29a includes twenty “x” (e.g., horizontal) RDG nodes, for example. Each RDG node can have various amounts of stored monetary value, as depicted in FIG. 29a. Fourteen of the example nodes in the group are shown as payable-measured state nodes, and six of the nodes are shown as measured-state nodes (see key and table). The stored monetary value of the six measured-state nodes can be summed (e.g., for a sum of $5.83 in this example) and distributed (e.g., equally) to the fourteen payable-measured state nodes, such that stored value of each of the payable-measured state nodes increases by $0.4164 ($5.83/14, see bottom table).

FIGS. 29b, 29c, and 29d show examples of alternative patterns. The pattern of FIG. 29b can be based on rank values of end users having pod nodes linked to the identified RDG nodes, for example. In some examples, patterns can be related to days, or to times (e.g., times of day).

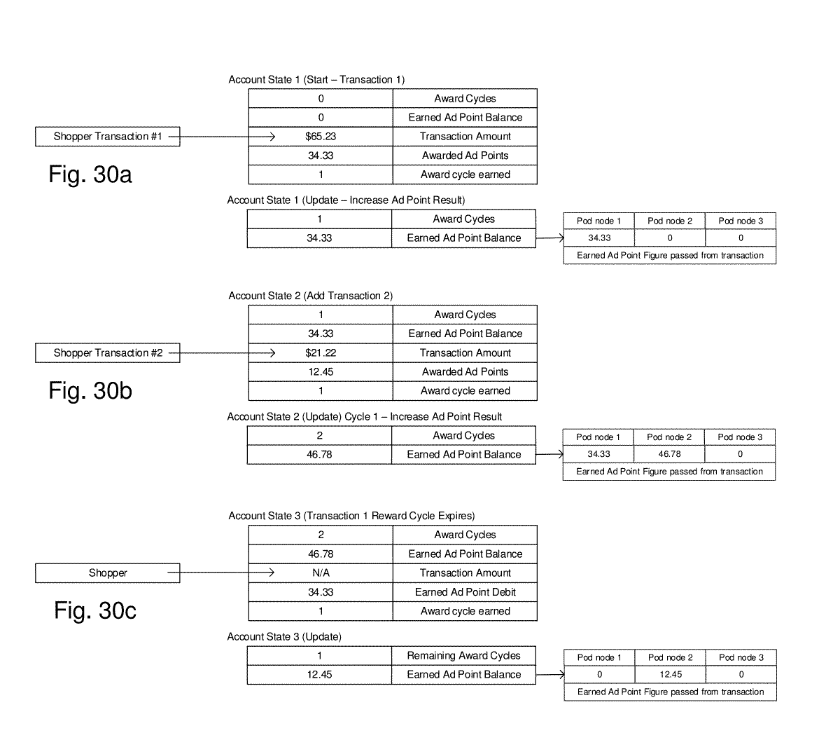

FIGS. 30a, 30b, and 30c are tables of example parameters, and illustrate how ad points can be accumulated over multiple transactions or events, to provide an accumulated benefit. Earned ad points from one or more transactions can be accumulated, and can be a valid for pod nodes linked to RDG nodes. FIG. 30a shows that a shopper's first transaction results in an award of 34.33 ad points, which are assigned to pod node 1. FIG. 30b shows, for a shopper's a second transaction, an additional award of 12.45 ad points, which can be added to the previously earned ad points, for a total of 46.78 ad points in this example (see FIG. 30b). When the pod node is granted for transaction #2, the combined ad point values of transaction 1 and transaction 2 can be provided as the active earned ad point figure for pod node 2. As such, after transaction #2, the shopper has two pod nodes with associated ad points: pod node 1 has 34.33 ad points (all from transaction #1), and pod node 2 has 46.78 ad points (34.33 from transaction #1 and 12.45 from transaction #2). This process of accumulating ad points can continue for subsequent transactions (not show) that may occur within the award cycle, such that additionally awarded pod nodes may be associated with ever-increasing ad point values based on current and previous transactions, until the award cycle ends.

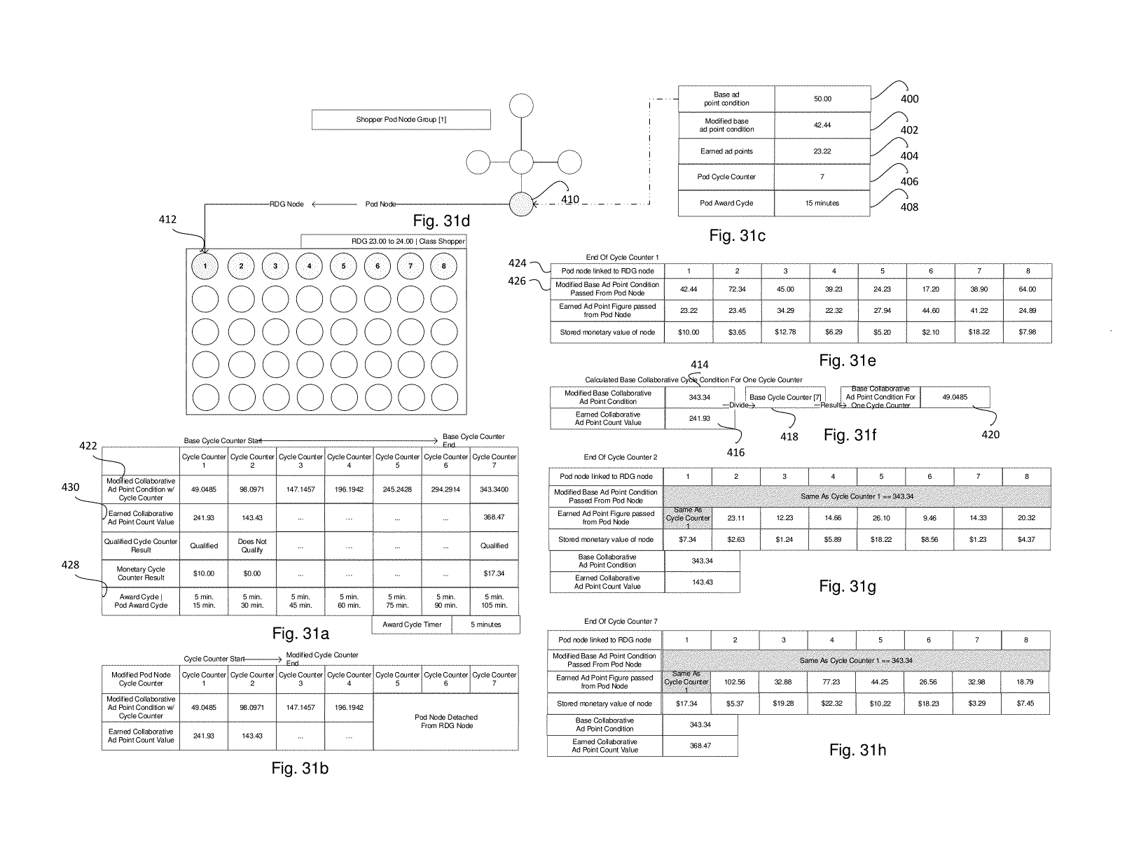

FIG. 30c illustrates that, when the award cycle ends, the 34.33 ad points earned in transaction #1 may no longer be eligible for linking via a pod node to an RDG node, and a deactivation of pod node 1 can occur (pod node 1 shown in FIG. 30c as having zero ad points). With the deactivation, the 34.33 ad points may no longer be valid and can be debited from earned ad point totals, in some examples. The shopper still retains the 12.45 ad points earned from transaction #2, in this example, which remain associated with pod node 2, as can be seen with reference to FIG. 30c. The shopper's previous earned ad point balance of 46.78 (e.g., before award cycle expired—FIG. 30b) is shown in FIG. 31c reduced to 12.45 ad points. By permitting ad point accumulation, an elastic ad point system can, in some examples, improve a shopper's experience by providing accelerated benefits, which may encourage additional transactions in some examples.

Referring to FIGS. 31c-31h, base collaborative group ad point conditions can be calculated by grouping other end-users associated to one RDG of a RDG class. Such grouping can vary by patterns, time of day, calendar day, current rank figures and/or rank grades, for example. When rank grades are used, for example, RDG nodes associated with end-users of a particular grade (e.g., grade A) can be considered a group and/or pattern. Then combining the end-users' conditions, group values can be obtained.

In FIG. 31e, when base collaborative ad point conditions are calculated for a pod node linked to a RDG node, modified base ad point conditions passed from pod nodes, 402, can be used and combined with others of a group pattern, (mentioned earlier). In FIGS. 31d and 31e, the group pattern, in this example, includes eight RDG nodes, (e.g. numbered 1, 2, 3, 4, 5, 6, 7, 8). In FIG. 31e, when modified base ad point conditions passed from pod node, (Row 1), are combined, a modified base collaborative ad point condition 414 can be determined and be active for the duration of a pod nodes pod-cycle-counter 412. In FIG. 31f, a calculated modified base collaborative ad point condition 414 can be further divided by a base-cycle counter 418 value. The base-cycle-counter 418 value can be a globally configured parameter and differ for each shopper, advertiser or distributor. The result can return a base collaborative ad point condition for one cycle counter 420.

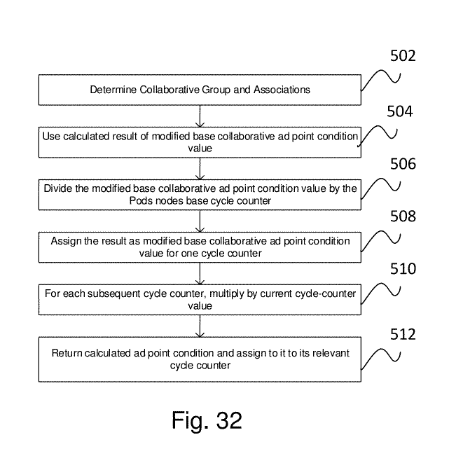

In FIG. 31a, to determine a subsequent pod cycle-counter's modified collaborative ad point condition with cycle counter 422, the base collaborative ad point condition for one cycle counter 420 can be added to its previous modified collaborative ad point condition with cycle counter 422, (e.g. as represented in FIG. 32a, table row 2), in one example. This can continue until it's equal to the original calculated modified base collaborative ad point condition 414 value.

Referring to FIG. 31d, a shopper's pod node 410 can link to a RDG node 412. The RDG node can receives conditions and values of pod node, (e.g. 400, 402, 404, 406, 408), in some examples. The pod node 410 can link to RDG node 412 when a qualified transaction occurs. The pod node can get the shoppers, advertisers or distributors earned ad point 404 and measurement values temporarily assigned. The pod node values and conditions can then be temporarily passed to the linked RDG node 412.

In FIG. 31c, pod nodes are configured to have a base ad point condition 400. The base ad point conditions 400 can differ for each pod node of shopper, advertiser or distributor. Configured conditions or associated values from a shopper pod node can become a base condition or value for pod nodes of advertisers and distributors. When a link event occurs, base configurations, (e.g. base ad point conditions, cycle-counters, award-able amounts), of pod nodes can be modified by a shoppers, advertisers or distributor's measurement value or grade or social associations. For example, the pod node 410 can have base ad point condition 400. When modified by a measurement value or grade, a modified base ad point condition 402 of 42.44 can be a result. This can reduce the earned ad points required to qualify for a reward, particularly in a collaborative ad point condition.

A shopper is awarded earned ad points 404 for a first transaction, (i.e. one with offer and new money not reward money). Earned ad points 404 can be collaboratively combined with other shoppers by linking their pod node to a RDG node. This can return an earned collaborative ad point count value 416. When associated with a pod node, earned ad points 404 can be valid for the duration of a pod cycle counter 406

When a first cycle counter of a pod node 410 linked to a RDG node 412 expires, a modified base collaborative ad point condition, (mentioned earlier), can be determined and temporarily assigned to that RDG node. This may be accomplished by first determining the configured collaborative pattern and association methods, (mentioned earlier).

In FIG. 31e, a modified base ad point condition of each pod node linked to a RDG node 424 can be combined, in one example. Each pod node linked to a RDG node 424, can be associated with various modified base ad point conditions passed from pod node 426 because each can represent a different shopper. And each pod node of linked shopper can have different ad point values, passed values and configured conditions. When adding modified base ad point conditions passed from pod node 426, the result, in this example, can be a modified base collaborative ad point condition 414 of 343.34. This can then become a pod node and RDG node active modified base collaborative ad point condition 414 for the duration of linked pods cycle counter 406.

In FIG. 31f, the modified base collaborative ad point condition 414 of 343.34 can be divided by a base cycle counter 418; configured by the facilitator. The purpose of dividing the modified base collaborative ad point condition is to segment its larger value into a smaller achievable single cycle count value. This can be used as a base collaborative ad point condition for one cycle counter 420. In each subsequent cycle counter, the base collaborative ad point condition for one cycle counter 420 can be added to the modified collaborative ad point condition with cycle counter 422 of its previous cycle, as represented in FIG. 31a.

In FIG. 31e, earned collaborative ad point count value(s) 416 can determined using grouping and combining methods of modified base collaborative ad point condition, (mentioned earlier). However, when calculating earned collaborative ad point count values 416, each subsequent cycle counter can result in a recalculation, as depicted in FIGS. 31a and 31b, and can differ because shoppers with different earned ad point values 404 can be grouped in a subsequent pod cycle-counter 406. Some other effects can include varying amounts of monetary value accumulated in each subsequent pod cycle-counter that can result transactions of other shoppers, as represented with different monetary values depicted in FIGS. 31e, 31g and 31h.

Referring to FIGS. 31a and 31b, a RDG node 412 can have a cycle counter value, inheriting a linked pod node 410. In some examples, FIG. 31b, a modified cycle-counter can be applied shortening a link duration of a pod node to RDG node, in some examples.

With each subsequent cycle-counter, modified base collaborative ad point condition of cycle counter 422 can increase up to a modified base collaborative ad point condition 414. Over the course of a nodes cycle counters, modified base collaborative ad point condition of cycle counter 422 can increase, therefore can become more difficult to satisfy. An award event can occur when an award cycle and pod award cycle expires 428. When earned collaborative ad points count values 430 satisfy modified collaborative ad point condition with cycle counter 422 values, an award can be earned.

Referring to FIG. 32, collaborative group and associations 502 can be determined by, in some examples, obtaining a base collaborative group ad point condition for each cycle counter. Next, a calculated result of a modified base collaborative group ad point condition value 504 can be used. The modified base collaborative group ad point condition value can be divided by the pod node's base cycle counter 506. The resulting modified base collaborative group ad point condition value can be assigned for one cycle counter 508. For each subsequent cycle counter, for example, multiply by the current cycle-counter value 510, in some examples. For example, cycle counter 1 multiplied by 1, cycle counter 2 multiplied by 2, and so forth. Return calculated ad point condition and assign to relevant cycle counter 512.

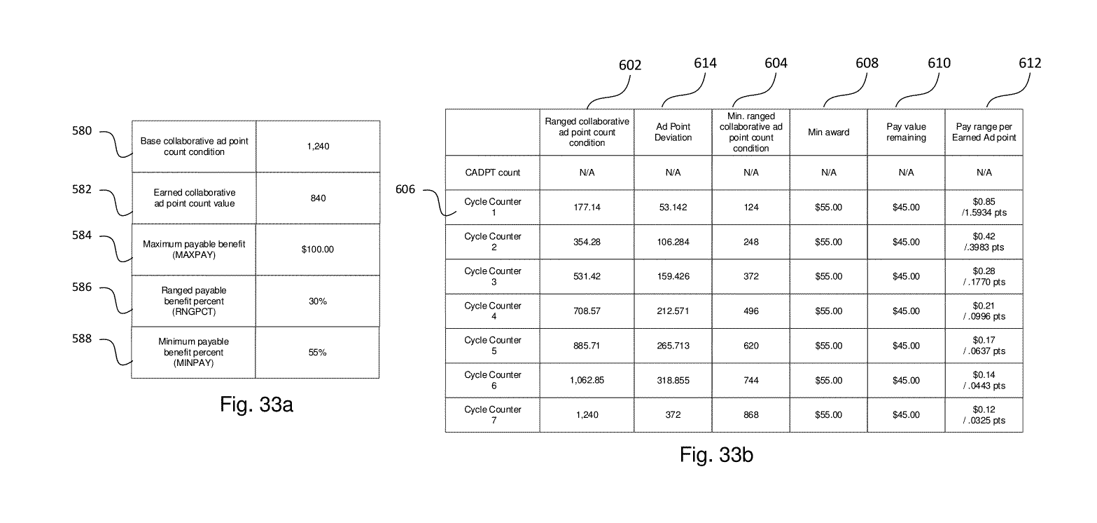

Referring to tables of FIGS. 33a and 33b, each cycle-counter of an RDG node can also have a ranged collaborative ad point condition 602, in some examples. A node that can satisfy ranged collaborative group ad point conditions 602 associated with a current cycle counter can receive a portion of its maximum payable benefit (MAXPAY) 584. Ranged collaborative group ad point count conditions 602 can increment with each subsequent cycle counter 606. The Base collaborative group ad point count condition 580c an be used to determine the collaborative group ad point Ranged collaborative group ad point count condition 602. When earned collaborative group ad point count value 582 of end-users (e.g. shoppers, advertisers or distributors) are within the min. ranged collaborative group ad point count condition 604 and ranged collaborative group ad point count condition 602, a reward benefit can be received, in some examples. In some examples, up to MAXPAY 582 of one cycle counter 606. An RDG node can inherit conditions, configurations and values (e.g. 580, 582, 584, 586, 588) from a pod node to which it is linked, in some examples.

In some examples, earned collaborative group ad point count values 582 not within min. ranged collaborative group ad point count condition 604 and ranged collaborative group ad point count condition 602 node may not award or may award up to a min award 608, in some examples. A non-reward, in some examples, can carry over its stored monetary value into a subsequent cycle counter. In some examples, a pod-node-to-RDG-node link that expires without an award can store monetary value for a subsequent linking pod node. For a new subsequent end-user (e.g., advertiser, shopper or distributor), the system can determine the modified base collaborative group ad point conditions of a new pod-node-to-RDG-node link, in some examples.

Referring to FIG. 33b, a ranged collaborative group ad point count condition 602 can be used in algorithm performed by the system. For example, a min. ranged collaborative group ad point count condition 604 and a ranged collaborative group ad point count condition 602 can be determined. The min ranged collaborative group ad point count condition 604 and ranged collaborative group ad point count condition 602 can be valid for a duration of a pod-node-to-RDG-node cycle counter. The algorithm may use parameters such as the calculated base collaborative group ad point condition 580 and ranged payable benefit percent (RNGPCT) 586, in some examples. A result of the algorithm can be used to configure a min ranged collaborative group ad point count condition 604, ranged collaborative group ad point count condition 602, minimum award (MINPAY) 608 pay value remaining 610 and pay range per earned ad point 612 above the min ranged collaborative group ad point count condition 604, in some examples.

In some examples, the payable value remaining 610 can be a difference between the maximum payable benefit (MAXPAY) 584 and min award 608. For example, using a base collaborative group ad point count condition 580 of 1,240 and a ranged payable benefit percent (RNGPCT) 586 of 30%, an ad point deviation 614 range of 372 can be determined for cycle counter 7, in one example. The cycle counter of 7 can then be assigned a min award 608 by multiplying a maximum payable benefit (MAXPAY) 584 value and minimum payable benefit percent (MINPAY) 588, in some examples. The min award 608 can be assigned to one of each cycle counter 606 (e.g. a min. ranged collaborative group ad point count condition 604 range between 124 to 868 points).

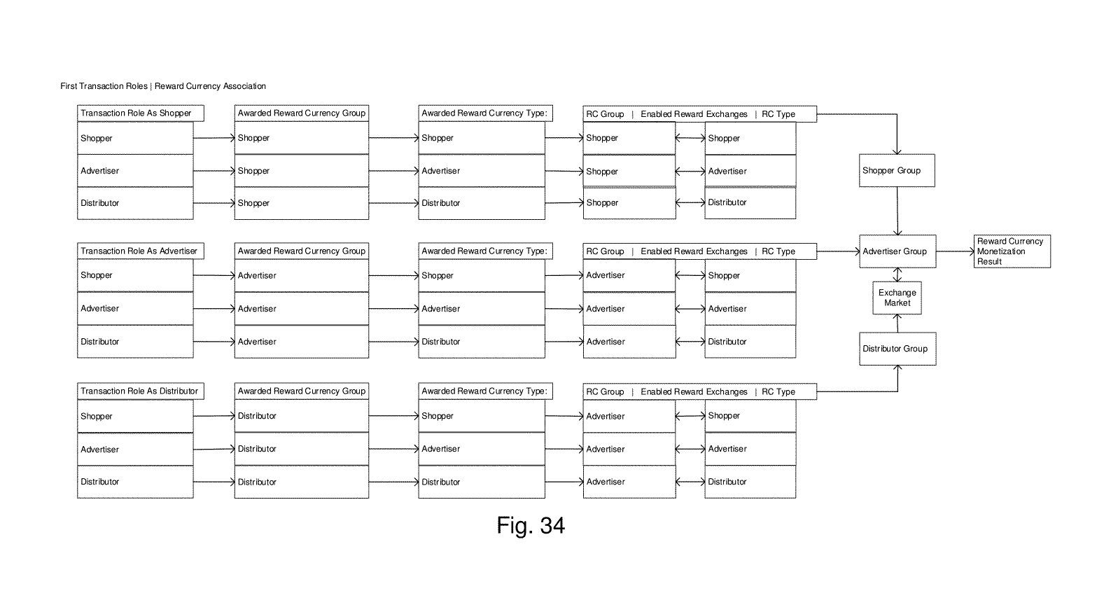

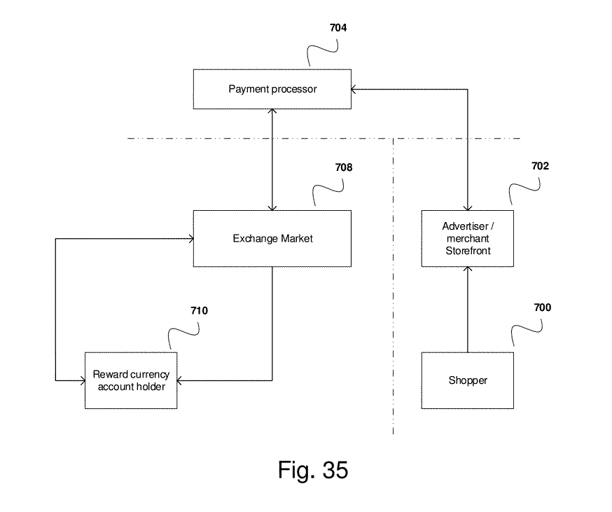

Referring to FIG. 34, reward currency (RC) can be awarded and issued to shoppers, advertisers and distributors. A group and type can be associated with RC. A first transaction role can determine the group of RC received. A shopper of a first transaction role is the offer redeemer and can include a shopper or an advertiser or a distributor, in some examples. End-users (e.g. advertisers, shoppers, distributors) of a first transaction role can be awarded RC of a shopper group. An advertiser in a first transaction role can be end-user offering an ad offer and can include shoppers, advertisers and distributors, in some examples. Advertisers can be awarded RC from an advertisers group. The distributor of a first transaction role can be a distributor of ad offers and can include shoppers, advertisers and distributors, in some examples. Distributors can be awarded RC from a distributors group, in some examples.

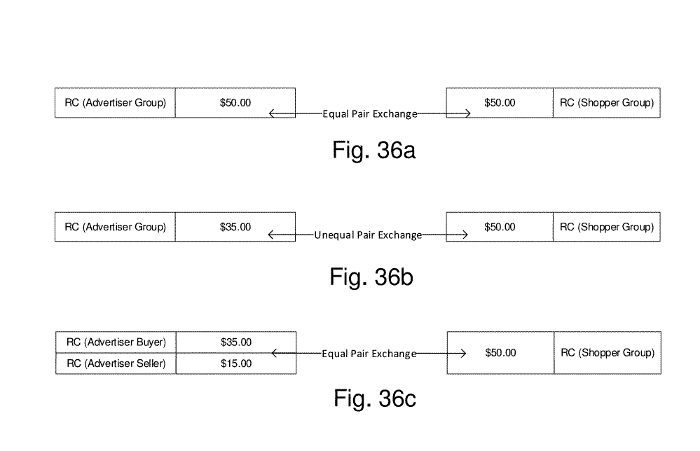

In some examples, reward currency can have restrictions that can delay monetization (e.g., delay when the reward currency is eligible to be converted into a cash payment, such as used in first transaction). A monetization of advertiser group reward currency can be restricted by a pair condition. A pair condition can be applied during a second transaction that uses reward currency. In FIG. 36a, a pair condition can be satisfied when reward currency of an advertiser and reward currency of a shopper group are equally paired in a second transaction. When such reward currency is unequally paired, see e.g., FIG. 36b, additional reward currency can be purchased from an exchange market, such that the pair condition may be satisfied, see e.g., FIG. 36c. A pair condition can occur asynchronously (e.g., after the shopper's second transaction and determined by exchange market of reward system). For RC of distributor group, monetization can be restricted to selling of the distributor-class RC through an exchange market to other end-users (e.g., to advertisers for purpose of satisfying a pair condition).

Referring to FIG. 34, in a second, reward-currency transaction, an associated reward currency group and type can be used to determine whether an exchange can occur. In some examples, shopper-class reward currency can be purchased by other shoppers, resulting in cash payment for the RC. On other occasions, reward currency can be shared or given to others of a same RC group and type, in some examples.

When an advertiser (e.g., merchant) has insufficient reward currency to satisfy a pair condition for a reward currency transaction, reward currency can be autonomously purchased from an exchange market to satisfy the pair condition and permit the transaction to occur. The advertiser can receive the shoppers reward currency, (i.e. shoppers reward currency equivalent to cash), in some examples. Sellers of reward currency can also receive cash (e.g., satisfying monetization) from a second transaction even though a shopper has not directly purchased a product from them, in some examples. This can monetarily benefit other advertisers, shoppers and distributors, in some examples.

An exchange market can be used to exchange, share, give, sell or buy RC, in various examples. End-users can sell or buy RC from other advertisers, shoppers or distributors at a prevailing market rate. Awarded and issued RC can have an intrinsic value equivalent to a first currency (e.g., one RC unit equals one U.S. dollar, one euro, etc.) in some examples. RC association types can include advertisers, shoppers or distributors, in some examples.

RC can be directed into holding accounts of shoppers, advertisers and distributors, which may be maintained by the system, in some examples. RC within a holding account can be of any intrinsic type (e.g., dollar, euro, bitcoin), and can be selectable by the advertiser, shopper and distributor, in some examples. A facilitator can provide an end user a physical (e.g., reward debit card) or digital (e.g., digital wallet) payment card/application to use reward currency. A facilitator can directly fund (e.g., load cash, replenish) holding accounts of end-users, in some examples. A facilitator can monitor second transactions, in some examples. RC transactions can use exchange market of facilitator to internally transfer reward currency to another end-user of the reward system.

First transactions can include B2C, B2B and C2C transactions, in some examples. End-users can have multiple roles, (e.g. shopper, advertiser, distributor), and hold various reward currency associations. In a B2B transaction, for example, a first advertiser can be a shopper using ad offer and transacting with a second advertiser, (i.e. issuer of ad offer). The first advertiser, (e.g. shopper), of this transaction can obtain an offer from second advertiser. The first advertiser can then buy a product or service from a second advertiser. The first advertiser buying the product can be associated with a shopper role. The second advertiser with the advertiser role, in some examples.

When reward currency is awarded, with the above example, the first advertiser can be benefactor of reward currency of shopper's roles, and can receive parameters, conditions, allocation percentages and incentives associated with shopper's role. This can include the pod nodes, RDG nodes, measurement parameters, allocations and reward incentives, in some examples.

A first transaction occurring between a shopper and advertiser can determine awarded RC group and type. For example, an advertiser, shopper or distributors purchasing a product can become associated with a shopper group while an advertiser (e.g., seller of product) of offer can be associated with the advertiser group.

An advertiser group include shoppers, advertisers or distributors who offer a product ad offer to shoppers. In a first transaction of an end-user associated with advertiser group, benefits and conditions associated with an advertiser can include pod nodes, RDG nodes, measurement parameters, allocations and reward incentives, in some examples.

A shopper group can include shoppers, advertisers and distributors who use offers of advertisers to buy products. In first transaction of an end-user associated with the shopper group, benefits and conditions associated with a shopper can include pod node limits, pod node conditions, RDG conditions and reward amount, in some examples.

A distributor group can include shoppers, advertisers or distributors. A distributor role can be to distribute ad offers to end-users. Distribution of offers can be distributed using physical, online and print channels, in some examples. Distributors can include owners and/or operators of in-store and online storefronts, mobile and web applications, domains, interactive media, e.g. television, radio, etc., and printed publications such as signage, magazines, newspapers, flyers and the like, in some examples. RC awarded and issued to distributor group can autonomously directed into the exchange market, in some examples. RC of distributor group can be monetized through an exchange market, (mentioned earlier).

Referring to FIG. 35, a shopper 700 can use reward currency by using a facilitator accepted reward payment card, in some examples, or online payment transfer method at advertiser (e.g., merchant) storefront 702. A payment transaction can occur using an in-store or online a point of sale terminal. A payment request to payment processor 704 can be executed when reward payment card is used at advertiser (e.g., merchant) storefront 702. The exchange market 702 can receive a notification of reward transaction from payment processor 704. The exchange market 708 may evaluate the shopper;s reward transaction amount and reward currency account holder 710 balance. Adequate reward currency account holder balances of shopper and advertiser can be determined and can result in transaction being approved. When approved, exchange market 708 may notify payment processor 704. Payment processor can then return approval or decline result to advertiser storefront 702.

When the exchange market approves a shopper's reward currency transaction, an advertiser's reward currency account is validated afterwards, real-time or asynchronous, for sufficient reward currency and valid group associations. The market rate can be used when determining the cost of buying reward currency.

The reward currency amount required to buy in second reward currency transaction can be determined according to the amount of shortage between an advertiser's reward currency balance and the shopper's reward currency transaction amount. When there is a shortage, it can be autonomously purchased from the exchange market. The amount bought may equal the reward currency shortage amount of that reward currency transaction. This can result in reward currency purchased in an amount that will equally pair with a shopper's reward currency transaction amount. This can satisfy a reward currency pair condition.

Some reasons for pair conditions can be to prevent market value price swings, keep reward currency circulating, prevent hording of reward currency, allow advertisers with reward currency balances greater than their transactional capacity to sell their reward currency and allow advertisers to monetarily gain from reward transactions not occurring directly at their physical, online or virtual storefront, in some examples.

When additional advertiser group reward currency is required, it can be purchased autonomously from the exchange market at market rate. The market rate can be determined using an algorithm that can use reward currency factors such as reward currency circulation amounts between advertiser and shopper groups, in some examples. The distributor and floating currency (e.g., floating currency can refer to reward currency that hasn't been awarded yet and its value is still stored in RDG nodes.) can be used in comparison to shopper or advertiser reward currency groups, in some examples.

A strike price can refer to a desired selling price that a seller of reward currency is trying to gain from its sale, and can be set by an end-user, (e.g. shopper, advertiser or distributor). Reward currency may not be sold unless the strike price is met, in some examples, or a strike price valid offer term expires.

There can be a reward currency holding cap for each advertiser, shopper or distributor. An advertiser's holding cap, for example, can be determined by factors such as, but not limited to, the advertiser's size, transactional volume, offer performance, offer quantity, discount percent assignments, or expenditures, in some examples.

When an advertiser's reward currency holding cap is exceeded, reward currency received above it can be autonomously directed into the exchange market for their benefit. Any reward currency directed in this way can be sold at an established strike price or at market rate. The strike price can be active for a specified strike price valid offer term. When a strike price term expires before being sold, remaining amount can be autonomously sold at market rate.

Reward currency earned by a shopper above their holding cap can result in the excess RC being autonomously directed into an exchange market and can be purchased by other shoppers, in some examples. The shopper can have the same benefits of setting a strike price condition. When a shopper buys reward currency from the exchange market, in some examples the RC can be bought at a cost less than its actual value. For example, a shopper can purchase it at a discounted rate of $0.85 when market rate of reward currency is 0.85:1.0. The benefit for a shoppers selling under these conditions can be to receive cash. Shoppers can buy reward currency from exchange market with new money (e.g., dollar, euro, pound not previously introduced to the system), in some examples.

A second, RC transaction can have at least three beneficiaries: the shopper, advertiser and seller of reward currency. The shopper may be a buyer of a product or service. The advertiser may sell the product or service. The seller of reward currency can sell to advertisers. A second, RC transaction can occur in-store or online, in various examples.

When an advertiser buys reward currency from the exchange market, the seller of reward currency can receive monetary value from the sale. The amount received by seller for a sale can be determined by a current reward currency market rate (i.e. buy and sell price). A purchase of reward currency through an exchange market can have either a positive or negative monetary profit/benefit for a buyer or a seller.

When the market rate is greater than the shopper's exchange rate (e.g., one), the buyer, advertiser can lose monetary benefit from a purchase of reward currency from exchange market (e.g., $0.85 per $1.00 of shopper RC). When market rate is lower than the shopper's exchange rate, the buyer, advertiser, gains from a reward currency purchase, (e.g. $1.25 per $1.00 of shopper RC), in some examples.

Market rate of reward currency can be determined using circulation differences between the shopper-class RC and advertiser-class RC, in some examples. When there are greater amounts of shopper-class RC than advertiser-class RC in circulation, the market rate to buy and the sellers profit from the exchange market can be greater, and vice versa.

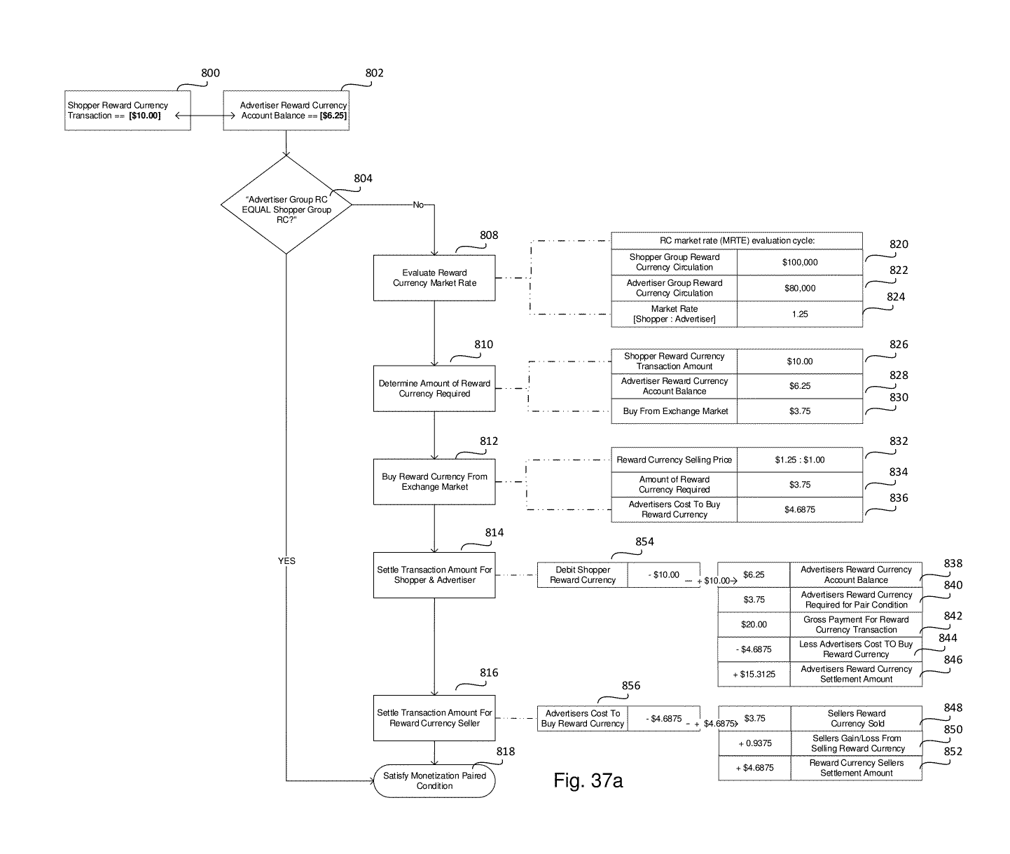

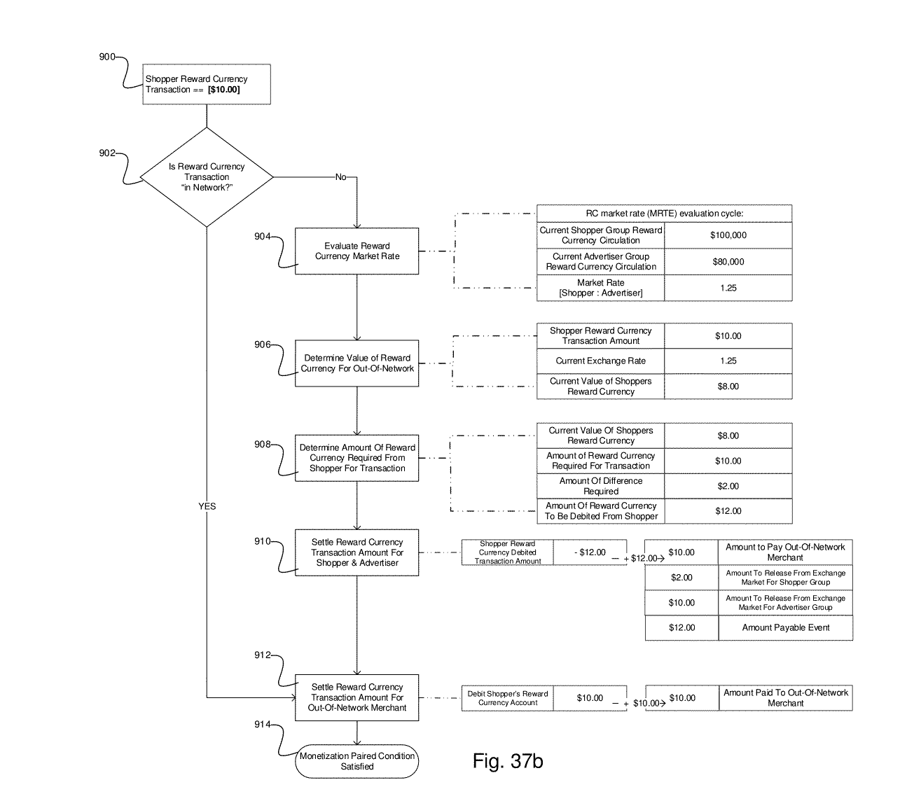

Referring to FIG. 37a, an example second transaction between a shopper and advertiser is represented. A shopper reward currency transaction 800 of $10.00 is depicted. Because the advertiser reward currency account balance 802 is $6.25, the advertiser-class RC is not equal to shopper-class RC advertiser 804. The shopper-class reward currency circulation 820 and the advertiser-class reward currency circulation 822 can determine market rate 824. When the market rate 824 has been determined, an amount of reward currency required 810 can be determined to satisfy pair conditions. The shopper's reward currency transaction amount is $10.00 826 and the advertiser's reward currency account balance $6.25 828, in this example. In order to satisfy a pair condition for the transaction, the advertiser may need to purchase $3.75 of RC from exchange market 830.

Reward currency can be purchased from exchange market 812. The current reward currency selling price 832 is market rate 824. The amount of reward currency required 834 to satisfy pair condition is $3.75 834. Because the market rate is greater than one, the advertisers cost to buy the reward currency 836 is $4.6875.

After purchase of reward currency from exchange market, a settle transaction amount for shopper and advertiser 814 can occur. This can result in a debit to shopper reward currency 854 of $10.00, which can be conveyed to the advertiser. Because the shopper's reward currency transaction 800 was $10.00, an equal amount can be paired (e.g. adding 854, 838, 840 equals 842) for a gross payment for reward currency transaction 842 of $20.00 less advertiser's cost to buy reward currency −$4.6875 844. This can result in an advertisers reward currency settlement amount 846 of $15.3125 for a shoppers $10.00 reward currency 800 transaction, in this example.

The settle transaction amount for reward currency seller 816 can then be determined by determining the advertiser's cost to buy reward currency −$4.6875 856 and that amount is the reward currency sellers settlement amount $4.6875 852 and satisfying monetization pair condition 818. A requirement for reward currency transactions. This can allow most reward transactions to process and complete, even when an advertiser has an initial reward currency account balance of zero. In some examples, the advertiser receives less than the shopper's reward transaction amount. In addition, the seller gain/loss from selling reward is $0.9375 more than $3.75 848, thus providing a greater return of profit, in this example.

In further explanation of FIG. 37a, once reward currency has been equally paired, settlement of a reward currency transaction for shopper and advertiser can occur. The shopper of the reward currency transaction may be debited the reward currency transaction amount of $10.00. That $10.00 then being directed to the advertiser.

A matching $10.00 is additionally awardable, in some examples. This can result in a $20.00 settlement value. The advertiser can be required to buy reward currency from the exchange market, in this example. The settlement value can be reduced to $16.25 including the advertiser's $6.25 of available reward currency and the shopper's $10.00. Because of the shortage of $3.75 from the $10.00 required amount to satisfy pair condition, the advertiser can be required to buy $3.75 from the exchange market. Because the market rate (e.g., 1.25), in this example is greater than the shopper exchange rate (e.g., one) it is costing the advertiser $4.6875 instead of $3.75. This amount can be debited from the advertiser's gross reward currency transaction amount for a reward currency settlement amount of $15.3125 and seller of reward currency receiving a settlement amount of $4.6875.

Referring to FIG. 37b, an example out-of-network reward currency transaction event is depicted. At Step 900, a shopper is conducting a $10.00 transaction. At Step 902, the transaction can occur in-network or out-of-network. When a transaction does not occur in-network, a different amount can be presented or autonomously debited from their reward currency account balance. However, the amount debited can be based on the market rate. At Step 904, the market rate is evaluated and determined. At Step 906, the shopper's actual cash value is determined for an out-of-network reward currency transaction. At Step 908, it is determined the shopper will be debited $12.00 for a $10.00 reward currency transaction occurring out-of-network. At Step 910, the settlement and debit amounts from the shopper's account as a result of transaction and amount released from exchange market to in-network advertiser's group holders of reward currency, (i.e. $12.00 and $10.00). At Step 912, the settlement value of the transaction to out-of-network merchant of transaction, (i.e. $10.00). At step 914, the monetization paired condition is satisfied.

In some examples, advertisers that can satisfy reward currency pair conditions without buying from the exchange market, and can monetary double the shopper's transaction amount. For example, in a reward currency transaction where the shopper buys a product or service for $20.00, the advertiser can also be required to have $20.00 in RC to satisfy the paired condition. When an advertiser has an adequate reward currency balance $20.00, the advertiser can receive $20.00 of shopper RC and $20.00 of advertiser RC for a total payment of $40.00.

Advertisers and shoppers can autonomously buy from or direct reward currency into, the exchange market. In some examples, buy, sell, or hold conditions can be used in various percentages and amounts.

While the present disclosure has described particular embodiments, implementations, examples, and applications, in both summarized and detailed forms, it is not intended that these descriptions in any way limit its scope to any such implementations, examples, and applications, and it will be understood that many substitutions, changes and variations in the described implementations, examples, applications and details of the method and system illustrated herein and of their operation can be made by those skilled in the art without departing from the spirit of this disclosure.

What is claimed is:

1. A computer-implemented method of providing a collaborative reward system, comprising:
receiving, at a central computer system, an advertisement, wherein the advertisement is provided by an advertiser and includes a discount percentage value for the advertisement;
converting, by the central computer system, the discount percentage value to an ad point value;
receiving, at the central computer system, an indication of a redemption of the advertisement, the indication of the redemption provided by a shopper;
providing, by the central computer system, the shopper a first quantity of earned ad points based on the indication of the redemption of the advertisement and on the ad point value of the advertisement, and associating the shopper with a first reward distribution grid based on the first quantity of earned ad points;
providing, by the central computer system, the advertiser a second quantity of earned ad points based on the indication of the redemption of the advertisement and on the ad point value of the advertisement, and associating the advertiser with a second reward distribution grid based on the second quantity of earned ad points;
rewarding, by the central computer system, the shopper with a first quantity of reward currency based on the first reward distribution grid and the first quantity of earned ad points; and
rewarding, by the central computer system, the advertiser with a second quantity of reward currency based on the second reward distribution grid and the second quantity of earned ad points.

2. The computer-implemented method of claim 1, wherein the converting the discount percentage value to the ad point value is based on a product class associated with the advertisement.

3. The computer-implemented method of claim 2, wherein the converting the discount percentage value to the ad point value is additionally based on a rank value of the advertiser.

4. The computer-implemented method of claim 1, wherein a distributor distributes the advertisement, and further comprising:
providing, at the central computer system, the distributor a third quantity of earned ad points based on the redemption of the advertisement and on the ad point value of the advertisement, and associating the distributor with a third reward distribution grid based on the third quantity of earned ad points; and
rewarding, by the central computer system, the distributor with a third quantity of reward currency based on the third reward distribution grid and the third quantity of earned ad points.

5. The computer-implemented method of claim 1, wherein associating the shopper with a first reward distribution grid comprises associating a first pod node of the shopper with a first node of the first reward distribution grid, and wherein the first node of the first reward distribution grid inherits a plurality of conditions from the first pod node of the shopper.

6. The computer-implemented method of claim 1, further comprising receiving, at the central computer system, an indication of an acquisition of the advertisement by the shopper, and providing the shopper a fourth quantity of earned ad points based on the acquisition of the advertisement and on the ad point value of the advertisement.

7. The computer-implemented method of claim 1, further comprising:
receiving an indication of a redemption of a second advertisement at the central computer system, the indication of the redemption of the second advertisement provided by the shopper;
providing the shopper a fifth quantity of earned ad points based on the indication of the redemption of the second advertisement and on an ad point value of the second advertisement;
associating the shopper with a fifth reward distribution grid based on a sum of the first quantity of ad points and the fifth quantity of ad points; and
rewarding the shopper with a fifth quantity of reward currency based on the fifth reward distribution grid and the sum of the first quantity of ad points and the fifth quantity of ad points.

8. The computer-implemented method of claim 1, wherein the shopper is associated with a plurality of reward distribution grids based on a monetary value of the redemption of the advertisement.

9. The computer-implemented method of claim 1, wherein the shopper is associated with a plurality of reward distribution grids based on one or more social network associations.

10. The computer-implemented method of claim 1, wherein the rewarding the advertiser with the second quantity of reward currency is additionally based on a rank value of the advertiser.

11. The computer-implemented method of claim 1, further comprising associating the shopper with a sixth reward distribution grid based on the indication of the redemption, and rewarding, by the central computer system, the shopper with an increase to a rank value of the shopper based on the sixth reward distribution grid.

12. The computer-implemented method of claim 11, wherein the sixth reward distribution grid is the same as the first reward distribution grid.

13. The computer-implemented method of claim 1, wherein the providing the shopper the first quantity of earned ad points is additionally based on a rank value of the shopper.

14. The computer-implemented method of claim 1, further comprising providing, for consideration by a plurality of shoppers, the advertisement with an indication of the ad point value.

15. The computer computer-implemented method of claim 14, wherein the providing of the advertisement further comprises adjusting, by the central computer system, the ad point value and providing an indication of the adjusted ad point value.

16. The computer-implemented method of claim 1, wherein the indication of the redemption is provided following an online redemption or an in-store redemption.

17. The computer-implemented method of claim 1, further comprising adjusting, by the central computer system, a rank value of the advertiser, and wherein a number of advertisements that may be currently active for the advertiser changes based on the adjustment of the rank value.

18. The computer-implemented method of claim 1, further comprising:
receiving, at the central computer system, an indication from the shopper of an intent to use the first quantity of reward currency to make a purchase from a retailer; and
determining, at the central computer system, whether the retailer has at least an amount of advertiser reward currency equal to the first quantity of reward currency.

19. The computer-implemented method of claim 18, wherein the retailer does not have an amount of advertiser reward currency at least equal to the first quantity of reward currency, and further comprising acquiring for the retailer, via a reward currency exchange market, additional reward currency.

20. The computer-implemented method of claim 1, wherein the first quantity of ad points is combined with ad points of another shopper, wherein the shopper and the another shopper are associated in a group and are collectively associated with a reward distribution grid.

21. The computer-implemented method of claim 1, further comprising, allocating, to nodes of the first distribution grid, monetary value collected in a plurality of transactions.
